(19) United States
(12) Patent Application Publication
(10) Pub. No.: US 2024/0253737 A1
(43) Pub. Date: Aug. 1, 2024

(54) CATAPULT SLINGSHOT 2 STROKE DOUBLE DOUBLE REVERSED BOOMERANG SLAP ARM DRIVE SPROCKET THRUSTERS

(71) Applicant: Brett Whitlock Burdick, Clinton, CT (US)

(72) Inventor: Brett Whitlock Burdick, Clinton, CT (US)

(21) Appl. No.: 18/421,954

(22) Filed: Jan. 24, 2024

Related U.S. Application Data
(60) Provisional application No. 63/441,786, filed on Jan. 28, 2023.

(51) Int. Cl. B62M 9/128; B62J 13/04; B62M 9/1242; B62M 9/1248; B62M 9/125; B62M 9/16; B62M 9/00; B62M 9/124

(52) U.S. Cl. CPC B62M 9/128; B62J 13/04; B62M 9/1242; B62M 9/1248; B62M 9/125; B62M 9/16; B62M 2009/002; B62M 2009/12406

(57) ABSTRACT

The disclosed embodiments include a drive structure. The drive structure includes a first sprocket and a second sprocket. Each of the first and second sprocket has a shape with two points and four sections of teeth where two sections of teeth are inline and two sections are curved. Attached to the first sprocket are slap crank arms, which contains a slap crank arm lever to move and cause an impact force when the first sprocket is rotated. A drive chain travels in a loop between the first sprocket and second sprocket. Embodiments of the drive structure include other elements of a bicycle frame and rear derailleur structure.

This application claims the benefit of U.S. Provisional Patent Application No. 63/441,786, entitled, “CATAPULT DOUBLE DOUBLE BOOMERANG SLAP THRUST DRIVE SPROCKET,” filed on Jan. 28, 2023, the content of which is hereby incorporated by reference herein in its entirety.

### BACKGROUND OF THE INVENTION

The background of the invention is described in the following headings of a description, the field of the invention, and the description of the prior art.

### DESCRIPTION

The disclosure describes embodiments of a drive structure; a drive structure and bicycle frame; and embodiments of a drive structure with rear derailer and bicycle frame.

Part of the embodiments of the drive structure are the embodiments of a sprocket with a non-circular shape when viewing the large flat front and rear face, which are mirror images of each other. Both the front and rear face of the sprocket can be referred to as the faces of the sprocket. The embodiments have two points as part of the shape of the face of the sprocket. The sprocket has teeth around the outer edge. The teeth can be described as four sections. The teeth in the first section are inline. The teeth in the second section are in a curved shape. The teeth in the third section are inline. The teeth in the fourth section are in a curved shape. Each section of teeth has a first end and a second end. The sections of teeth are arranged where the second end of the first section of teeth connects to the first end of the second section of teeth, the second end of the second section of teeth connects to the first end of the third section of teeth, the second end of the third section of teeth connects to the first end of the fourth section of teeth, the second end of the fourth section of teeth connects to the first end of the first section of teeth. The connection of the second end of the first section of teeth to the first end of the second section of teeth forms a first point in the shape of the face of the sprocket. The connection of the second end of the third section of teeth to the first end of the fourth section of teeth forms a second point in the shape of the face of the sprocket.

### FIELD OF THE INVENTION

A main component of the invention relates to drive sprockets. In general a drive sprocket takes the initial power source and puts that force into another part of the machine. In a typical bicycle the pedals are attached to crank arms. The crank arms are attached to the drive sprocket. A user of the bicycle puts one foot on a pedal and another foot on the other pedal. The user then pedals to put force on the crank arms and then turns the drive sprocket. The drive sprocket turns the bicycle chain. The drive sprocket has teeth around the outer edge which fit into spaces in a bicycle chain. The spaces are formed between short bars which are perpendicular to the length of the bicycle chain. The teeth of the sprocket push on the short bars of the bicycle chain. The bicycle chain engages with another sprocket which is attached to the rear wheel of the bicycle. The turning bicycle chain turns the sprocket attached to the rear wheel and therefore turns the rear wheel of the bicycle which propels the bicycle forward. The source of power is the user's legs, which turns the pedals which propels the bicycle.

Drive sprockets are a component of other machines. The other machines for example are motorcycles which have a drive sprocket which is turned by an engine. Also an electric powered bicycle has a drive sprocket which is turned by a motor. The drive sprocket turns a chain which turns another sprocket and then a wheel of the machine to propel the machine.

### DESCRIPTION OF THE PRIOR ART

Drive sprockets are a common component of machines which move a chain which is part of the mechanical components to allow that movement.

For bicycles, drive sprockets are commonly circular. There are other shaped bicycle drive sprockets such as an oval and diamond shape. There are bicycle drive sprockets which have a general circular form but are not circular.

### BRIEF DESCRIPTION OF DRAWINGS

FIG. 1 is a front view of an embodiment of the front face of the first sprocket.

FIG. 2 is a front view of an embodiment of the front face of the first sprocket.

FIG. 3 is front view of an embodiment of the front face of the first sprocket with a derailment guard.

FIG. 4 is a side view of an embodiment of the outer edge of the first sprocket with a derailment guard.

FIG. 5 is a view defining the teeth, valleys, tooth tip, and bottom of the valley of the outer edge of the first or second sprocket.

FIG. 6 is a front view of an embodiment of the front face of the first sprocket defining the four sections of teeth.

FIG. 7 is a front view of an embodiment of the front face of the first sprocket defining the four sections of teeth and the first and second ends of the sections of teeth.

FIG. 8 is a front view of the front face of the first sprocket defining the first and second point of the first sprocket and the first double tooth structure and the second double tooth structure, and the outer edge of the first sprocket.

FIG. 9 is a partial view of an embodiment of the front view of the front face of the first sprocket defining the first double tooth structure.

FIG. 10 is a partial view of the front view of an embodiment of the front face of the first sprocket defining the first double tooth structure, the first double tooth structure first section tooth, and the first double tooth structure second section tooth.

FIG. 11 is a partial view of the front view of an embodiment of the front face of the first sprocket defining the second double tooth structure.

FIG. 12 is a partial view of the front view of an embodiment of the front face of the first sprocket defining the second double tooth structure, the second double tooth structure third section tooth, and the second double tooth structure fourth section tooth.

FIG. 13 is a front view of an embodiment of the front face of the first sprocket defining the line segments defining the connection between the four sections of teeth of the sprocket.

FIG. 14 is a side view of the outer edge of the sprocket defining the sprocket horizontal plane.

FIG. 15 is a partial view of an embodiment of the front view of the front face of the first or second sprocket defining the first section tooth tip to tooth tip line segment, the bottom of a valley to first section of tooth tip to tooth tip line segment, and a perpendicular line segment distance.

FIG. 16 is a partial view of an embodiment the front view of the front face of the first or second sprocket defining the angle at the connection of the first straight line segment to the first line segment defining the second section of teeth.

FIG. 17 is a partial view of an embodiment the front view of the front face of the first or second sprocket defining the angle at the connection of the first straight line segment to the first line segment defining the second section of teeth.

FIG. 18 is a partial view of an embodiment of the front view of the front face of the first or second sprocket defining the angle at the connection of the last line segment defining the second section of teeth to the second straight line segment.

FIG. 19 is a partial view of an embodiment of the front view of the front face of the first or second sprocket defining the angle at the connection of the last line segment defining the second section of teeth to the second straight line segment.

FIG. 20 is a partial view of an embodiment of the front view of the front face of the first or second sprocket defining the angle at the connection of the second straight line segment to the first line segment defining the fourth section of teeth.

FIG. 21 is a partial view of an embodiment of the front view of the front face of the first or second sprocket defining the angle at the connection of the second straight line segment to the first line segment defining the fourth section of teeth.

FIG. 22 is a partial view of an embodiment of the front view of the front face of the first or second sprocket defining the angle at the connection of the last line segment defining the fourth section of teeth to the first straight line segment.

FIG. 23 is a partial view of an embodiment of the front view of the front face of the first or second sprocket defining the angle at the connection of the last line segment defining the fourth section of teeth to the first straight line segment.

FIG. 24 is a front view of an embodiment of the front face of the first sprocket with a derailment guard with short crank arms.

FIG. 25 is a front view of an embodiment of the front face of the first sprocket with a derailment guard with long crank arms.

FIG. 26 is a front view of an embodiment of the front face of the first sprocket with a derailment guard with short crank arms with a slap crank arm end structure.

FIG. 27 is a front view of an embodiment of the front face of the first sprocket with a derailment guard with short crank arms with a slap crank arm end structure.

FIG. 28 is a front view of an embodiment of the front face of the first sprocket with a derailment guard with short crank arms with a slap crank arm end structure.

FIG. 29 is a front view of an embodiment of the front face of the first sprocket with a derailment guard with long crank arms with a slap crank arm end structure.

FIG. 30 is a front view of an embodiment of the front face of the sprocket with a derailment guard with short crank arms with a slap crank arm end structure.

FIG. 31 is a side view of an embodiment of the right face of the slap crank arm end structure.

FIG. 32 is a side view of an embodiment of the right face of the slap crank arm end structure.

FIG. 33 is a side view of an embodiment of the right face of the slap crank arm end structure.

FIG. 34 is a rear view of an embodiment of the rear face of the slap crank arm end structure.

FIG. 35 is a front view of an embodiment of the front face of the slap crank arm end structure.

FIG. 36 is a rear view of an embodiment of the rear face of the slap crank arm end structure.

FIG. 37 is a front view of an embodiment of the front face of the slap crank arm end structure.

FIG. 38 is a rear view of an embodiment of the rear face of the slap crank arm lever.

FIG. 39 is a side view of an embodiment of the right face of the slap crank arm lever.

FIG. 40 is a front view of an embodiment of the front face of the slap crank arm lever.

FIG. 41 is a partially exploded front view of an embodiment of the slap crank arm lever and the slap crank arm pivot bar.

FIG. 42 is a partial front view of an embodiment of the slap crank arm pivot bar, slap crank arm pivot bar bushing, and slap crank arm pivot bar bearing.

FIG. 43 is a side view of an embodiment of the slap crank arm rear spring.

FIG. 44 is a side view of an embodiment of the slap crank arm front spring.

FIG. 45 is a front view of an embodiment of a drive structure.

FIG. 46 is a front view of an embodiment of a drive structure with rear derailer.

FIG. 47 is a front view of an embodiment of a drive structure with rear derailer and bicycle frame.

FIG. 48 is a front view of an embodiment of a second sprocket with a derailment guard.

FIG. 49 is a side view of an embodiment of the outer edge of a second sprocket showing the sprocket horizontal plane.

FIG. 50 is a side view of an embodiment of the outer edge of a second sprocket with a derailment guard.

FIG. 51 is a front view of an embodiment of the front face of the second sprocket defining the four sections of teeth.

FIG. 52 is a front view of an embodiment of the front face of the second sprocket defining the four sections of teeth and the first and second ends of the sections of teeth. of the rear derailleur structure.

FIG. 53 is a partial view of an embodiment of the front view of the front face of the second sprocket defining the first double tooth structure.

FIG. 54 is a partial view of the front view of an embodiment of the front face of the second sprocket defining the first double tooth structure, the first double tooth structure first section tooth, and the first double tooth structure second section tooth.

FIG. 55 is a partial view of the front view of an embodiment of the front face of the second sprocket defining the second double tooth structure.

FIG. 56 is a partial view of the front view of an embodiment of the front face of the second sprocket defining the second double tooth structure, the second double tooth structure third section tooth, and the second double tooth structure fourth section tooth.

FIG. 57 is a front view of the front face of the second sprocket defining the first and second point of the sprocket and the first double tooth structure and the second double tooth structure.

FIG. 58 is a front view of an embodiment of the front face of the second sprocket defining the line segments defining the connection between the four sections of teeth of the sprocket.

FIG. 59 is a side view of an embodiment of the rear derailleur structure.

FIG. 60 is a rear view of an embodiment of the rear derailleur structure.

FIG. 61 is a rear view of an embodiment of the rotation tension sprocket bar spring.

FIG. 62 is a partial front view of an embodiment of a drive structure with rear derailer and bicycle frame with focus on the second sprocket.

FIG. 63 is a partial front view of a drive structure with rear derailer and bicycle frame with focus on the second sprocket.

FIG. 64 is a partial front view of an embodiment of a first sprocket and drive chain.

FIG. 65 is a partial front view of an embodiment of a first sprocket and drive chain.

FIG. 66 is a front view of an embodiment of a bicycle with a first sprocket, second sprocket, and rear derailleur structure.

FIG. 67 is a front view of an embodiment of a bicycle with a first sprocket, second sprocket, and rear derailleur structure.

FIG. 68 is a front view of an embodiment of a bicycle with a first sprocket, second sprocket, and rear derailleur structure.

FIG. 69 is a front view of an embodiment of a bicycle with a first sprocket, second sprocket, and rear derailleur structure.

FIG. 70 is a front view of an embodiment of a bicycle with a first sprocket, round second sprocket, and rear derailleur structure.

FIG. 71 is a front view of an embodiment of a bicycle with a first sprocket, second sprocket, and rear derailleur structure.

FIG. 72 is a front view of an embodiment of a bicycle with a first sprocket, second sprocket, and rear derailleur structure.

FIG. 73 is a front view of an embodiment of a bicycle with a first sprocket, second sprocket, and rear derailleur structure.

FIG. 74 is a front view of an embodiment of a bicycle with a first sprocket, second sprocket, and rear derailleur structure.

FIG. 75 is a front view of an embodiment of a bicycle with a first sprocket, second sprocket, and rear derailleur structure.

FIG. 76 is a partial front view of an embodiment of a first crank arm.

FIG. 77 is a partial rear view of an embodiment of a first crank arm.

FIG. 78 is a partial rear view of an embodiment of a second crank arm.

FIG. 79 is a partial front view of an embodiment of a second crank arm.

FIG. 80 is a partial front view of an embodiment of a first crank arm connected to a second crank arm.

FIG. 81 is a partial exploded side view of an embodiment of a first crank arm, spindle, and second crank arm.

FIG. 82 is a rear view of an embodiment of a bolt.

FIG. 83 is a rear view of an embodiment of a spindle with a spindle hole shown.

FIG. 84 is a side view of an embodiment of a first washer.

FIG. 85 is a front view of an embodiment of a first washer.

FIG. 86 is a side view of an embodiment of a lock washer.

FIG. 87 is a front view of an embodiment of a lock washer.

FIG. 88 is a side view of an embodiment of second washer.

FIG. 89 is a front view of an embodiment of second washer.

FIG. 90 is a side view of an embodiment of a nut.

FIG. 91 is a front view of an embodiment of a spindle showing the spindle first end.

FIG. 92 is a rear view of an embodiment of a spindle showing the spindle second end.

FIG. 93 is a side exploded view of an embodiment of a nut, lock washer, first washer, first slap crank arm, spindle, second slap crank arm, second washer, and bolt.

FIG. 94 is a front view of a representation of the relative dimensions of the height and width of a first or second sprocket.

FIG. 95 is a front view of a representation of the relative dimensions of the height and width of a first or second sprocket.

FIG. 96 is a front view of a representation of the relative dimensions of the height and width of a first or second sprocket.

FIG. 97 is a partial view of a first or second sprocket with a double tooth structure.

FIG. 98 is a partial view of a first or second sprocket with a point which is not a double tooth structure.

FIG. 99 is a front view of an embodiment of the first sprocket with double tooth structures.

FIG. 100 is a front view of an embodiment of the first sprocket with double tooth structures.

FIG. 101 is a front view of an embodiment of the first sprocket with double tooth structures.

FIG. 102 is a front view of an embodiment of the first sprocket with a point which is not a double tooth structure.

FIG. 103 is a front view of an embodiment of the first sprocket with a point which is not a double tooth structure.

FIG. 104 is a front view of an embodiment of the first sprocket with a point which is not a double tooth structure.

FIG. 105 a front view of an embodiment of a first sprocket with a larger profile derailment guard.

FIG. 106 is a partial view of a first sprocket with a double tooth structure.

FIG. 107 is a partial view of a first sprocket with a point which is not a double tooth structure.

FIG. 108 is a front view of an embodiment of the first sprocket with a double tooth structure.

FIG. 109 is a front view of an embodiment of the first sprocket with a point which is not a double tooth structure.

FIG. 110 is a front view of an embodiment of a drive structure with rear derailer.

FIG. 111 is a front view of an embodiment of a drive structure with rear derailer and bicycle frame.

FIG. 112 is a front view of an embodiment of a drive structure with rear derailer.

FIG. 113 is a front view of an embodiment of a drive structure with rear derailer and bicycle frame.

FIG. 114 is a front view of an embodiment of a drive structure with rear derailer.

FIG. 115 is a front view of an embodiment of a drive structure with rear derailer and bicycle frame.

FIG. 116 is a front view of an embodiment of a drive structure with rear derailer.

FIG. 117 is a front view of an embodiment of a drive structure with rear derailer and bicycle frame.

FIG. 118 is a front view of an embodiment of a drive structure with rear derailer.

FIG. 119 is a front view of an embodiment of a drive structure with rear derailer and bicycle frame.

FIG. 120 is a front view of an embodiment of a drive structure.

FIG. 121 is a front view of an embodiment of a drive structure and bicycle frame.

FIG. 122 is a partial front view of an embodiment of a drive chain, first sprocket, and crank arms.

FIG. 123 is a partial front view of an embodiment of a drive chain, first sprocket, and crank arms.

FIG. 124 is a front view of an embodiment of a drive structure with rear derailer.

FIG. 125 is a front view of an embodiment of a drive structure with rear derailer and bicycle frame.

FIG. 126 is a front view of an embodiment of a first sprocket with a position of the first and second crank arm.

FIG. 127 is a front view of an embodiment of a first sprocket with a position of the first and second crank arm.

FIG. 128 is a front view of an embodiment of a first sprocket with a position of the first and second crank arm.

FIG. 129 is a front view of an embodiment of a first sprocket with a position of the first and second crank arm.

FIG. 130 is a front view of an embodiment of a first sprocket with a position of the first and second crank arm.

FIG. 131 is a front view of an embodiment of a first sprocket with a position of the first and second crank arm.

FIG. 132 is a front view of an embodiment of a first sprocket with a position of the first and second crank arm.

FIG. 133 is a front view of an embodiment of a first sprocket with a position of the first and second crank arm.

FIG. 134 is a front view of an embodiment of a first sprocket with a position of the first and second crank arm.

FIG. 135 is a front view of an embodiment of a first sprocket with a position of the first and second crank arm.

FIG. 136 is a front view of an embodiment of a first sprocket with a position of the first and second crank arm.

FIG. 137 is a front view of an embodiment of a first sprocket with a position of the first and second crank arm.

FIG. 138 is a front view of an embodiment of a first sprocket with a position of the first and second crank arm.

FIG. 139 is a front view of an embodiment of a first sprocket with a position of the first and second crank arm.

FIG. 140 is a front view of an embodiment of a first sprocket with a position of the first and second crank arm.

FIG. 141 is a front view of an embodiment of a first sprocket with a position of the first and second crank arm.

FIG. 142 is a front view of an embodiment of a first sprocket with a position of the first and second crank arm.

FIG. 143 is a front view of an embodiment of a first sprocket with a position of the first and second crank arm.

FIG. 144 is a front view of an embodiment of a first sprocket with a position of the first and second crank arm.

FIG. 145 is a front view of an embodiment of a first sprocket with a position of the first and second crank arm.

FIG. 146 is a front view of an embodiment of a first sprocket with a position of the first and second crank arm.

FIG. 147 is a front view of an embodiment of a first sprocket with a position of the first and second crank arm.

FIG. 148 is a front view of an embodiment of a first sprocket with a position of the first and second crank arm.

FIG. 149 is a front view of an embodiment of a first sprocket with a position of the first and second crank arm.

FIG. 150 is a front view of an embodiment of a first sprocket with a position of the first and second crank arm.

FIG. 151 is a front view of an embodiment of a first sprocket with a position of the first and second crank arm.

FIG. 152 is a front view of an embodiment of a first sprocket with a position of the first and second crank arm.

FIG. 153 is a front view of an embodiment of a first sprocket with a position of the first and second crank arm.

FIG. 154 is a front view of an embodiment of a first sprocket with a position of the first and second crank arm.

FIG. 155 is a front view of an embodiment of a first sprocket with a position of the first and second crank arm.

FIG. 156 is a front view of an embodiment of a first sprocket with a position of the first and second crank arm.

FIG. 157 is a front view of a relative orientation of the rotation of the first sprocket to the second sprocket.

FIG. 158 is a front view of a relative orientation of the rotation of the first sprocket to the second sprocket.

FIG. 159 is a front view of a relative orientation of the rotation of the first sprocket to the second sprocket.

FIG. 160 is a front view of a relative orientation of the rotation of the first sprocket to the second sprocket.

FIG. 161 is a front view of a relative orientation of the rotation of the first sprocket to the second sprocket.

FIG. 162 is a front view of a relative orientation of the rotation of the first sprocket to the second sprocket.

FIG. 163 is a front view of a relative orientation of the rotation of the first sprocket to the second sprocket.

FIG. 164 is a front view of a relative orientation of the rotation of the first sprocket to the second sprocket.

FIG. 165 is a front view of a relative orientation of the rotation of the first sprocket to the second sprocket.

FIG. 166 is a front view of a relative orientation of the rotation of the first sprocket to the second sprocket.

FIG. 167 is a front view of a relative orientation of the rotation of the first sprocket to the second sprocket.

FIG. 168 is a front view of a relative orientation of the rotation of the first sprocket to the second sprocket.

FIG. 169 is a front view of a relative orientation of the rotation of the first sprocket to the second sprocket.

FIG. 170 is a front view of a relative orientation of the rotation of the first sprocket to the second sprocket.

FIG. 171 is a front view of a relative orientation of the rotation of the first sprocket to the second sprocket.

FIG. 172 is a front view of a relative orientation of the rotation of the first sprocket to the second sprocket.

FIG. 173 is a front view a representation of a first sprocket and a non-pointed sprocket in the rear of a bicycle.

FIG. 174 is a front view a representation of a first sprocket and a non-pointed sprocket in the rear of a bicycle.

FIG. 175 is a front view of an embodiment of a bicycle with a first sprocket, second sprocket, and rear derailleur structure.

FIG. 176 is a front view of an embodiment of a bicycle with a first sprocket, second sprocket, and rear derailleur structure.

FIG. 177 is a front view of an embodiment of a bicycle with a first sprocket, second sprocket, and rear derailleur structure.

FIG. 178 is a front view of an embodiment of a bicycle with a first sprocket, second sprocket, and rear derailleur structure.

FIG. 179 is a partial front view of an embodiment of a drive structure with rear derailer and bicycle frame with focus on the second sprocket.

FIG. 180 is a partial front view of an embodiment of a drive structure with rear derailer and bicycle frame with focus on the second sprocket.

FIG. 181 is front view of an embodiment of the front face of the first sprocket with a derailment guard.

FIG. 182 is a side view of an embodiment of the outer edge of the first sprocket with a derailment guard.

FIG. 183 is a front view an embodiment of the front face of the sprocket with a chain arranged around the outer edge of the sprocket.

FIG. 184 is a front view of an embodiment of the front face of the first sprocket defining the four sections of teeth.

FIG. 185 is a front view of an embodiment of the front face of the first sprocket defining the four sections of teeth and the first and second ends of the sections of teeth.

FIG. 186 is a front view of the front face of the first sprocket defining the first and second point of the sprocket and the first double tooth structure and the second double tooth structure, and the outer edge of the first sprocket.

FIG. 187 is a front view of an embodiment of the front face of the first sprocket defining the line segments defining the connection between the four sections of teeth of the sprocket.

FIG. 188 is a partial view of an embodiment of the front view of the front face of the first or second sprocket defining the first section tooth tip to tooth tip line segment, the bottom of a valley to first section of tooth tip to tooth tip line segment, and a perpendicular line segment distance.

FIG. 189 is a partial view of an embodiment the front view of the front face of the first or second sprocket defining the angle at the connection of the first straight line segment to the first line segment defining the second section of teeth.

FIG. 190 is a partial view of an embodiment the front view of the front face of the first or second sprocket defining the angle at the connection of the first straight line segment to the first line segment defining the second section of teeth.

FIG. 191 is a partial view of an embodiment of the front view of the front face of the first or second sprocket defining the angle at the connection of the last line segment defining the second section of teeth to the second straight line segment.

FIG. 192 is a partial view of an embodiment of the front view of the front face of the first or second sprocket defining the angle at the connection of the last line segment defining the second section of teeth to the second straight line segment.

FIG. 193 is a partial view of an embodiment of the front view of the front face of the first or second sprocket defining the angle at the connection of the second straight line segment to the first line segment defining the fourth section of teeth.

FIG. 194 is a partial view of an embodiment of the front view of the front face of the first or second sprocket defining the angle at the connection of the second straight line segment to the first line segment defining the fourth section of teeth.

FIG. 195 is a partial view of an embodiment of the front view of the front face of the first or second sprocket defining the angle at the connection of the last line segment defining the fourth section of teeth to the first straight line segment.

FIG. 196 is a partial view of an embodiment of the front view of the front face of the first or second sprocket defining the angle at the connection of the last line segment defining the fourth section of teeth to the first straight line segment.

FIG. 197 is a front view of an embodiment of the front face of the first sprocket with a derailment guard with short crank arms.

FIG. 198 is a front view of an embodiment of the front face of the first sprocket with a derailment guard with long crank arms.

FIG. 199 is a front view of an embodiment of the front face of the first sprocket with a derailment guard with short crank arms with a slap crank arm end structure.

FIG. 200 is a front view of an embodiment of the front face of the first sprocket with a derailment guard with short crank arms with a slap crank arm end structure.

FIG. 201 is a front view of an embodiment of the front face of the first sprocket with a derailment guard with short crank arms with a slap crank arm end structure.

FIG. 202 is a front view of an embodiment of the front face of the first sprocket with a derailment guard with long crank arms with a slap crank arm end structure.

FIG. 203 is a front view of an embodiment of the front face of the sprocket with a derailment guard with short crank arms with a slap crank arm end structure.

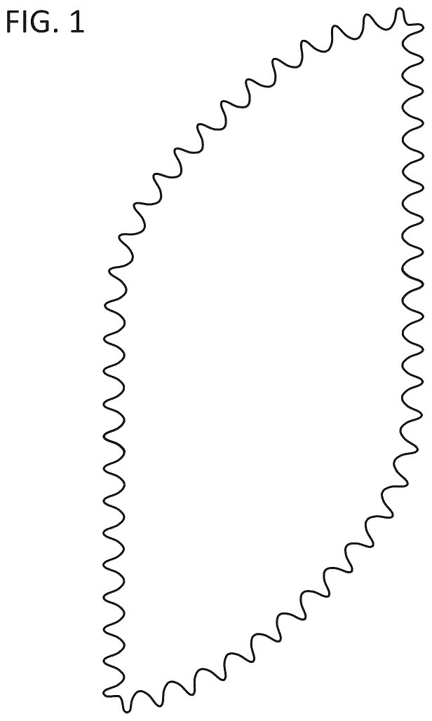

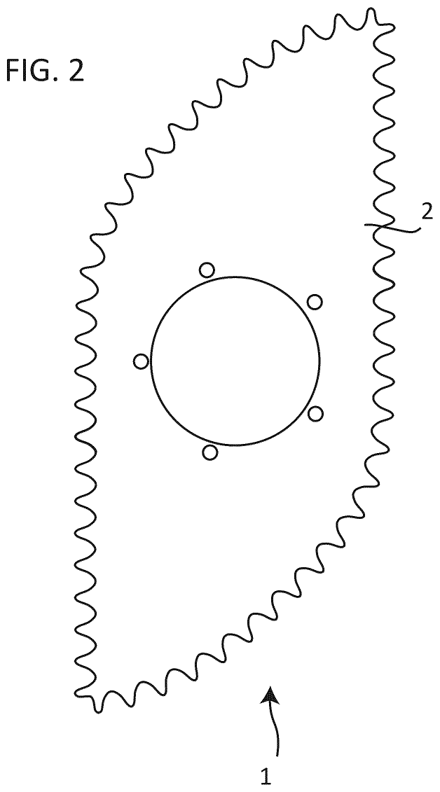

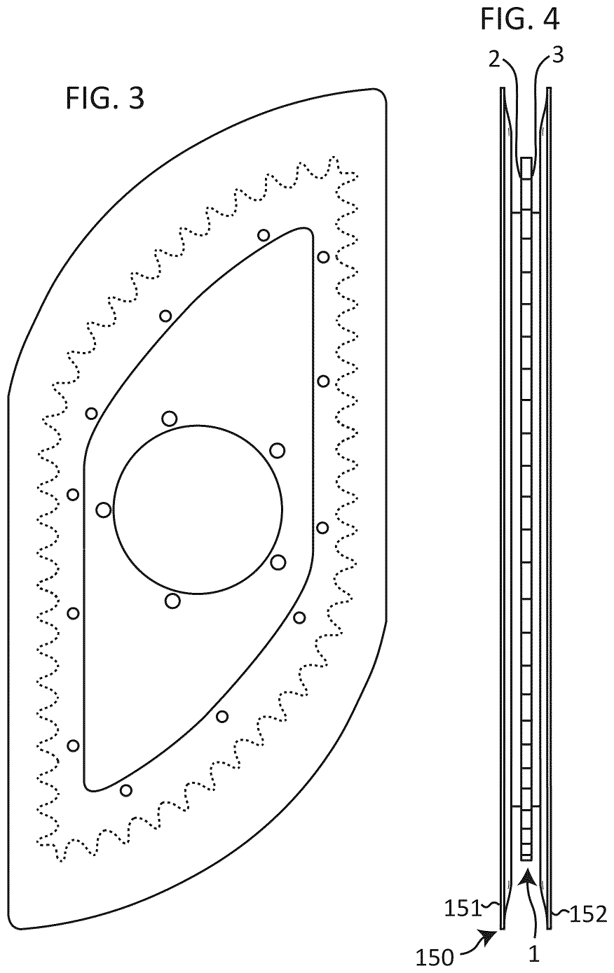

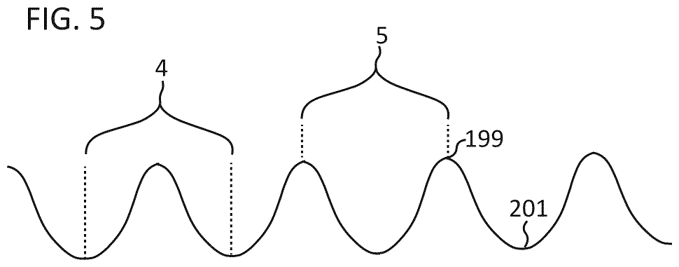

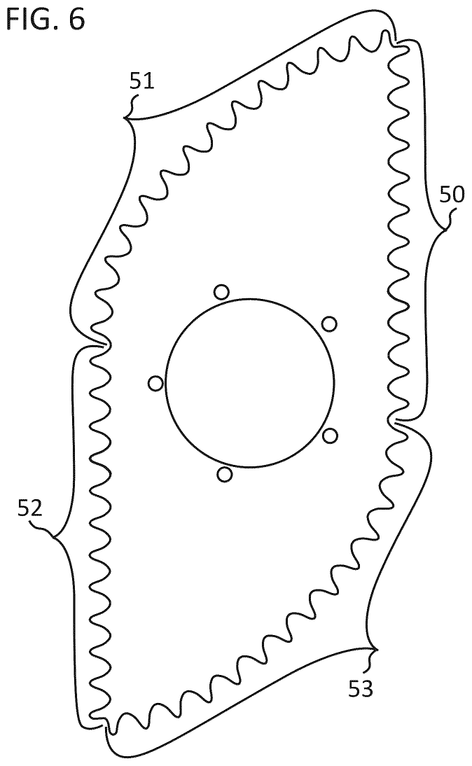

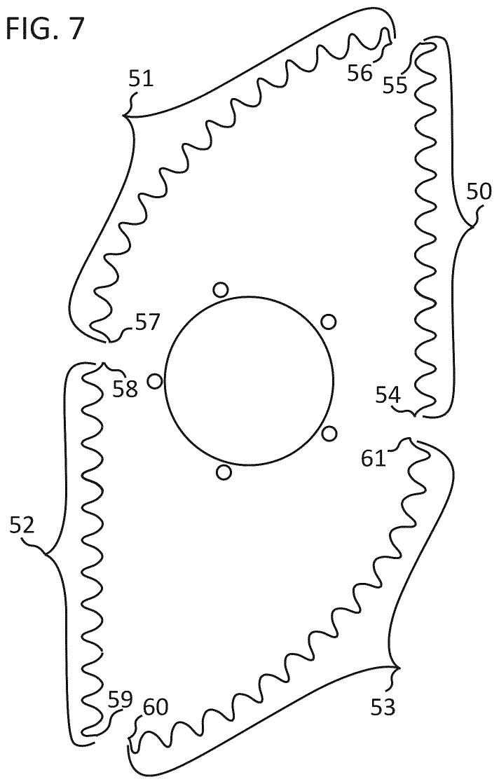

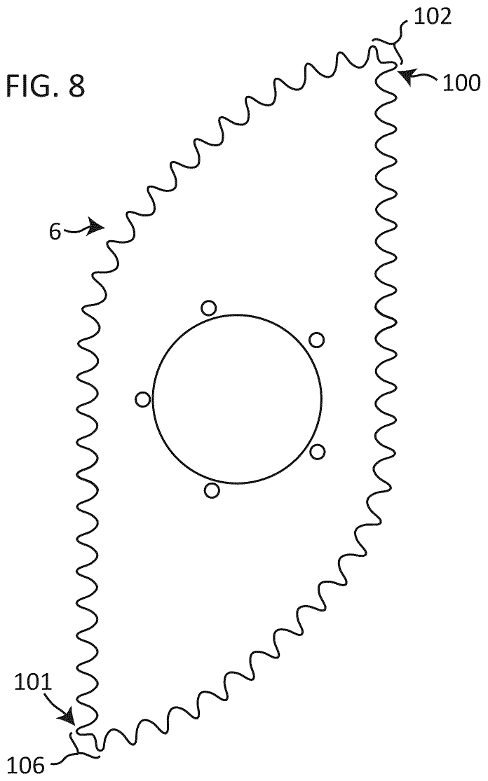

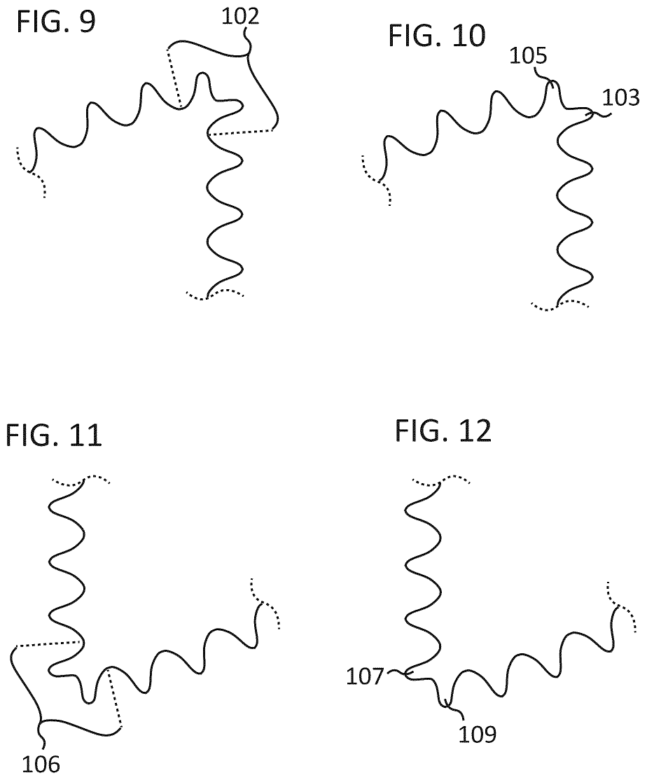

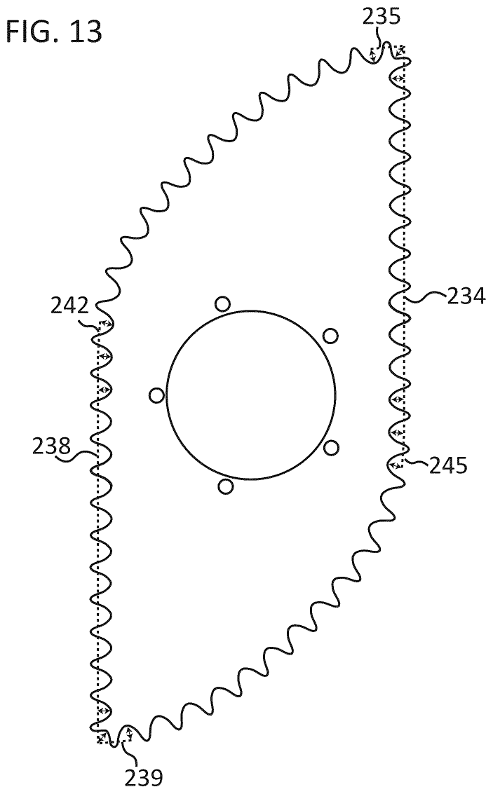

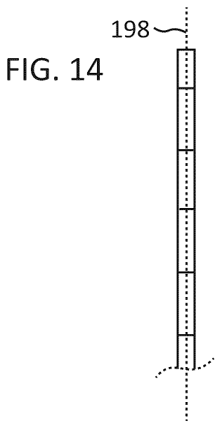

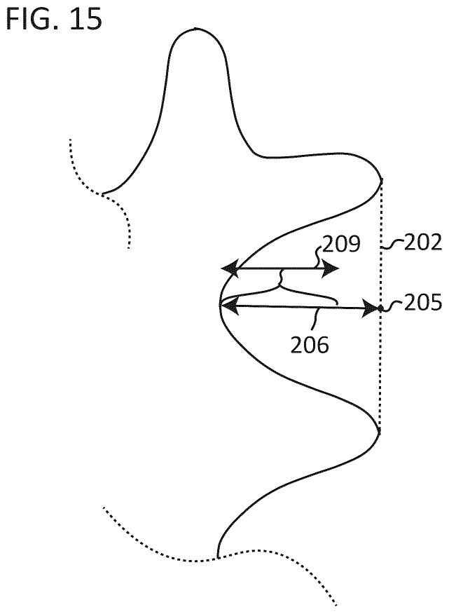

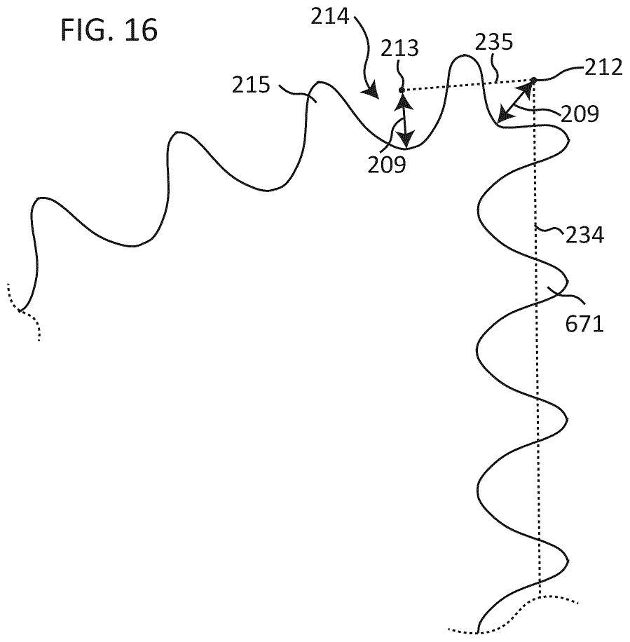

### DETAILED DESCRIPTION OF THE INVENTION

Described is an embodiment of a drive structure 30. A drive structure 30 includes a first sprocket 1; second sprocket 70; drive chain 20; spindle 700; first slap crank arm 290; and second slap crank arm 291.

Also described is an embodiment of a drive structure with rear derailer and bicycle frame 40. An embodiment of the drive structure with rear derailer and bicycle frame 40 includes a drive structure 30 of a first sprocket 1, second sprocket 70, drive chain 20, spindle 700, first slap crank arm 290, and second slap crank arm 291; and a bicycle frame 600; and rear derailleur structure 500.

Also described is an embodiment of a drive structure with rear derailer 39, which contains: a drive structure 30 of a first sprocket 1, second sprocket 70, drive chain 20, spindle 700, first slap crank arm 290, and second slap crank arm 291; and rear derailleur structure 500.

Also described is an embodiment of a drive structure and bicycle frame 41, which contains: a drive structure 30 of a first sprocket 1, second sprocket 70, drive chain 20, spindle 700, first slap crank arm 290, and second slap crank arm 291, and a bicycle frame 600.

Embodiments of the first sprocket 1 and second sprocket 70 can be described with similar parts, which are used to describe each of the sprockets.

The first and second sprocket are unique in the quality of the two points on the sprocket outer edge 6, and the shape of each sprocket.

An embodiment of the first sprocket 1 and second sprocket 70 has: a sprocket front face 2; a sprocket rear face 3; and a sprocket outer edge 6.

For each sprocket, the sprocket front face 2 and the sprocket rear face 3 each has a shape. The shape of the sprocket front face 2 and the sprocket rear face 3 is the same, looking through the sprocket. If an impression of the shape was taken on both sides, the shape would be a mirror image of each other for the front face 2 and the rear face 3. The sprocket is generally flat and the shape can be described when viewing the flat sides of the sprocket, or the sprocket front face 2 and the sprocket rear face 3. When describing the shape of the first sprocket 1 and second sprocket 70 the points are in the general shape of the flat sides. For ease the shape of the sprocket and sections of teeth can also be defined by looking at the front face of each sprocket.

Around the first sprocket 1 and second sprocket 70 is an outer edge 6. Between each tooth is a valley 5. Each valley has a bottom of a valley 201. A tooth 4, or the tooth boundary, is defined from the bottom of the valley 201 on one side of the tooth 4 to the bottom of the valley 201 on the other side of the tooth 4. Each tooth 4 has a tooth tip 199. The tooth tip 199 is the part of the tooth 4 the farthest way from the sprocket. A valley 5 is defined as the area from one tooth tip 199 to the next adjacent tooth tip 199. The valley 5 is defined as the area from one tooth tip 199 to the next adjacent tooth tip 199 even though a portion of the valley boundary overlaps with a tooth boundary.

The drive chain 20 can include an embodiment of a typical bicycle chain. The drive chain 20 is one enclosed loop. The teeth 4 of the first sprocket 1 and the second sprocket 70 engage into the drive chain 20.

In drive structure 30, the drive chain 20 wraps around the first sprocket 1 and the second sprocket 70. The drive chain 20 is configured where there is: a section of the outer edge of the first sprocket of contact of the drive chain and the first sprocket 42; and a section of the outer edge of the second sprocket of contact of the drive chain and the second sprocket 43. The drive chain is one enclosed loop where the drive chain travels from the outer edge of the first sprocket to the outer edge of the second sprocket then around the section of the outer edge of the second sprocket of contact of the drive chain and the second sprocket 43, then back to the outer edge of the first sprocket and then around the section of the outer edge of the first sprocket of contact of the drive chain and the first sprocket 42.

The drive structure with rear derailer and bicycle frame 40 has two additional components of a bicycle frame 600 and rear derailleur structure 500, as compared to the drive structure 30.

A bicycle frame 600 is a typical bicycle frame with tubing of metal or other material such as carbon fiber, or other embodiments of a bicycle frame. The bicycle frame 600 has a bicycle frame front tip 601 and a bicycle frame rear tip 602. The bicycle front tire is oriented closer to the bicycle frame front tip 601. The bicycle rear tire is oriented closer to the bicycle frame rear tip 602. The other main components of a typical bicycle which are not part of the bicycle frame 600 are the fork, handle bars, seat, and seat post.

An embodiment of each of the first sprocket 1 and second sprocket 70 has four sections of teeth. Two of the sections of teeth have a general shape of being inline or straight, as viewed from the front face of each sprocket. Two of the sections of the teeth have a general shape of being curved, as viewed from the front face of each sprocket. The sprocket sections of teeth can be defined as a first section of teeth 50, second section of teeth 51, third section of teeth 52, fourth section of teeth 53. The first section of teeth 50 is in a straight line. The third section of teeth 52 is in a straight line. The second section of teeth 51 is curved. The fourth section of teeth 53 is curved.

Each of the four sections of teeth has a first end and a second end. The second end of the first section of teeth 55 connects to the first end of the second section of teeth 56, the second end of the second section of teeth 57 connects to the first end of third section of teeth 58, the second end of the third section of teeth 59 connects to the first end of the fourth section of teeth 60, the second end of the fourth section of teeth 61 connects to the first end of the first section of teeth 54.

For the first sprocket 1 and the second sprocket 70, as viewed from the front face of each sprocket, there is a first point 100 and a second point 101 in the shape of the front face 2.

The first point 100 in the shape of the front face 2 is at the second end of the first section of teeth 55 and the first end of the second section of teeth 56. The second point 101 in the shape of the front face 2 is at the second end of the third section of teeth 59 and the first end of the fourth section of teeth 60.

Embodiments of the connection of the second section of teeth 51 to the third section of teeth and the connection of the fourth section of teeth 53 to the first section of teeth 50 can be a gradual transition from the curved section to the straight section.

In an embodiment of the first sprocket 1 and second sprocket 70, the first and second end of each of the first, second, third, and fourth section falls at a bottom of a valley 201.

In an embodiment of the first sprocket 1 and the second sprocket 70, each of the following can fall at a bottom of a valley 201: the second end of the first section of teeth 55; the first end of the second section of teeth 56; the second end of the third section of teeth 59; and the first end of the fourth section of teeth 60.

In an embodiment of the first sprocket 1 and second sprocket 70, where the first and second end of each of the first, second, third, and fourth section falls at a bottom of a valley 201, there can be a first double tooth structure 102 and a second double tooth structure 106. Also, there can be a first double tooth structure 102 and a second double tooth structure 106 in an embodiment of the first sprocket 1 and second sprocket 70, each of the following can fall at a bottom of a valley 201: the second end of the first section of teeth 55; the first end of the second section of teeth 56; the second end of the third section of teeth 59; and the first end of the fourth section of teeth 60.

The sprocket first double tooth structure 102 is formed by two symmetrical parts. The first double tooth structure 102 has a first section tooth and a second section tooth. The first section of teeth 50 has a tooth directly adjacent to the second end of the sprocket first section of teeth 55. The tooth in the first section of teeth 50 directly adjacent to the second end of the first section of teeth 55 is the first section tooth of the first double tooth structure, also called the first double tooth structure first section tooth 103. The second section of teeth 51 has a tooth directly adjacent to the first end of the second section of teeth 56. The tooth in the second section of teeth 51 directly adjacent to the first end of the second section of teeth 56 is the second section tooth of the first double tooth structure, also called the first double tooth structure second section tooth 105. The first double tooth structure 102 is formed from the first double tooth structure first section tooth 103 and the first double tooth structure second section tooth 105.

The second double tooth structure 106 formed by two symmetrical parts. The second double tooth structure 106 has a first section tooth and a second section tooth. The third section of teeth 52 has a tooth directly adjacent to the second end of the third section of teeth 59. The tooth in the third section of teeth 52 directly adjacent to the second end of the third section of teeth 59 is the third section tooth of the second double tooth structure, also called the second double tooth structure third section tooth 107. The fourth section of teeth 53 has a tooth directly adjacent to the first end of the fourth section of teeth 60. The tooth in the fourth section of teeth 53 directly adjacent to the first end of the fourth section of teeth 60 is the fourth section tooth of the second double tooth structure, also called the second double tooth structure fourth section tooth 109. The second double tooth structure 106 is formed from the second double tooth structure third section tooth 107 and the second double tooth structure fourth section tooth 109.

The shape of the first sprocket 1 and the second sprocket 70 is viewed from the general overall shape by looking at the front face of the sprocket. For the shape of each of the first section and second section tooth of each of the first and second double tooth structure on each sprocket, the shape is defined by the profile of the tooth when viewing the front face of each sprocket.

The first double tooth structure first section tooth 103 has a shape. The first double tooth structure second section tooth 105 has a shape. The shape of the first double tooth structure first section tooth 103 is the mirror image of the shape of the first double tooth structure second section tooth 105.

The second double tooth structure third section tooth 107 has a shape. The second double tooth structure fourth section tooth 109 has a shape. The shape of the second double tooth structure third section tooth 107 is the mirror image of the shape of the second double tooth structure fourth section tooth 109.

The shape of the first double tooth structure first section tooth 103 and the shape of the second double tooth structure third section tooth 107 is the same. The shape of the first double tooth structure second section tooth 105 and the shape of the second double tooth structure fourth section tooth 109 is the same.

The shape of the embodiments of each the first sprocket 1 and second sprocket 70 can be defined by defining the general angle between points of the sprocket, where the angle is defined between the inline section of the teeth and the curved section of teeth which join to form the point. Also the connection of the curved section to the inline section of teeth can be defined by line segments.

Line segments which join at a point are used to define the angle between the inline section of teeth and the curved section of teeth. The line segments, any other line segments used in a definition of the line segments, and the starting and stopping points are all within the sprocket horizontal plane 198 of each of the first sprocket 1 and second sprocket 70. The sprocket horizontal plane 198 is in the middle of the width of the first sprocket 1 and second sprocket 70 when viewing the sprocket outer edge 6.

The line segments used to define the angle between the inline section of teeth and the curved section of teeth are defined by starting and stopping points which form the line segments. The starting and stopping points are a defined distance away from specific bottom of the valleys of the sprocket.

The first double tooth structure first section tooth 103 can be called the first section tooth of the first double tooth. The second section tooth of the first double tooth structure can be called the first double tooth structure second section tooth 105. The second double tooth structure third section tooth 107 can be called the third section tooth of the second double tooth structure. The second double tooth structure fourth section tooth 109 can be called the fourth section tooth of the second double tooth structure.

The distance of the starting and stopping points for the line segments away from the bottom of the valleys starts by defining the first section tooth tip to tooth tip line segment 202.

The first section tooth tip to tooth tip line segment 202 has a first end and a second end. The first end of the first section tooth tip to tooth tip line segment is at the tip of the first section tooth of the first double tooth. The second end of the first section tooth tip to tooth tip line segment is at the tip of the tooth in the first section of teeth adjacent to the first section tooth of the first double tooth structure 671. There is a middle point of the first section tooth tip to tooth tip line segment 205. There is a bottom of a valley to first section of tooth tip to tooth tip line segment 206. The bottom of a valley to first section of tooth tip to tooth tip line segment 206 has a first end and a second end. The first end of the bottom of a valley to first section of tooth tip to tooth tip line segment is at the bottom of the valley between the first section tooth of the first double tooth structure (first double tooth structure first section tooth 103) and the tooth in the first section of teeth adjacent to the first section tooth of the first double tooth structure 671. The second end of the bottom of a valley to first section of tooth tip to tooth tip line segment is at the middle point of a first section tooth tip to tooth tip line segment 205.

Additionally, there is a perpendicular line segment distance 209. The perpendicular line segment distance 209 has a first end and a second end. The first end of the perpendicular line segment distance is at the bottom of the valley between the first section tooth of the first double tooth structure and the tooth in the first section of teeth adjacent to the first section tooth of the first double tooth structure 671. The second end of the perpendicular line segment distance is a point along the bottom of a valley to first section of tooth tip to tooth tip line segment 206. The perpendicular line segment distance 209 is 0.65 to 0.85 times the length of the bottom of a valley to first section of tooth tip to tooth tip line segment 206. The starting and stopping points of the line segments defining the angles are a perpendicular line segment distance 209 away from the bottom of particular valleys.

Additionally, there is a first double tooth perpendicular line segment distance end point 212. The first double tooth perpendicular line segment distance end point 212 is a perpendicular line segment distance 209 away from the sprocket from the bottom of the valley between the first section tooth of the first double tooth structure and the second section tooth of the first double tooth structure, the first double tooth perpendicular line segment distance end point 212 is equal distant from the first section tooth of the first double tooth structure and the second section tooth of the first double tooth structure (first double tooth structure second section tooth 105).

Additionally, there is a first valley of the second section of teeth perpendicular line segment end point 213. The valley in the second section of teeth adjacent to the valley between the first section tooth and second section tooth of the first double tooth structure is the first valley of the second section of teeth. The first valley of the second section of teeth perpendicular line segment end point 213 is a perpendicular line segment distance 209 away from the sprocket from the bottom of the valley of the first valley of the second section of the teeth. There is a tooth of the second section of teeth adjacent to the second section tooth of the first double tooth structure 215. The first valley of the second section of teeth perpendicular line segment end point 213 is equal distant from the second section tooth of the first double tooth structure and the tooth of the second section of teeth adjacent to the second section tooth of the first double tooth structure 215.

Additionally, there is a last valley of the second section of teeth perpendicular line segment end point 216. There is a valley at the second end of the second section of teeth and the first end of the third section of teeth 217. There is a valley in the second section of teeth adjacent to the valley at the second end of the second section of teeth and the first end of the third section of teeth is the last valley of the second section of teeth. The valley in the second section of teeth adjacent to the valley at the second end of the second section of teeth and the first end of the third section of teeth is the last valley of the second section of teeth 218. There is a tooth of the second section of teeth adjacent to the valley at the second end of the second section of teeth and the first end of the third section of teeth 219. There is a tooth of the second section of teeth adjacent to the tooth of the second section of teeth adjacent to the valley at the second end of the second section of teeth and the first end of the third section of teeth 220. There is a bottom of the valley at the last valley of the second section of the teeth. The last valley of the second section of teeth perpendicular line segment end point 216 is a perpendicular line segment distance 209 away from the sprocket from the bottom of the valley of the last valley of the second section of the teeth. The last valley of the second section of teeth perpendicular line segment end point 216 is equal distant from the tooth of the second section of teeth adjacent to the valley at the second end of the second section of teeth and the first end of the third section of teeth 219 and the tooth of the second section of teeth adjacent to the tooth of the second section of teeth adjacent to the valley at the second end of the second section of teeth and the first end of the third section of teeth 220.

Additionally, there is a connection of the second section and third section of teeth perpendicular line segment distance end point 221. There is a bottom of the valley at the second end of the second section of teeth and the first end of the third section of teeth. There is a tooth of the third section of teeth adjacent to the valley at the second end of the second section of teeth and the first end of the third section of teeth 222. The connection of the second section and third section of teeth perpendicular line segment distance end point 221 is a perpendicular line segment distance 209 away from the sprocket from the bottom of the valley at the second end of the second section of teeth and the first end of the third section of teeth, the connection of the second section and third section of teeth perpendicular line segment distance end point is equal distant from the tooth of the second section of teeth adjacent to the valley at the second end of the second section of teeth and the first end of the third section of teeth 219 and the tooth of the third section of teeth adjacent to the valley at the second end of the second section of teeth and the first end of the third section of teeth 222.

Additionally, there is a second double tooth perpendicular line segment distance end point 223. The second double tooth perpendicular line segment distance end point 223 is a perpendicular line segment distance 209 away from the sprocket from the bottom of the valley between the third section tooth of the second double tooth structure and the fourth section tooth of the second double tooth structure.

Additionally, there is a first valley of the fourth section of teeth perpendicular line segment end point 224. There is a first valley of the fourth section of teeth 225. The valley in the fourth section of teeth adjacent to the valley between the third section tooth and fourth section tooth of the second double tooth structure is the first valley of the fourth section of teeth 225. The first valley of the fourth section of teeth perpendicular line segment end point 224 is a perpendicular line segment distance 209 away from the sprocket from the bottom of the valley of the first valley of the fourth section of the teeth. There is a tooth of the fourth section of teeth adjacent to the fourth section tooth of the second double tooth structure 226. The first valley of the fourth section of teeth perpendicular line segment end point 224 is equal distant from the fourth section tooth of the second double tooth structure and the tooth of the fourth section of teeth adjacent to the fourth section tooth of the second double tooth structure 226.

Additionally, there is a last valley of the fourth section of teeth perpendicular line segment end point 227. The is a valley at the second end of the fourth section of teeth and the first end of the first section of teeth 228. There is a valley in the fourth section of teeth adjacent to the valley at the second end of the fourth section of teeth and the first end of the first section of teeth. The valley in the fourth section of teeth adjacent to the valley at the second end of the fourth section of teeth and the first end of the first section of teeth is the last valley of the fourth section of teeth 229. There is a tooth of the fourth section of teeth adjacent to the valley at the second end of the fourth section of teeth and the first end of the first section of teeth 230. There is a tooth of the fourth section of teeth adjacent to the tooth of the fourth section of teeth adjacent to the valley at the second end of the fourth section of teeth and the first end of the first section of teeth 231. There is a bottom of the valley at the last valley of the fourth section of the teeth. The last valley of the fourth section of teeth perpendicular line segment end point 227 is a perpendicular line segment distance 209 away from the sprocket from the bottom of the valley of the last valley of the fourth section of the teeth. The last valley of the fourth section of teeth perpendicular line segment end point 227 is equal distant from the tooth of the fourth section of teeth adjacent to the valley at the second end of the fourth section of teeth and the first end of the first section of teeth 230 and the tooth of the fourth section of teeth adjacent to the tooth of the fourth section of teeth adjacent to the valley at the second end of the fourth section of teeth and the first end of the first section of teeth 231.

Additionally, there is a connection of the fourth section and first section of teeth perpendicular line segment distance end point 232. There is a bottom of the valley at the second end of the fourth section of teeth and the first end of the first section of teeth. There is a tooth of the first section of teeth adjacent to the valley at the second end of the fourth section of teeth and the first end of the first section of teeth 233. The connection of the fourth section and first section of teeth perpendicular line segment distance end point 232 is a perpendicular line segment distance 209 away from the sprocket from the bottom of the valley at the second end of the fourth section of teeth and the first end of the first section of teeth. The connection of the fourth section and first section of teeth perpendicular line segment distance end point 232 is equal distant from the tooth of the fourth section of teeth adjacent to the valley at the second end of the fourth section of teeth and the first end of the first section of teeth 230 and the tooth of the first section of teeth adjacent to the valley at the second end of the fourth section of teeth and the first end of the first section of teeth 233.

The line segments and angles are defined as follows.

There is a first straight line segment 234. The first straight line segment 234 has a first end and a second end. The first end of the first straight line segment is the connection of the fourth section and first section of teeth perpendicular line segment distance end point 232. The second end of the first straight line segment is the first double tooth perpendicular line segment distance end point 212.

There is a first line segment defining the second section of teeth 235. The first line segment defining the second section of teeth has a first end and a second end. The first end of the first line segment defining the second section of teeth is the first double tooth perpendicular line segment distance end point 212 and the second end of the first line segment defining the second section of teeth is the first valley of the second section of teeth perpendicular line segment end point 213.

There is a connection of the first straight line segment 234 to the first line segment defining the second section of teeth 235 at the first double tooth perpendicular line segment distance end point 212.

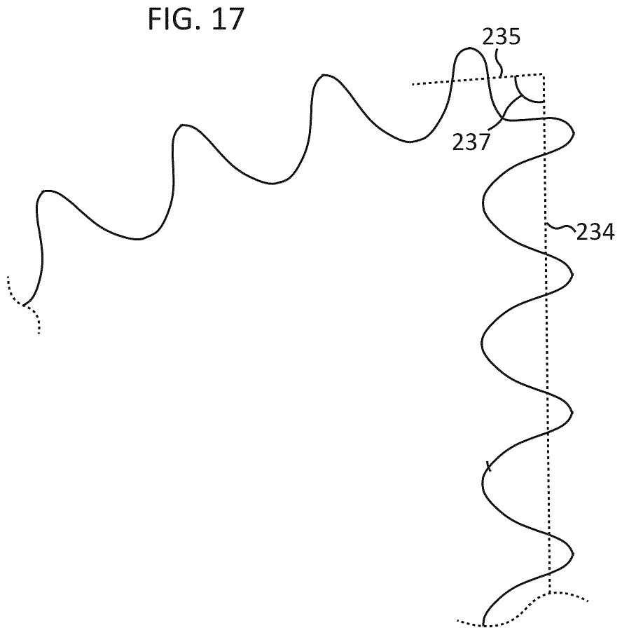

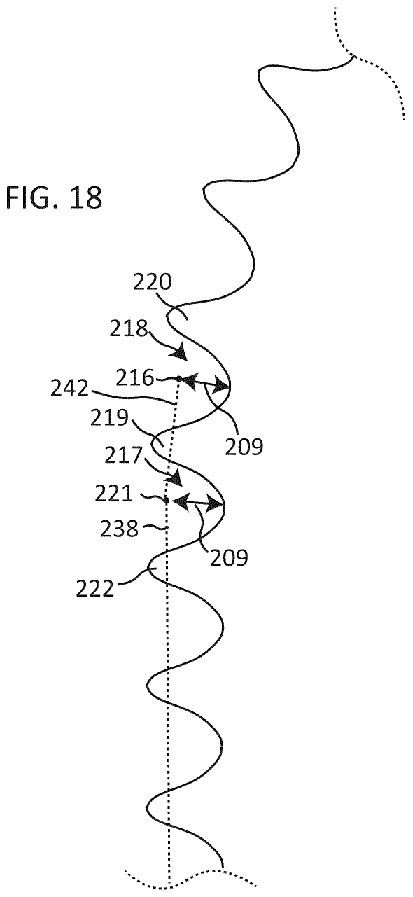

There is an angle at the connection of the first straight line segment to the first line segment defining the second section of teeth 237. The angle at the connection of the first straight line segment to the first line segment defining the second section 237 of teeth is between 81 and 89 degrees, as in FIG. 17, where the embodiment is at 85 degrees in the figure.

There is a second straight line segment 238. The second straight line segment 238 has a first end and a second end. The first end of the second straight line segment is the connection of the second section and third section of teeth perpendicular line segment distance end point 221 and the second end of the second straight line segment is the second double tooth perpendicular line segment distance end point 223.

There is a first line segment defining the fourth section of teeth 239. The first line segment defining the fourth section of teeth 239 has a first end and a second end. The first end of the first line segment defining the fourth section of teeth is the second double tooth perpendicular line segment distance end point 223 and the second end of the first line segment defining the fourth section of teeth is the first valley of the fourth section of teeth perpendicular line segment end point 224.

There is a connection of the second straight line segment 238 to the first line segment defining the fourth section of teeth 239 at the second double tooth perpendicular line segment distance end point 223.

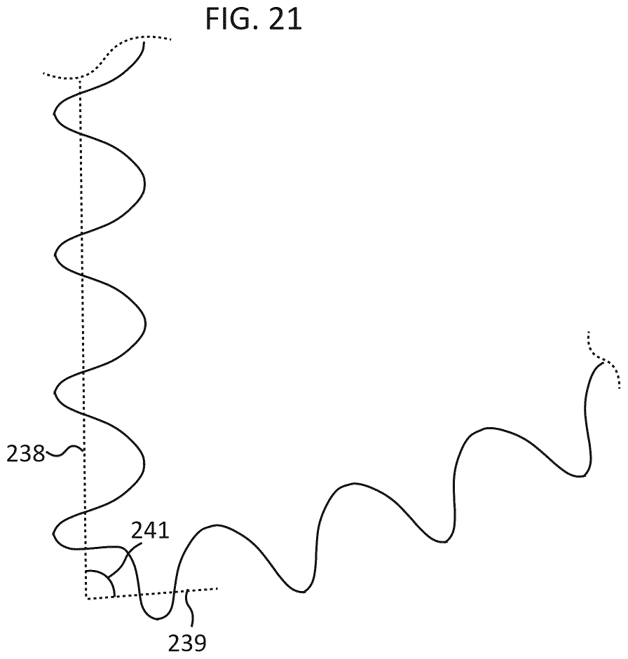

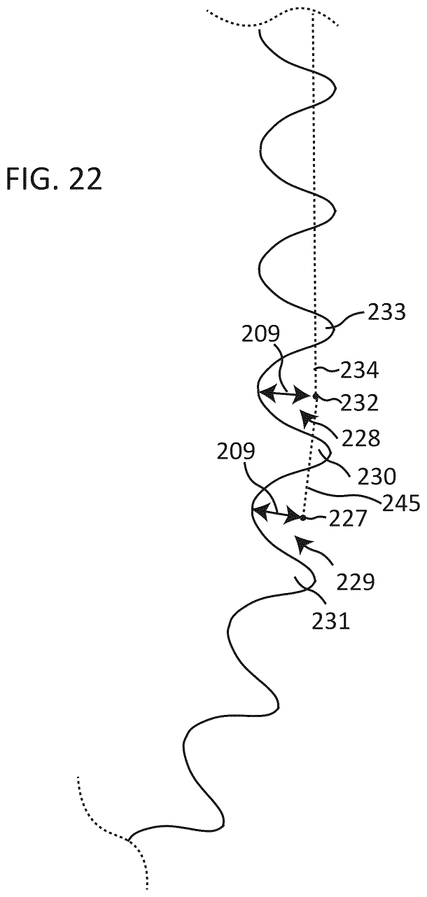

There is an angle at the connection of the second straight line segment to the first line segment defining the fourth section of teeth 241. The angle at the connection of the second straight line segment to the first line segment defining the fourth section of teeth 241 is between 81 and 89 degrees, as in FIG. 21, where the embodiment is at 85 degrees as in the figure.

There is last line segment defining the second section of teeth 242. The last line segment defining the second section of teeth has a first end and a second end. The first end of the last line segment defining the second section of teeth is the last valley of the second section of teeth perpendicular line segment end point 216 and the second end of the last line segment defining the second section of teeth is the connection of the second section and third section of teeth perpendicular line segment distance end point 221.

There is a connection of the last line segment defining the second section of teeth 242 to the second straight line segment 238 at the connection of the second section and third section of teeth perpendicular line segment distance end point 221.

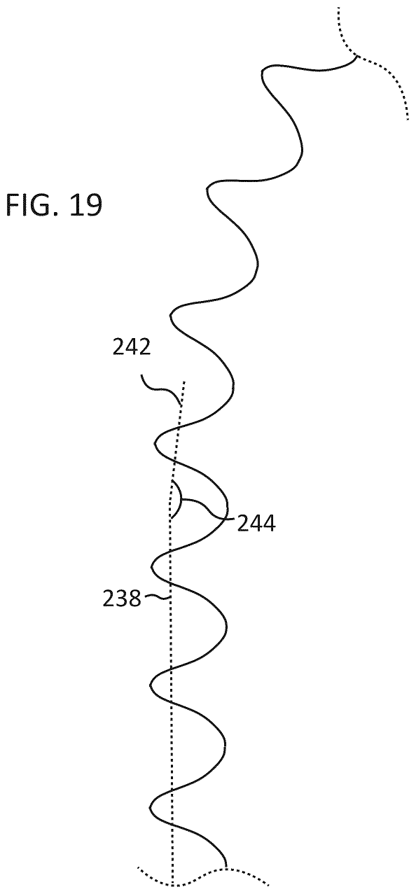

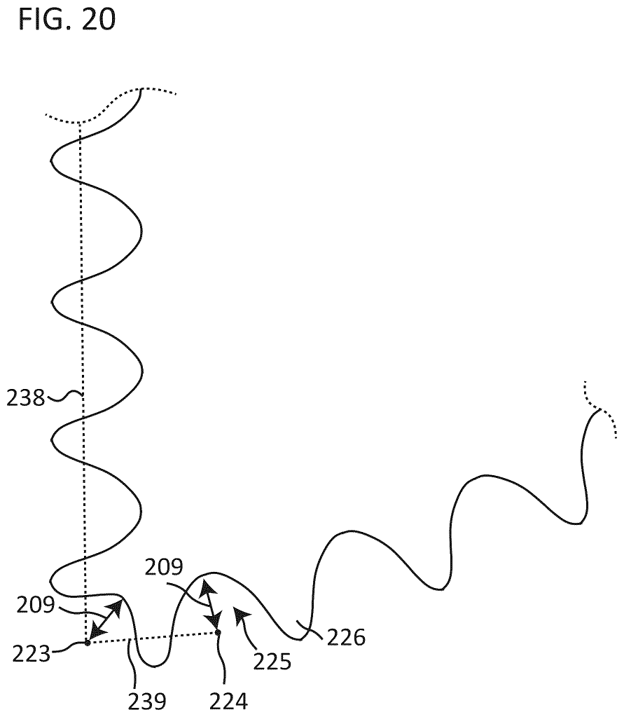

There is an angle at the connection of the last line segment defining the second section of teeth to the second straight line segment 244. The angle at the connection of the last line segment defining the second section of teeth to the second straight line segment 244 is between 163 and 171 degrees, as is FIG. 19, where the embodiment is at 167 degrees as in the figure.

There is a last line segment defining the fourth section of teeth 245. The last line segment defining the fourth section of teeth has a first end and a second end. The first end of the last line segment defining the fourth section of teeth is the last valley of the fourth section of teeth perpendicular line segment end point 227. The second end of the last line segment defining the fourth section of teeth is the connection of the fourth section and first section of teeth perpendicular line segment distance end point 232.

There is a connection of the last line segment defining the fourth section of teeth 245 to the first straight line segment 234 at the connection of the fourth section and first section of teeth perpendicular line segment distance end point 232.

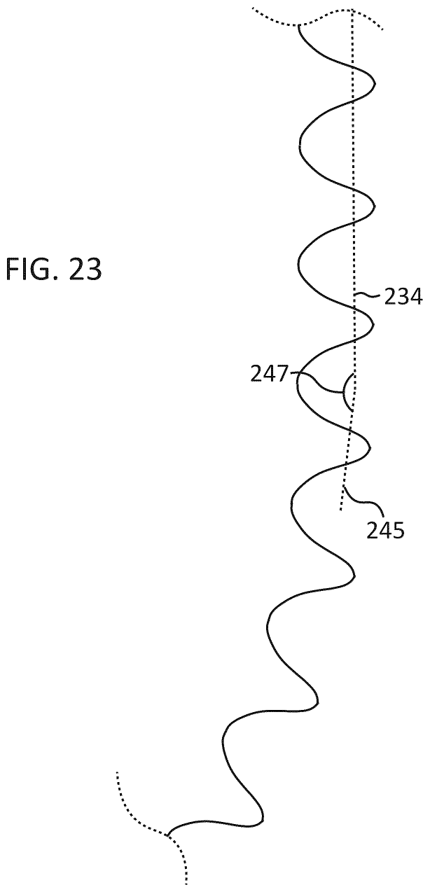

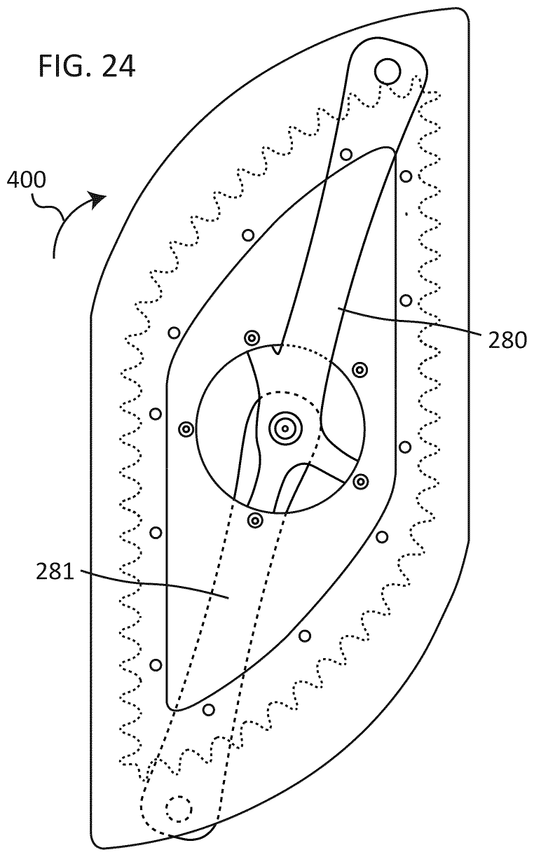

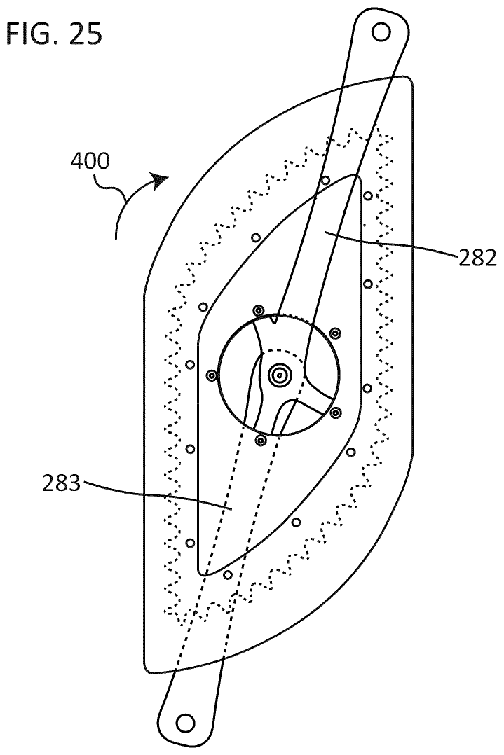

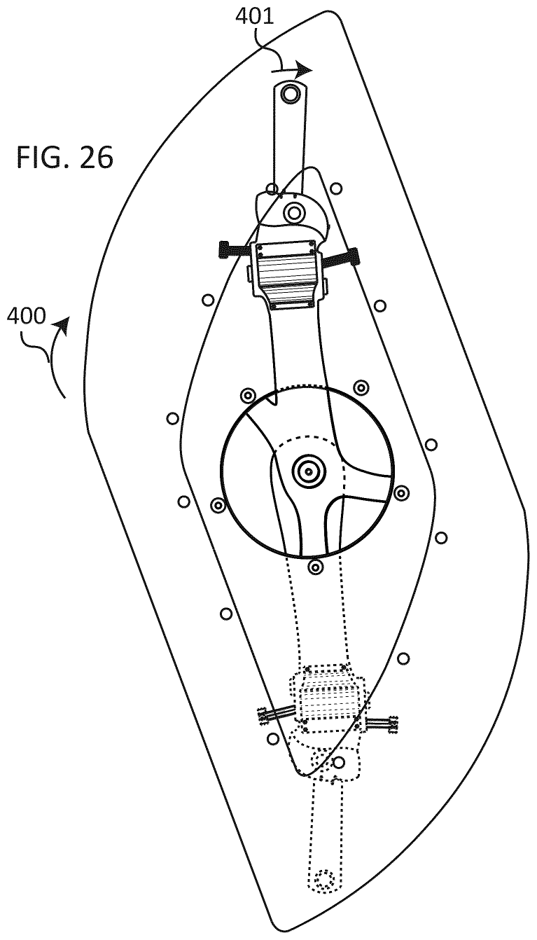

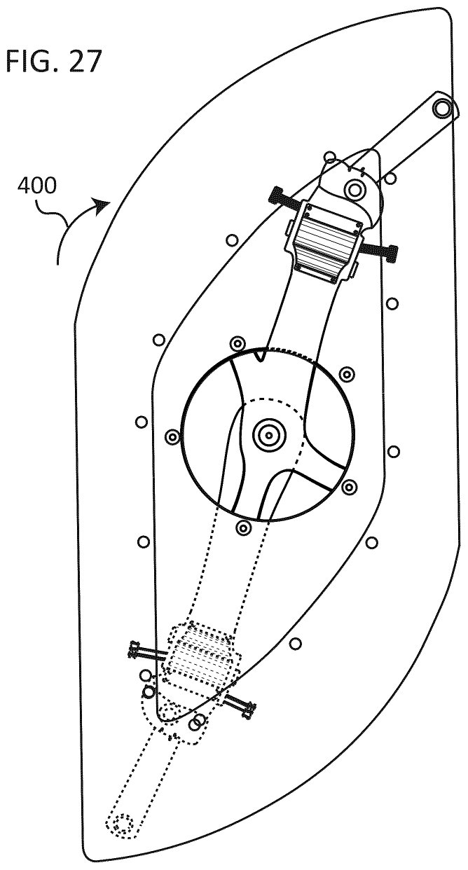

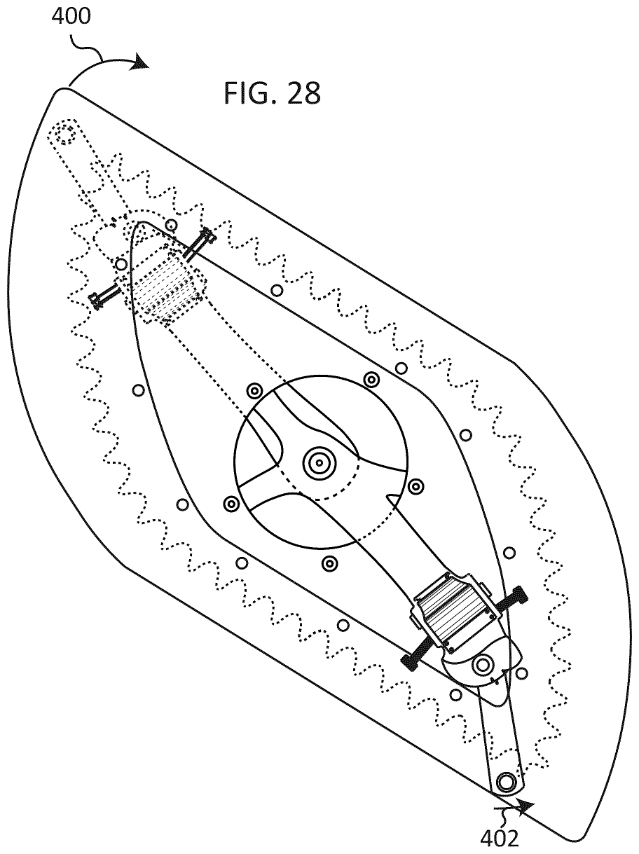

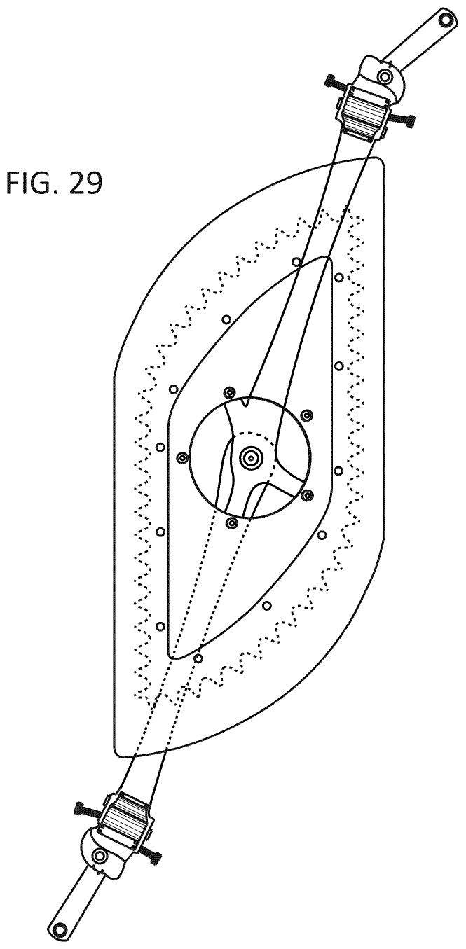

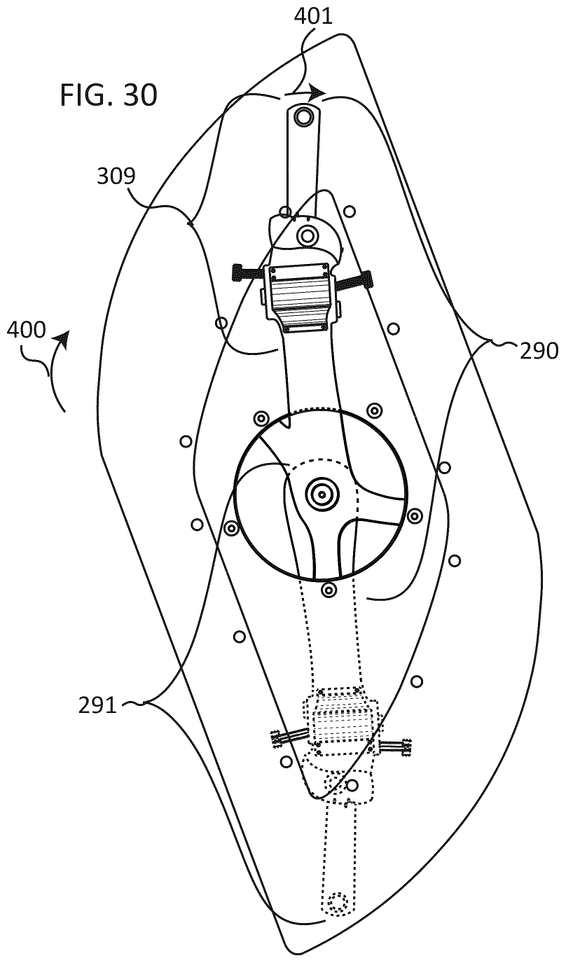

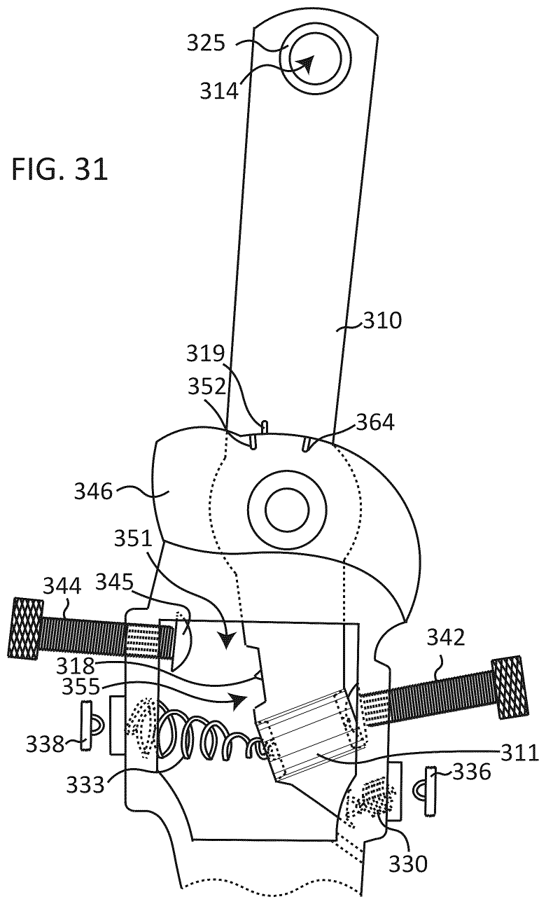

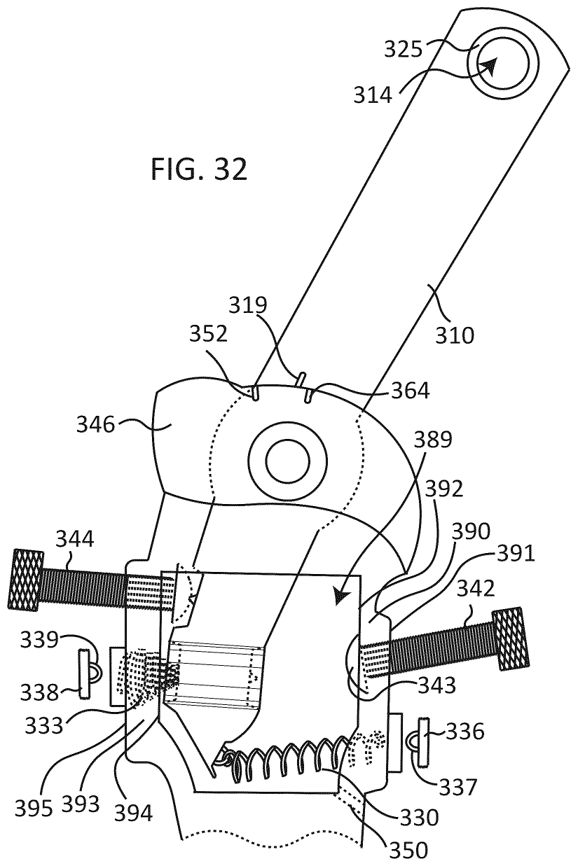

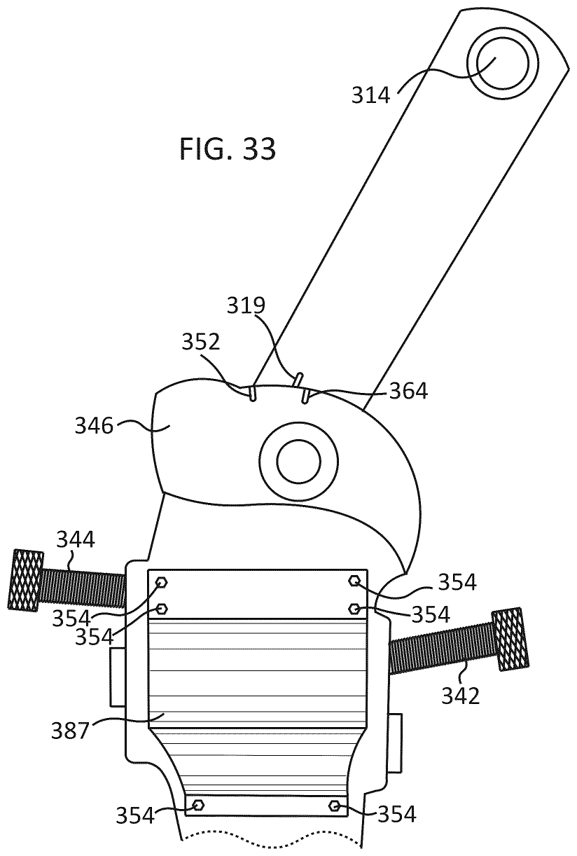

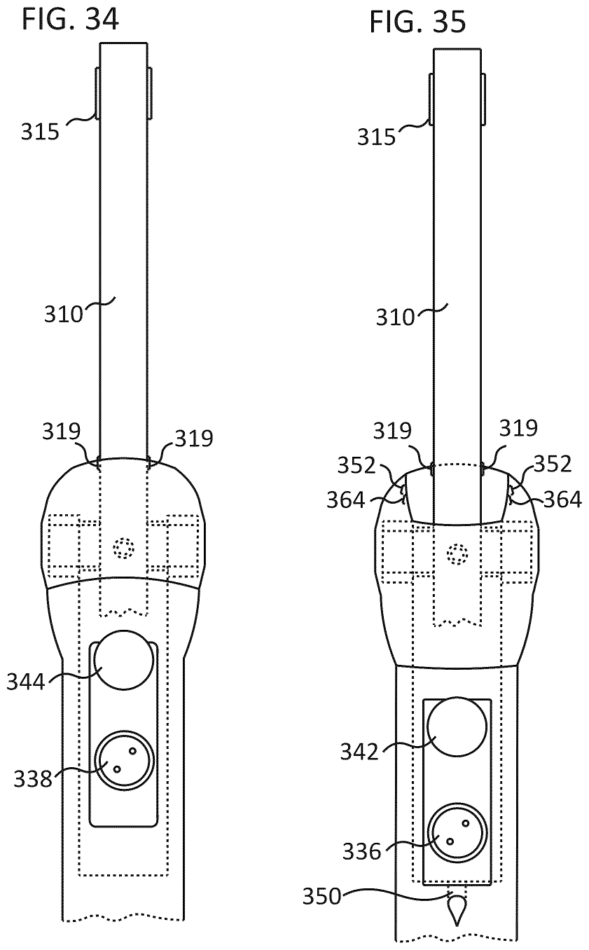

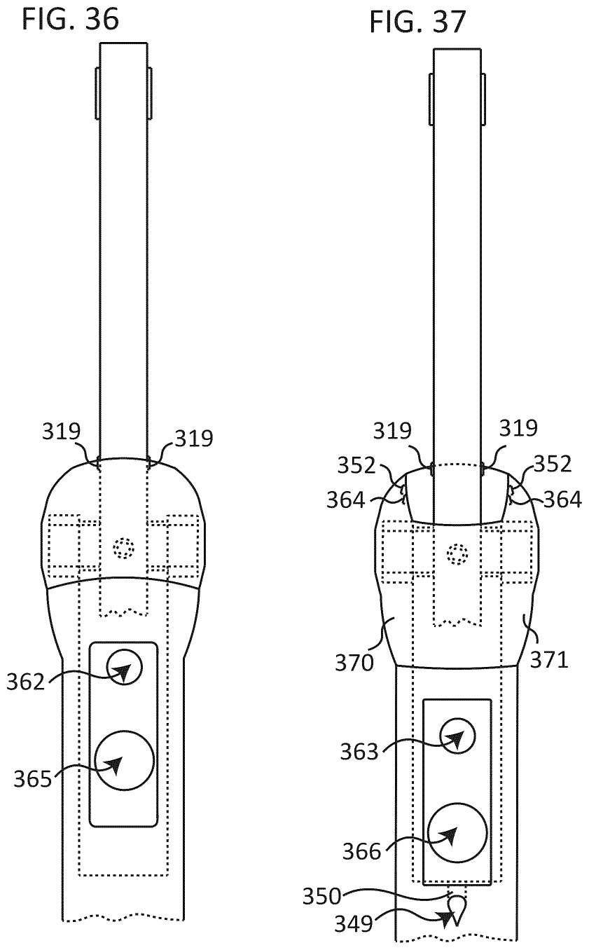

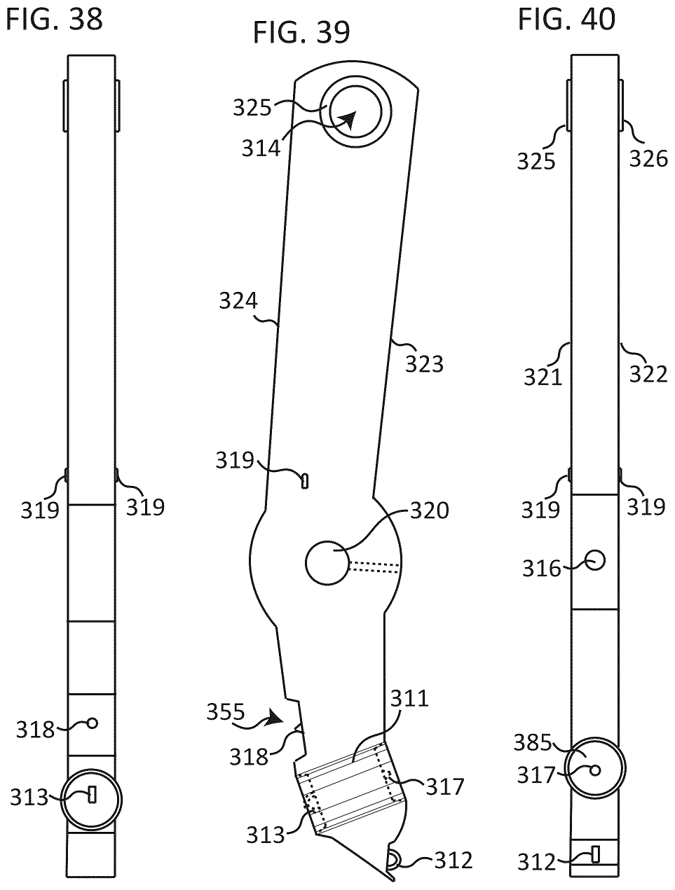

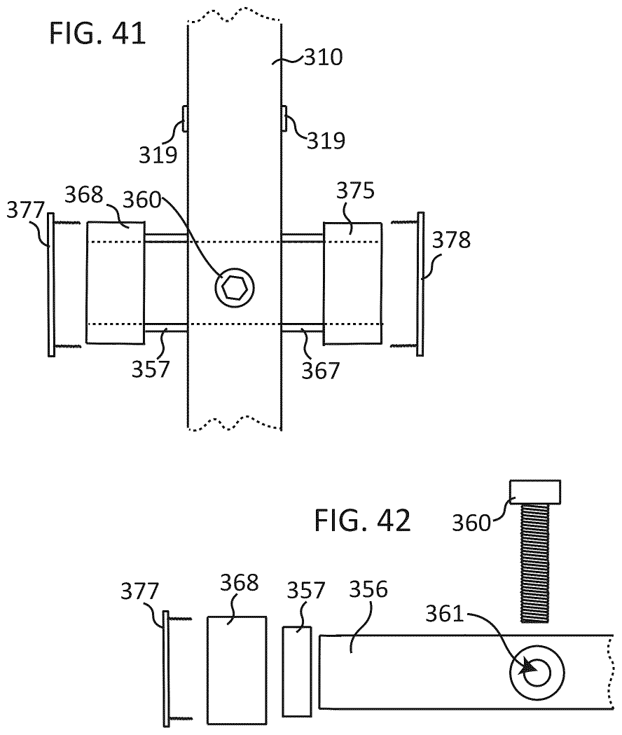

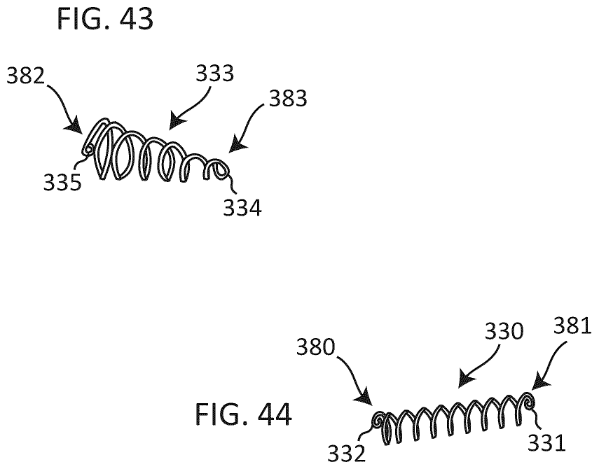

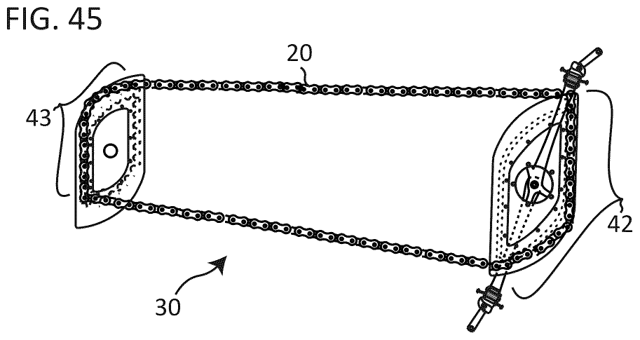

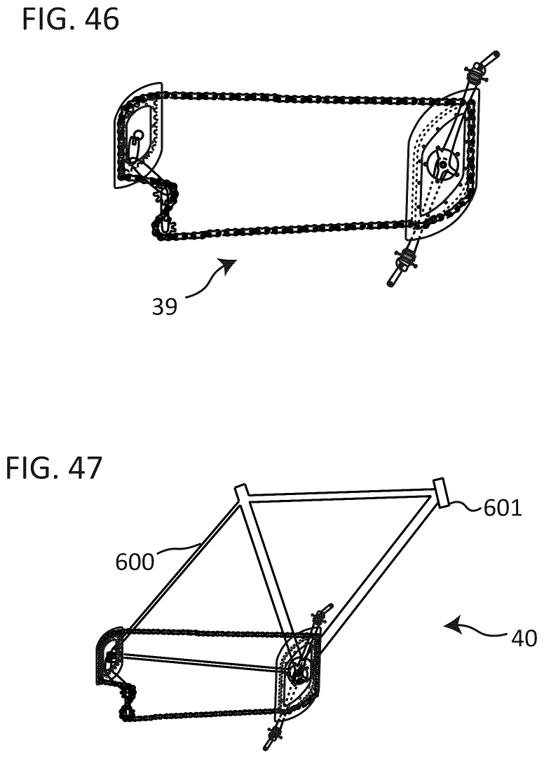

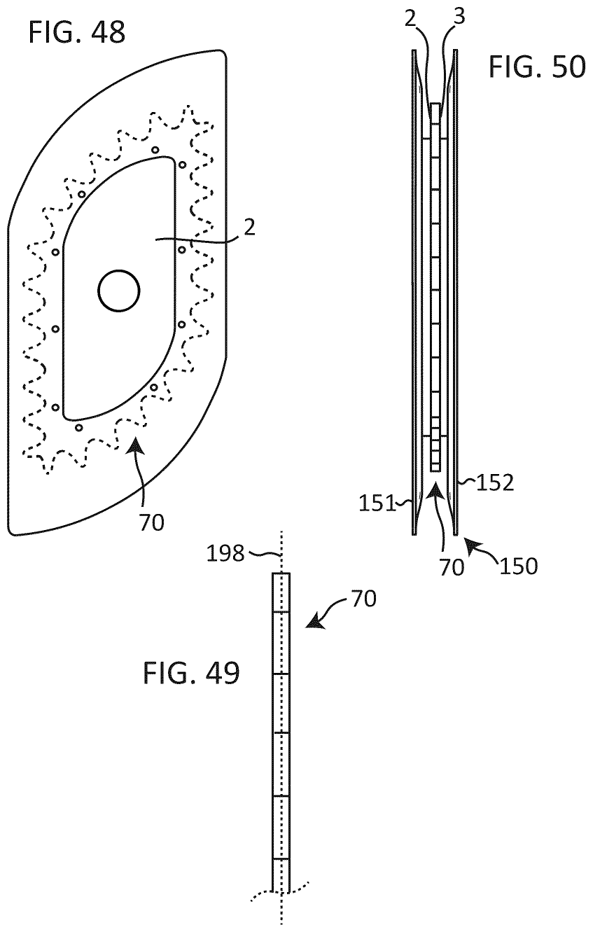

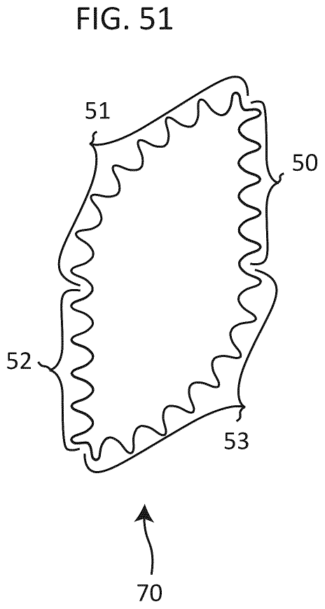

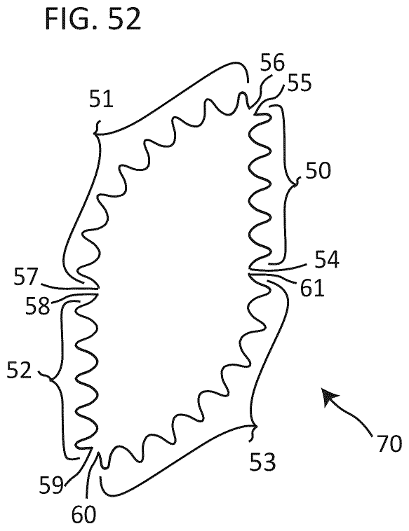

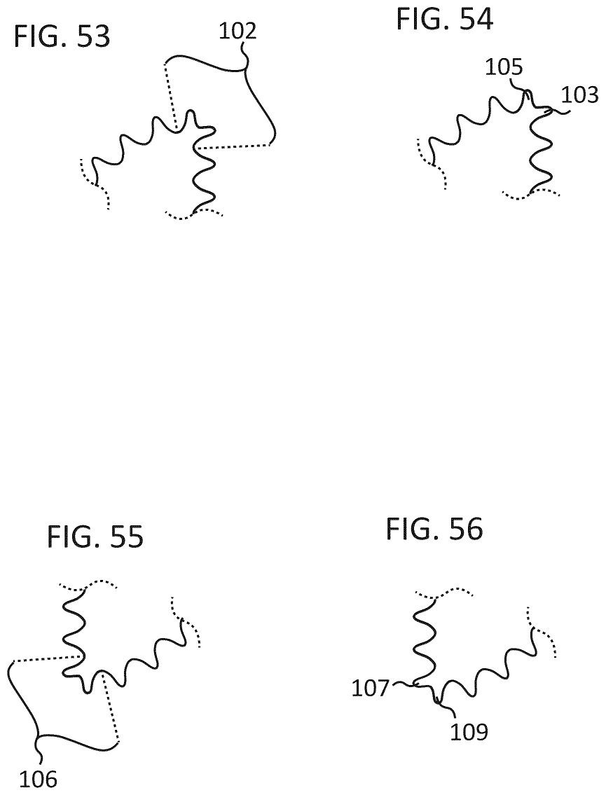

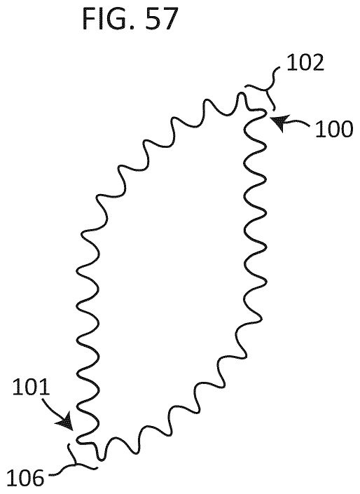

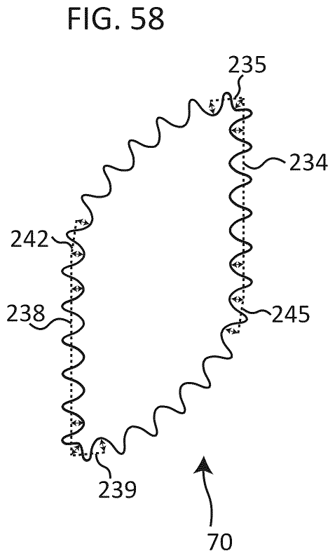

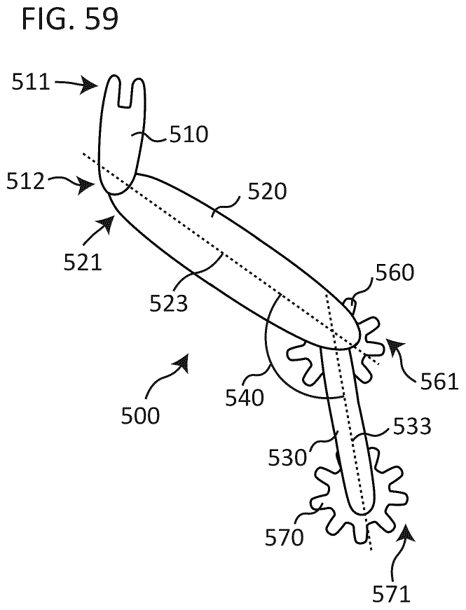

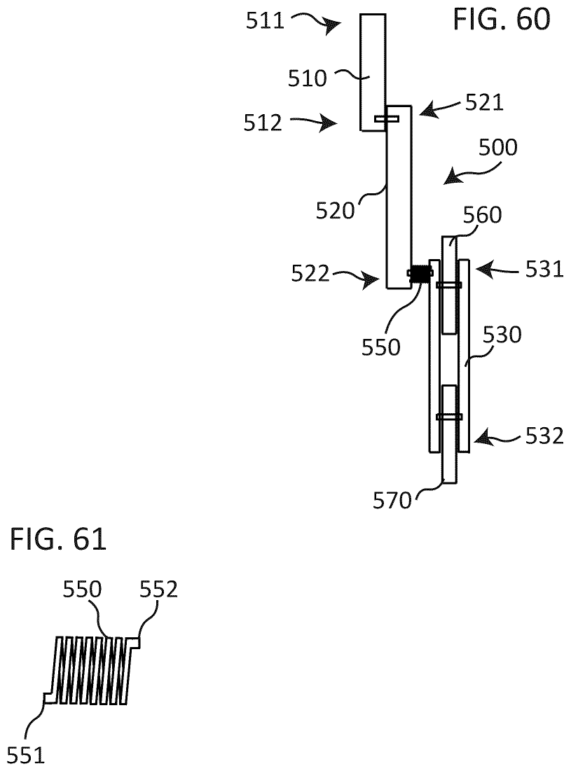

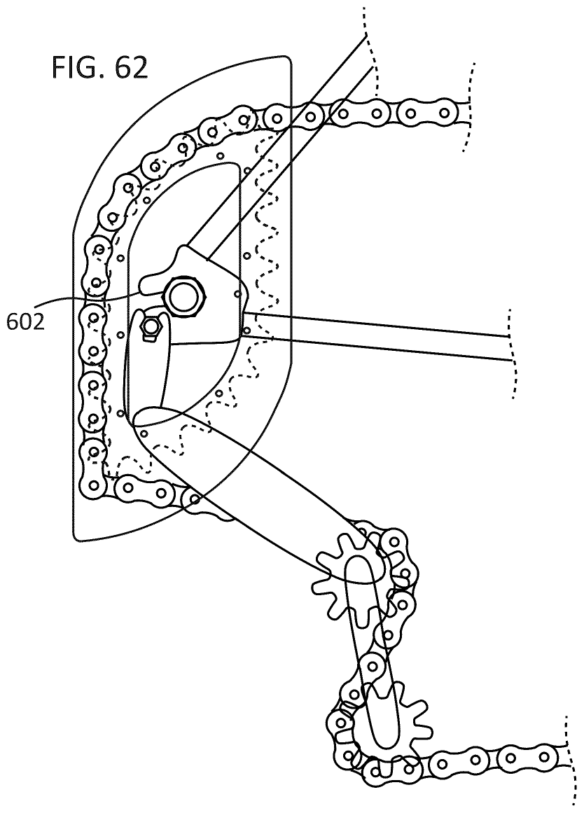

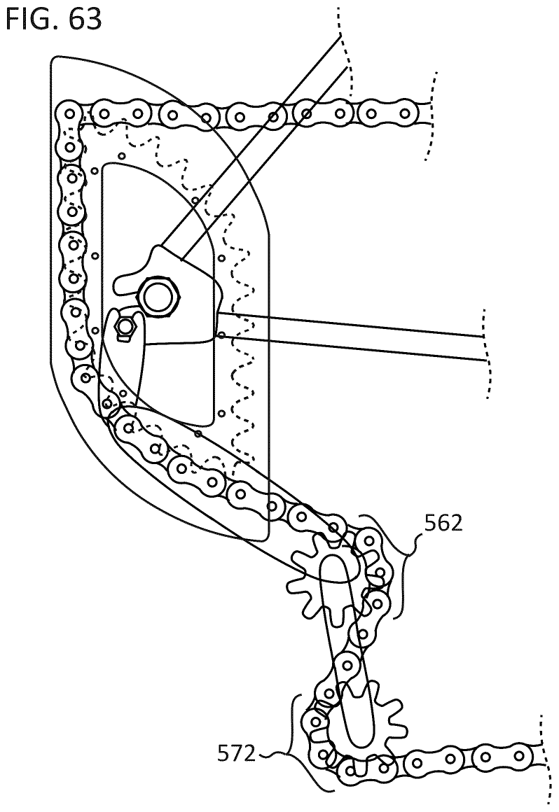

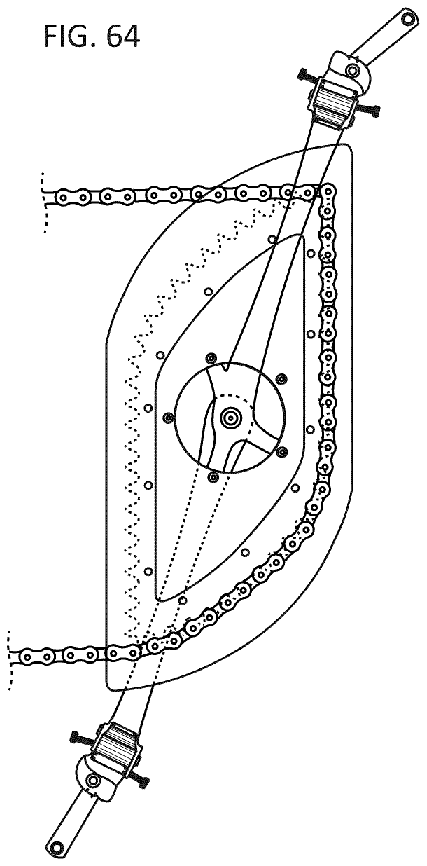

There is an angle at the connection of the last line segment defining the fourth section of teeth to the first straight line segment 247. The angle at the connection of the last segment defining the fourth section of teeth to the first straight line segment 247 is between 163 and 171 degrees, as in FIG. 23, where the embodiment is at 167 degrees as in the figure.

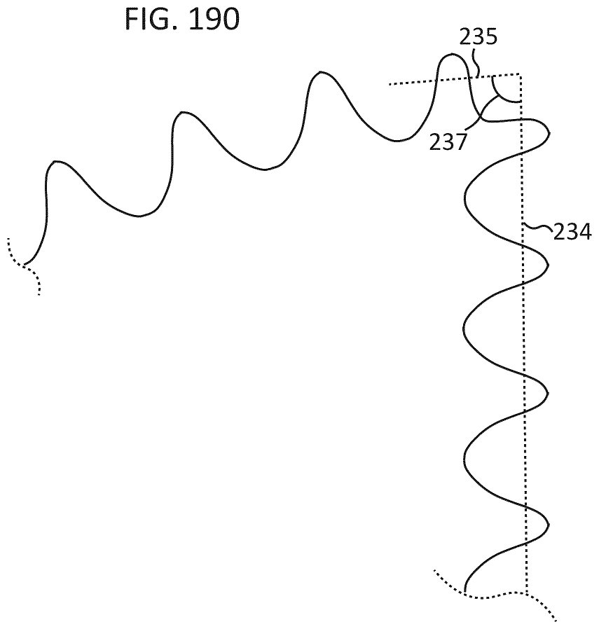

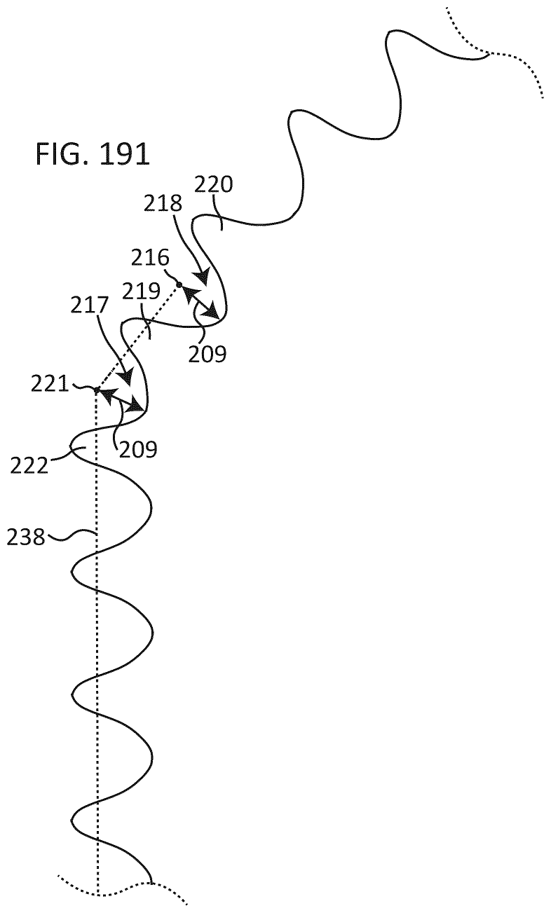

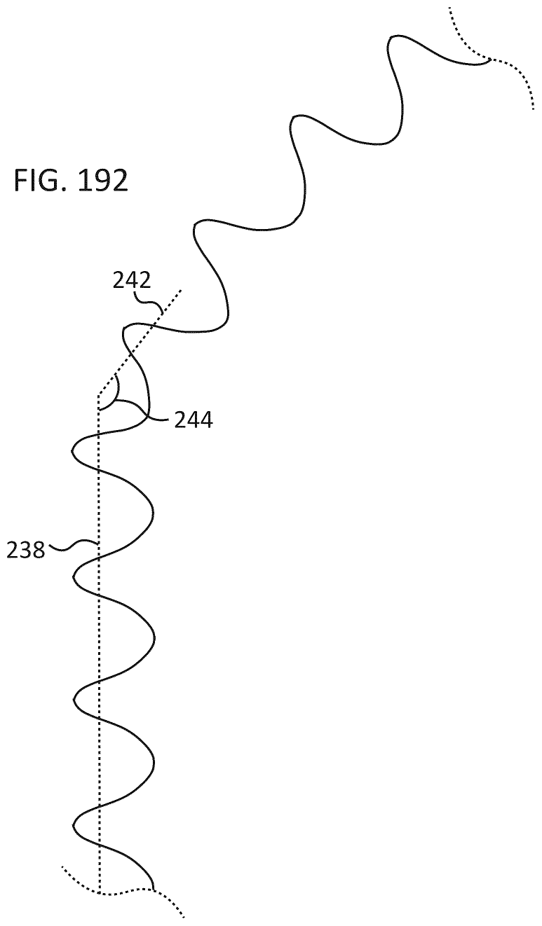

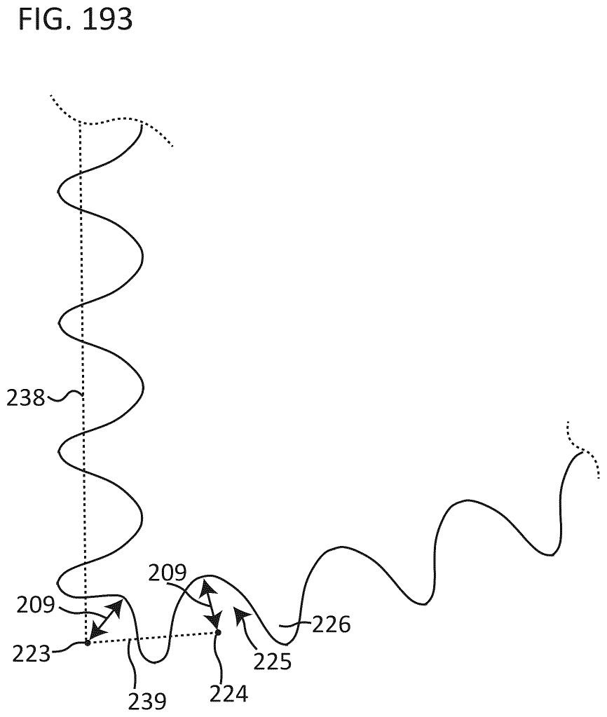

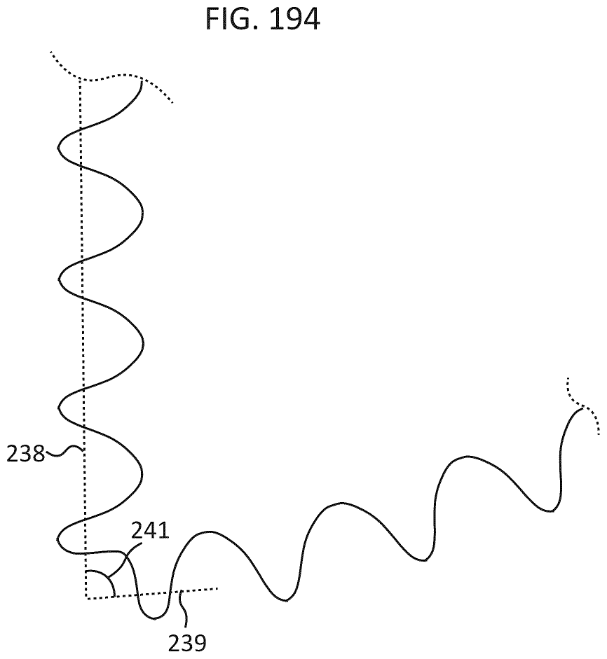

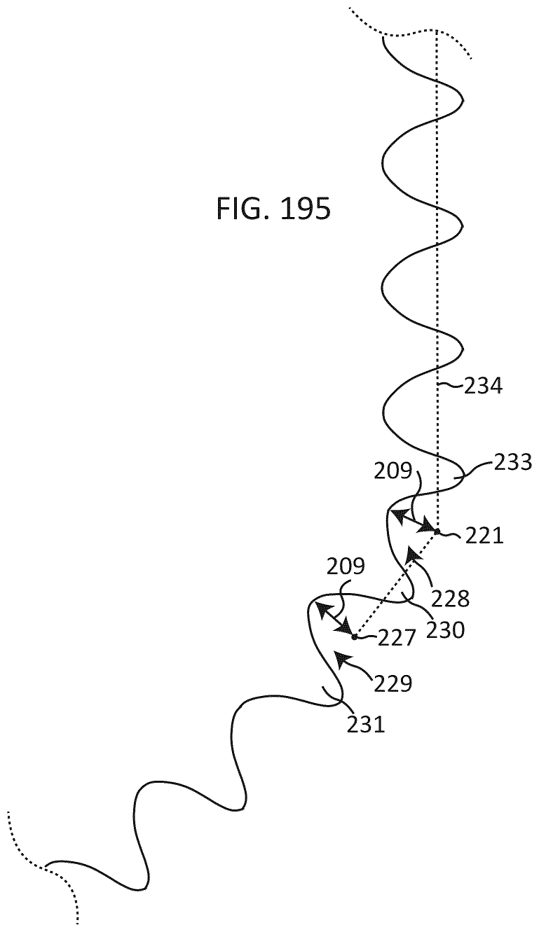

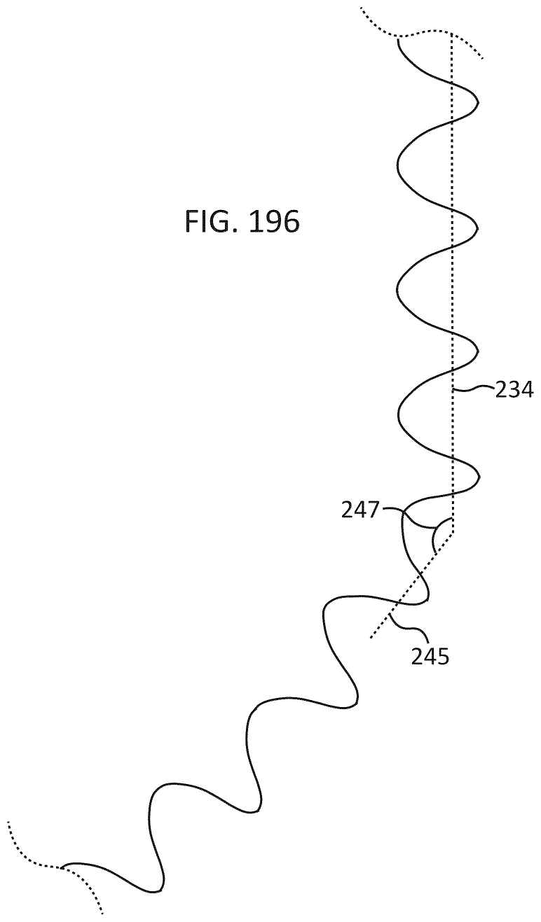

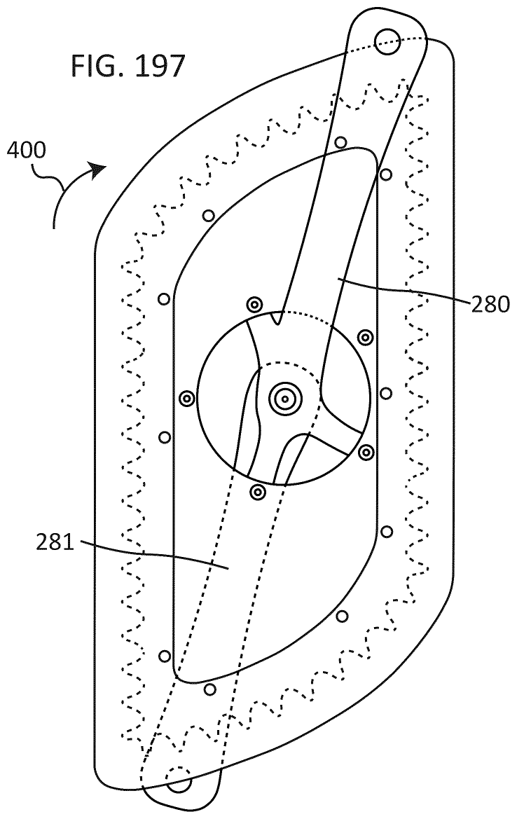

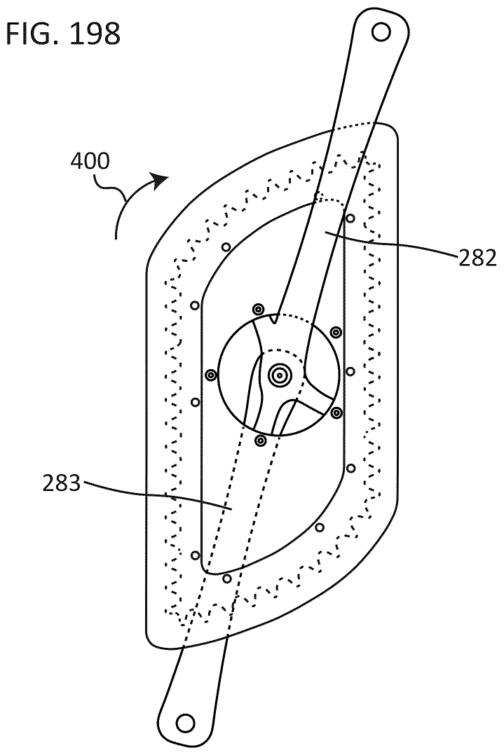

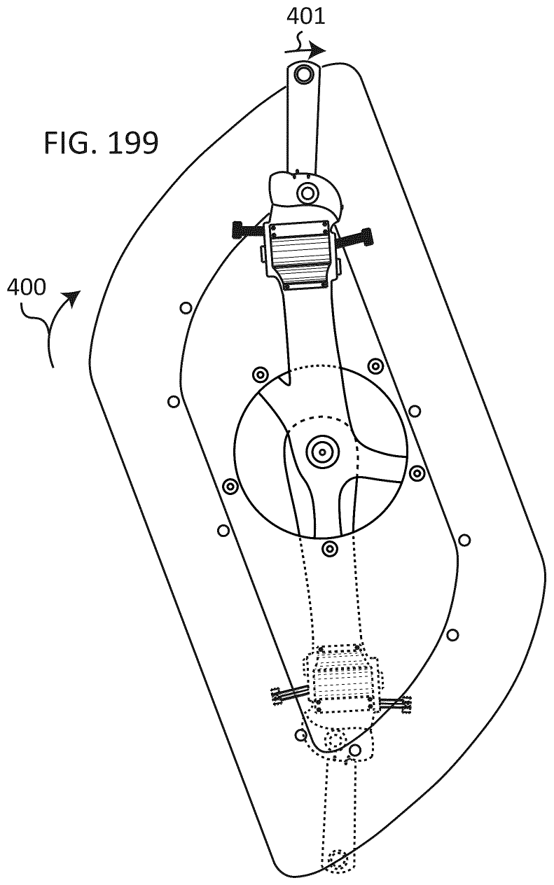

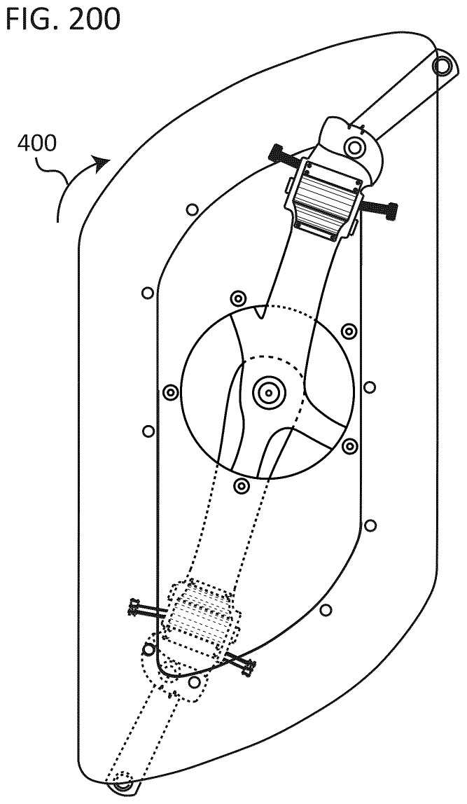

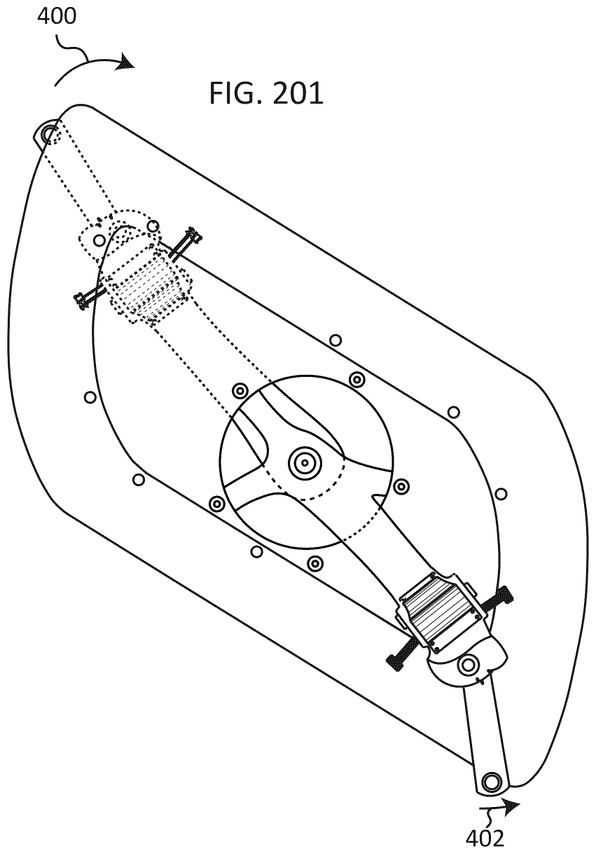

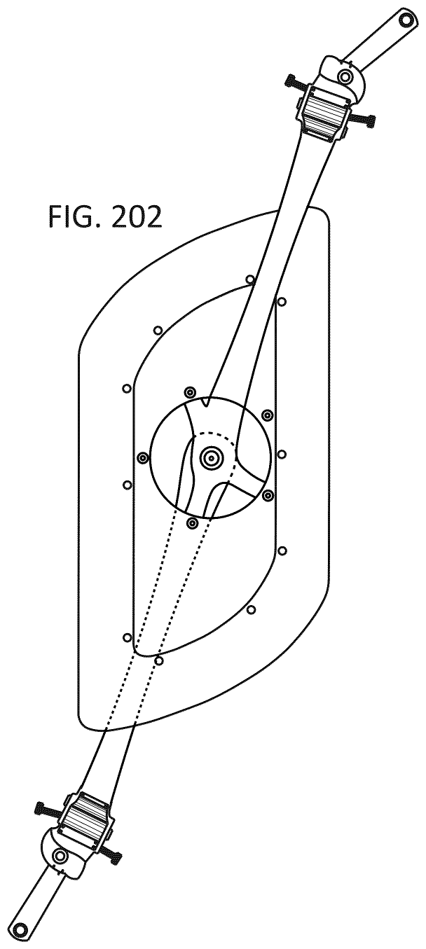

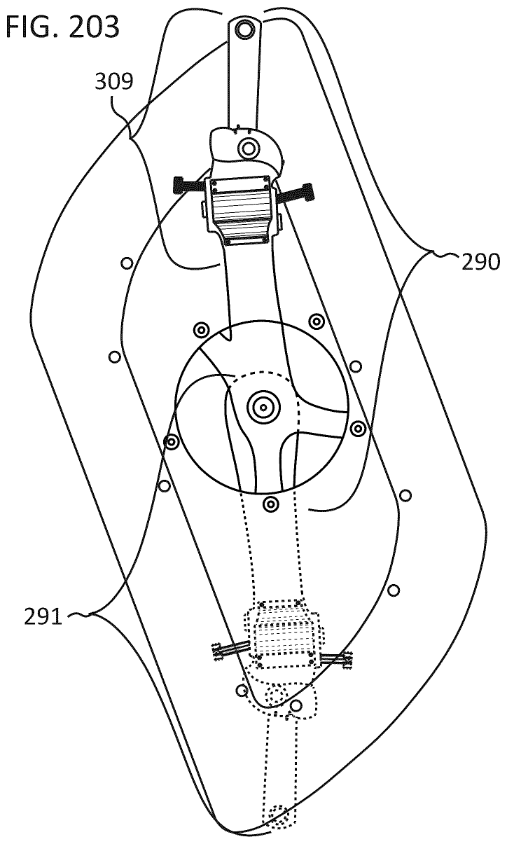

The angles can vary as in a secondary and less effect embodiment of as in FIGS. 190, 192, 194, and 196. The angle at the connection of the first straight line segment to the first line segment defining the second section of teeth 237 (FIG. 190), and angle at the connection of the second straight line segment to the first line segment defining the fourth section of teeth 241 (FIG. 194), which is 82 to 90, where the embodiment is at 86 degrees in the figures. The angle at the connection of the last line segment defining the second section of teeth to the second straight line segment 244 (FIG. 192), and the angle at the connection of the last line segment defining the fourth section of teeth to the first straight line segment 247 (FIG. 196), which is 138 to 146 degrees, where the embodiment is at 142 degrees as in the figures.

An embodiment of the first sprocket 1 and second sprocket 70 can have a derailment guard 150. An embodiment of the derailment guard 150 goes around the entire sprocket outer edge 6. The derailment guard 150 prevents a chain engaged with the sprocket from coming off the sprocket. The derailment guard 150 can be made of a derailment guard first flange 151 which is attached to the sprocket front face 2. The derailment guard 150 can be made of a derailment guard second flange 152 which is attached to the sprocket rear face 3. Each flange can be attached to the sprocket 1 with rivets.

An embodiment of the first sprocket 1 can be combined with a crank arm structure, which can be called a slap crank arm. A first slap crank arm 290 and second slap crank arm 291 are used to turn the first sprocket 1. The first slap crank arm 290 is connected to the sprocket 1 and the second slap crank arm 291 is attached to the first slap crank arm 290. The connection between the first slap crank arm 290 and second slap crank arm 291 can with the spindle 700. Where the ends of the spindle 700 has interlocking elements or teeth with the slap crank arms. Each of the first slap crank arm 290 and second slap crank arm 291 has a slap crank arm end structure 309 connected at the end of the first slap crank arm 290 and second slap crank arm 291 (the slap crank arm end structure 309 can be considered part of the first slap crank arm 290 and second slap crank arm 291).

The slap crank arm end structure 309 has multiple components. The slap crank arm housing structure 346 forms the main structure of the slap crank arm end structure 309. An embodiment of the slap crank arm housing structure 346 has a slap crank arm housing structure left wall 370 and slap crank arm housing structure right wall 371, which forms part of the slap crank arm housing structure hollow cavity 351. Within the slap crank arm housing structure hollow cavity 351 is the lower part of the slap crank arm lever 310. The upper part of the slap crank arm lever 310 extends out of the slap crank arm housing 346.

The slap crank arm lever 310 is attached to a slap crank arm pivot bar 340. The first end of the slap crank arm pivot bar 356 attaches to the slap crank arm housing structure left wall 370, the second end of the slap crank arm pivot bar 356 attaches to the slap crank arm housing structure right wall 371. The attachment of the slap crank arm pivot bar 356 to the walls of the slap crank arm housing structure 346 can be loose which allows for rotation of the slap crank arm pivot bar 356.

The movement of the slap crank arm lever 310 is controlled by a set of two springs, the slap crank arm rear spring 333 and the slap crank arm front spring 330. The slap crank arm rear spring 333 has a slap crank arm rear spring first end 382 and a slap crank arm rear spring second end 383. The slap crank arm rear spring first end 382 is attached to the slap crank arm housing structure 346. The slap crank arm rear spring second end 383 is attached to the slap crank arm lever 310. The slap crank arm front spring 330 has a slap crank arm front spring first end 380 and a slap crank arm front spring second end 381. The slap crank arm front spring first end 380 is attached to the slap crank arm lever 310. The slap crank arm front spring second end 381 is attached to the slap crank arm housing structure 346.

The slap crank arm lever 310 has a slap crank arm lever pedal hole 314 through the upper part of the slap crank arm lever 310 which extends out of the slap crank arm housing 346. The slap crank arm lever pedal hole 314 is used to attach a pedal to the slap crank arm.

An embodiment of the slap crank arm end structure 309 can contain a slap crank arm rear set screw 344 and a slap crank arm front set screw 342, which controls the range of motion of the slap crank arm lever 310.

There is a slap crank arm rear set screw hole 362. The slap crank arm rear set screw hole 362 has a first and second opening. The first opening of the slap crank arm rear set screw hole is on the slap crank arm housing structure rear wall rear face 395. The second opening of the slap crank arm rear set screw hole is on the slap crank arm housing structure rear wall front face 394. The slap crank arm rear set screw 344 travels through the slap crank arm rear set screw hole 362. The slap crank arm rear set screw 344 is configured to stop the slap crank arm lever 310 when the slap crank arm lever moves towards the slap crank arm housing structure rear wall 393.

There is a slap crank arm front set screw hole 363. The slap crank arm front set screw hole 363 has a first and second opening, where the first opening of the slap crank arm front set screw hole is on slap crank arm housing structure front wall rear face 392 and the second opening of the slap crank arm front set screw hole is on the slap crank arm housing structure front wall front face 391. The slap crank arm front set screw 342 travels through the slap crank arm front set screw hole 363. The slap crank arm front set screw 342 is configured to stop the slap crank arm lever 310 when the slap crank arm lever 310 moves towards the slap crank arm housing structure front wall 390.

Each of the slap crank arm rear set screw 344 and slap crank arm front set screw 342 can be screwed in or out to change the amount the slap crank arm lever 310 can move towards the rear or front wall of the slap crank arm housing structure.

An embodiment of the slap crank arm lever 310 can have slap crank arm lever hammer 311. The slap crank arm lever hammer 311 is located on the lower part of the slap crank arm lever 310. The slap crank arm lever hammer 311 is a widened portion of the slap crank arm lever 310 which will impact the slap crank arm front set screw 342. There is the slap crank arm lever hammer front face 385, which can be considered a portion of the slap crank arm lever front face 323.

An embodiment of the slap crank arm housing structure 346 can have a rear slap crank arm housing slap crank arm lever position indicator 352 and front slap crank arm housing slap crank arm lever position indicator 364. Both the rear slap crank arm housing slap crank arm lever position indicator 352 and front slap crank arm housing slap crank arm lever position indicator 364 are on the top part of the each of the left and right wall of the slap crank arm housing structure 346. The rear slap crank arm housing slap crank arm lever position indicator 352 shows how far back the slap crank arm lever 310 will move towards the rear wall of the slap crank arm housing structure. The front slap crank arm housing slap crank arm lever position indicator 364 shows how far forward the slap crank arm lever 310 will move toward the front wall of the slap crank arm housing structure. Additionally, an embodiment of the slap crank arm lever 310 can have a slap crank arm lever position indicator 319 on the left and right face of the slap crank arm lever 310. To determine the range of motion of the slap crank arm lever 310, each slap crank arm lever position indicator 319 can be compared with the rear slap crank arm housing slap crank arm lever position indicator 352 and front slap crank arm housing slap crank arm lever position indicator 364.

An embodiment of the slap crank arm end structure 309 can have a slap crank arm housing weep hole 350. The slap crank arm housing weep hole 350 allows fluid to exit the slap crank arm housing structure hollow cavity 351. The slap crank arm housing weep hole 350 has internal and external opening. The internal opening of the slap crank arm housing weep hole opens into the slap crank arm housing structure hollow cavity 351. The external opening of the slap crank arm housing weep hole is on the front face of slap crank arm end structure.

An embodiment of the slap crank arm end structure 309 can have the slap crank arm rear spring 333 in a conical shape. The wide end of the conical shape is closer to the slap crank arm rear spring first end 382 near the rear wall of the slap crank arm housing structure and the narrow end of the conical shape is closer to the slap crank arm rear spring second end 383 near the slap crank arm lever 310. Also, an embodiment of the slap crank arm end structure 309 can have the slap crank arm front spring 330 in a cylindrical shape. The slap crank arm front spring first end 380 is attached to the slap crank arm lever 310 and the slap crank arm front spring second end 381 is attached to the slap crank arm housing structure front wall 390.

The movement of the slap crank arm lever 310 can also be controlled by a spear and bumper arrangement, which can make the slap crank arm lever 310 impact with the set screws less violently and cause less slipping.

In an embodiment, the slap crank arm lever 310 can have a slap crank arm rear impact cut out 355, which is a section of the slap crank arm lever 310 which is not flush with the rest of the rear face of the slap crank arm lever. Within the slap crank arm rear impact cut out 355 there can be a slap crank arm rear impact spear 318. The slap crank arm rear impact spear 318 is a small pointed element which protrudes from the slap crank arm lever rear face 324. An embodiment of an end of slap crank arm rear set screw 344, within the slap crank arm housing structure 346, can have extra padding, a rubber, or soft composition, and form a slap crank arm rear set screw bumper 345. The slap crank arm rear impact spear 318 is configured to hit the slap crank arm rear set screw bumper 345.

In an embodiment, the slap crank arm lever 310 can have a slap crank arm front impact spear 317. The slap crank arm front impact spear 317 is a small pointed element which protrudes from the slap crank arm lever front face 323. An embodiment of an end of slap crank arm front set screw 342, within the slap crank arm housing structure 346, can have extra padding, a rubber, or soft composition, and form a slap crank arm front set screw bumper 343. The slap crank arm front impact spear 317 is configured to hit the slap crank arm front set screw bumper 343.

An embodiment of the slap crank arm end structure 309 has loops to secure the slap crank arm rear spring 333 and slap crank arm front spring 330. There is a slap crank arm lever rear spring securing loop 313, which is a semi-circle or horseshoe shaped loop attached at both ends to the rear face of the slap crank arm lever. There is a slap crank arm lever front spring securing loop 312 which is a semi-circle or horseshoe shaped loop attached at both ends to the front face of the slap crank arm lever. There is a rear closure cap 338 which is oriented inside a rear closure cap hole 365. The rear closure cap hole 365 has a first opening and a second opening. The first opening of the rear closure cap hole 365 is in the rear face of the rear wall of the slap crank arm housing structure and the second opening of the rear closure cap hole 365 is in the front face of the rear wall of the slap crank arm housing structure. There is a rear closure cap securing loop 339, which is a semi-circle or horseshoe shaped loop attached at both ends to the rear closure cap 338. The rear closure cap 338 is oriented in the rear closure cap hole 365 with the rear closure cap securing loop 339 inside the hollow cavity of the slap crank arm housing structure. There is a front closure cap 336 which is oriented inside a front closure cap hole 366. The front closure cap hole 366 has a first opening and a second opening. The first opening of the front closure cap hole 366 is in the rear face of the front wall of the slap crank arm housing structure and the second opening of the front closure cap hole 366 is in the front face of the front wall of the slap crank arm housing structure. There is a front closure cap securing loop 337, which is a semi-circle or horseshoe shaped loop attached at both ends to the front closure cap 336. The front closure cap 336 is oriented in the front closure cap hole 366 with the front closure cap securing loop 337 inside the hollow cavity of the slap crank arm housing structure. The springs in the slap crank arm end structure 309 have loops at their ends to attach to the loops on the closure caps and slap crank arm lever 310. There can be a slap crank arm rear spring rear securing loop 335, where the slap crank arm rear spring rear securing loop 335 forms the slap crank arm rear spring first end 382. There can be a slap crank arm rear spring front securing loop 334 where the slap crank arm rear spring front securing loop 334 forms the slap crank arm rear spring second end 383. There can be a slap crank arm front spring rear securing loop 332, where the slap crank arm front spring rear securing loop 332 forms the slap crank arm front spring first end 380. There can be a slap crank arm front spring front securing loop 331 where the slap crank arm front spring front securing loop 331 forms the slap crank arm front spring second end 381. The slap crank arm rear spring rear securing loop 335 is attached to the rear closure cap securing loop 339. The slap crank arm rear spring front securing loop 334 is attached to the slap crank arm lever rear spring securing loop 313. The slap crank arm front spring rear securing loop 332 is attached to the slap crank arm lever front spring securing loop 312. The slap crank arm front spring front securing loop 331 is attached to the front closure cap securing loop 337. The rear closure cap 338 and front closure cap 336 can be considered part the slap crank arm housing structure 346, when describing the attachment of the slap crank arm rear spring 333 and slap crank arm front spring 330.

In an embodiment of the slap crank arm lever 310, the slap crank arm lever pedal hole 314 can have a slap crank arm lever pedal hole raised reinforcement first ring 325 and slap crank arm lever pedal hole raised reinforcement second ring 326 around the slap crank arm lever pedal hole 314. The slap crank arm lever pedal hole raised reinforcement first ring 325 are slap crank arm lever pedal hole raised reinforcement second ring 326 raised portions of the slap crank arm lever 310 around two openings of the slap crank arm lever pedal hole 314 on both the left and right face of the slap crank arm lever 310. The slap crank arm lever pedal hole raised reinforcement first ring 325 is on the slap crank arm lever left face 321. The slap crank arm lever pedal hole raised reinforcement second ring 326 is on the slap crank arm lever right face 322.

In an embodiment slap crank arm lever 310 is attached to the slap crank arm pivot bar 340 where there is a slap crank arm pivot bar hole 320 which the slap crank arm pivot bar 340 is oriented through. The slap crank arm pivot bar hole 320 has a first and second opening. The first opening of the slap crank arm pivot bar hole is on the slap crank arm lever left face 321. The second opening of the slap crank arm pivot bar hole is on the slap crank arm lever right face 322. There is a slap crank arm lever pivot bar securing screw hole 316. The slap crank arm lever pivot bar securing screw hole 316 has a first opening and a second opening. The first opening of the slap crank arm lever pivot bar securing screw hole is inside the slap crank arm pivot bar hole 320. The second opening of the slap crank arm lever pivot bar securing screw hole is on the slap crank arm lever front face 323. There is a slap crank arm pivot bar in bar securing screw hole 361. The slap crank arm pivot bar in bar securing screw hole has an opening. The opening of the slap crank arm pivot bar in bar securing screw hole is on the outer surface of the slap crank arm pivot bar. There is a slap crank arm pivot bar securing screw 360. The slap crank arm pivot bar securing screw 360 is oriented in the slap crank arm lever pivot bar securing screw hole 316 and into the slap crank arm pivot bar in bar securing screw hole 361.

In an embodiment, there are a slap crank arm pivot bar left bushing 357 and a slap crank arm pivot bar right bushing 367. The slap crank arm pivot bar 356 is oriented through both of the left and right slap crank arm pivot bar bushings. The slap crank arm pivot bar left bushing 357 is oriented between the left wall of the slap crank arm housing structure and the left face of the slap crank arm lever. The slap crank arm pivot bar right bushing 367 is oriented between the right wall of the slap crank arm housing structure and the right face of the slap crank arm lever.

In an embodiment, there are a a slap crank arm pivot bar left bearing 368 and a slap crank arm pivot bar right bearing 375. The slap crank arm pivot bar 356 is oriented through both the left and right slap crank arm pivot bar bearings 358. The left slap crank arm pivot bar bearing is oriented inside the left wall of the slap crank arm housing structure. The right slap crank arm pivot bar bearing is oriented inside the right wall of the slap crank arm housing structure.

In an embodiment, there are a slap crank arm housing left cavity hole opening 388 and a slap crank arm housing right cavity hole opening 389. The slap crank arm housing left cavity hole opening 388 is oriented in the left wall of the slap crank arm housing structure. The slap crank arm housing right cavity hole opening 389 is oriented on the right wall of the slap crank arm housing structure.

In an embodiment, there is a slap crank arm housing cavity hole left covering plate 386 and a slap crank arm housing cavity hole right covering plate 387. The slap crank arm housing cavity hole left covering plate 386 covers the slap crank arm housing left cavity hole opening 388. The slap crank arm housing cavity hole right covering plate 387 covers the slap crank arm housing right cavity hole opening 389. The left and right slap crank arm housing cavity hole covering plates are removably attached to the left and right wall of the slap crank arm housing structure with a plurality of slap crank arm housing cavity hole covering plate securing screws 354.

An embodiment of a rear derailleur structure 500 includes: an attachment bar 510; an extender bar 520; a tension sprocket bar 530; a rotation tension sprocket bar spring 550; a first tension sprocket 560; and a second tension sprocket 570.

The attachment bar 510 has an attachment bar first end 511 and attachment bar second end 512.

The extender bar 520 has an extender bar first end 521 and an extender bar second end 522.

The tension sprocket bar 530 has a tension sprocket bar first end 531 and tension sprocket bar second end 532.

The rotation tension sprocket bar spring 550 has a rotation tension sprocket bar spring first end 551 and a rotation tension sprocket bar spring second end 552.

The first tension sprocket 560 has a first tension sprocket outer edge 561.

The first tension sprocket 569 has a section of the outer edge of the first tension sprocket of contact of the drive chain and the first tension sprocket 562.

The second tension sprocket 570 has a second tension sprocket outer edge 571.

The second tension sprocket 570 has a section of the outer edge of the second tension sprocket of contact of the drive chain and the second tension sprocket 572.

The first end of the attachment bar 511 is attached to a bicycle frame 600. The attachment can occur with a slotted section of bicycle frame 600 and a slotted section of the first end of the attachment bar 511. Then a bolt can be oriented through the slotted sections and nut will cinch down to hold the first end of the attachment bar 511 to the bicycle frame 600.

The extender bar first end 521 is attached to the attachment bar second end 512.

The tension sprocket bar first end 531 is attached to the extender bar second end 522.

The angle of attachment between the extender bar and the tension sprocket bar 540 describes the extender bar 520 and the tension sprocket bar 530 orientation to each other.

The rotation tension sprocket bar spring first end 551 is attached to the extender bar second end 522 and rotation tension sprocket bar spring second end 552 is attached to the tension sprocket bar first end 531. The angle of attachment between the extender bar and the tension sprocket bar 540 is changed by the rotation tension sprocket bar spring 550. There is a extender bar longitudinal axis 523 and a tension sprocket bar longitudinal axis 533. The angle of attachment between the extender bar and the tension sprocket bar 540 is defined by the angle of extender bar longitudinal axis 523 to the tension sprocket bar longitudinal axis 533.

For the attachment of the first end of the attachment bar 511, the extender bar first end 521, the extender bar second end 522, the rotation tension sprocket bar spring first end 551, the rotation tension sprocket bar spring second end 552, the tension sprocket bar first end 531, and the tension sprocket bar second end 532, to other corresponding parts the absolute end tip may not make the connection but the end portion of the component.

The first tension sprocket 560 is attached to the tension sprocket bar first end 531.

The second tension sprocket 570 is attached to the tension sprocket bar second end 532.

For an embodiment of drive structure with rear derailer and bicycle frame 40, the drive chain 20 travels from the outer edge of the first sprocket to the outer edge of the second sprocket then around a section of the outer edge of the second sprocket of contact of the drive chain and the second sprocket 43 then to the first tension sprocket 560 and around a section of the outer edge of the first tension sprocket of contact of the drive chain and the first tension sprocket 562 then to the second tension sprocket 570, the drive chain is oriented in between the first tension sprocket 560 and second tension sprocket 570, then around a section of the outer edge of the second tension sprocket of contact of the drive chain and the second tension sprocket 572, then back to the first sprocket 1 and then around a section of the outer edge of the first sprocket of contact of the drive chain and the first sprocket 42.

The first sprocket 1 and second sprocket 70 can be oriented in different positions when configured for use with a bicycle. Also the transition of the curved to straight sections of teeth which is not the first point or the second point can be described where, on each of the first and second sprocket, the connection of the second section of teeth to the third section of teeth is a gradual transition without a sharp point and the connection of the fourth section of teeth to the first section of teeth is a gradual transition without a sharp point.

The orientation of the first sprocket 1 and second 70 can be described relative to a bicycle frame 600, where the bicycle frame 600 has a bicycle frame front tip 601 and bicycle frame rear tip 602. The bicycle frame front tip 601 is the leading portion of the bicycle frame 600, when the bicycle is frame is configured to be ridden.

An embodiment, as in FIG. 47, where the first sprocket 1 is attached to the bicycle frame closer to the front tip of the bicycle frame than the second sprocket 70. The first sprocket 1 is oriented where the first sprocket is rotated for forward riding where the first section of teeth of the first sprocket is closer to the front tip of the bicycle frame, then the second section of teeth of the first sprocket is closer to the front tip of the bicycle frame, then the third section of teeth of the first sprocket is closer to the front tip of the bicycle frame, and then the fourth section of teeth of the first sprocket is closer to the front tip of the bicycle frame. And, the second sprocket 70 is oriented where the second sprocket 70 is rotated for forward riding where the first section of teeth of the second sprocket is closer to the front tip of the bicycle frame, then the second section of teeth of the second sprocket is closer to the front tip of the bicycle frame, then the third section of teeth of the second sprocket is closer to the front tip of the bicycle frame, and then the fourth section of teeth of the second sprocket is closer to the front tip of the bicycle frame.

In a different embodiment, as in FIG. 63 or 68, where the second sprocket 70 is oriented where the second sprocket 70 is rotated for forward riding where the third section of teeth of the second sprocket is closer to the front tip of the bicycle frame, then the second section of teeth of the second sprocket is closer to the front tip of the bicycle frame, then the first section of teeth of the second sprocket is closer to the front tip of the bicycle frame, and then the fourth section of teeth of the second sprocket is closer to the front tip of the bicycle frame.

In a different embodiment, as in FIG. 70, the first sprocket is oriented where the first sprocket is rotated for forward riding where the third section of teeth of the first sprocket is closer to the front tip of the bicycle frame, then the second section of teeth of the first sprocket is closer to the front tip of the bicycle frame, then the first section of teeth of the first sprocket is closer to the front tip of the bicycle frame, and then the fourth section of teeth of the first sprocket is closer to the front tip of the bicycle frame.

The first slap crank arm 290 and second slap crank arm 291 can be more securely attached to the first sprocket 1 with an embodiment of a bolt 730 and nut 740, along with other elements to compress the first slap crank arm 290 and second slap crank arm 291 together. There is a spindle 700. There is a spindle longitudinal axis 703. Along the spindle longitudinal axis 703 is a spindle hole 704. The spindle hole 704 has a spindle hole first opening 705 and spindle hole second opening 706. The spindle hole 704 has a spindle hole first opening 705 on the spindle first end 701 and spindle hole second opening 706 is on the spindle second end 702. There is a nut 740, first washer 710, lock washer 713, and second washer 716. The first washer 710 has a first washer front face 711 and first washer rear face 712. The lock washer 713 has a lock washer front face 714 and a lock washer rear face 715. The second washer 716 has a second washer front face 717 and a second washer rear face 718. There is a bolt 730. The bolt 730 has a bolt first end section 731 and bolt second end section 732. An embodiment of the bolt 730 has the bolt first end section 731 which is a threaded section and the bolt second end section 732 is a bolt head. The bolt first end section 731 is oriented through the nut 740. The bolt 730 is oriented through each of the first washer 710, second washer 716, lock washer 713, and spindle hole 704. The lock washer front face 714 is oriented in contact with the nut 740. The lock washer rear face 715 is oriented in contact with the first washer front face 711. The first washer rear face 712 is in contact with the first slap crank arm 290. The second washer front face 717 is in contact with the second slap crank arm 291. The second washer rear face 718 is in contact with the head of the bolt which is the bolt first end section 731.

The spindle can be oriented through a portion of the bicycle frame, or a bearing. When the spindle 700 is oriented through a portion of the bicycle frame 600, or a bearing, this can be considered connected to the bicycle frame 600.

The second sprocket 70 can have a derailment guard around the outer edge.

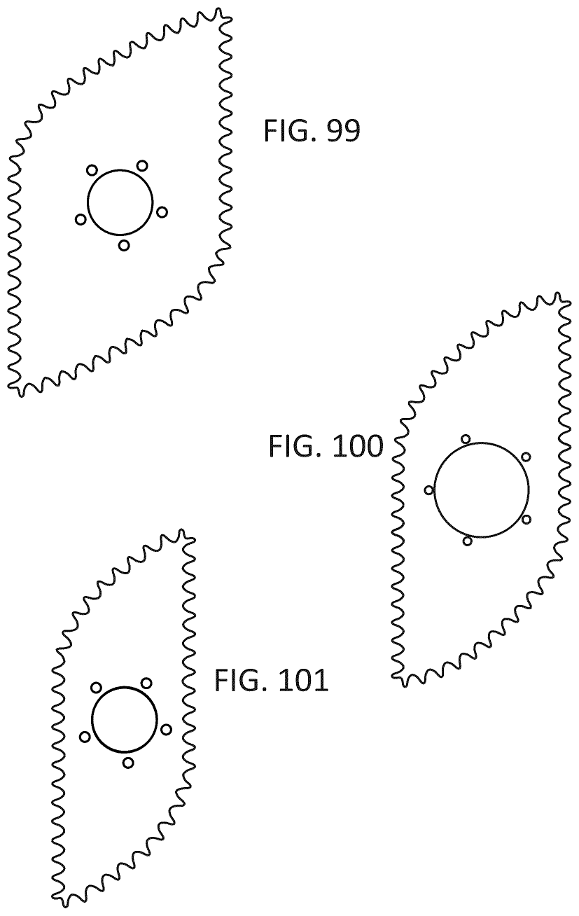

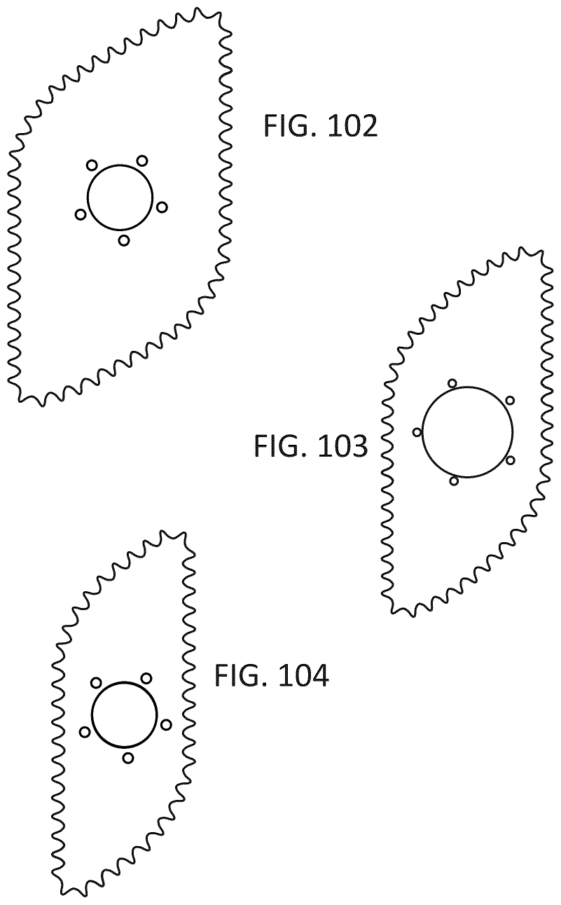

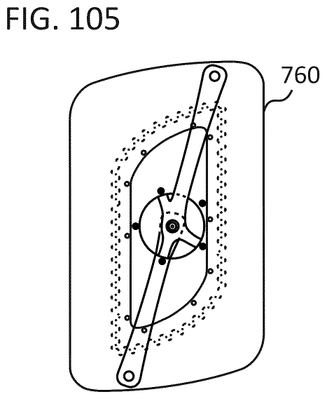

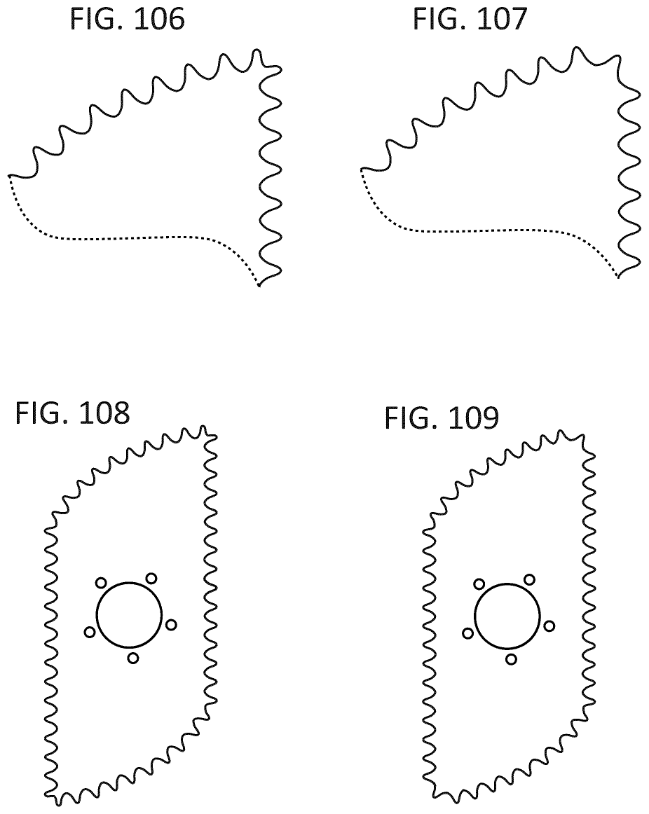

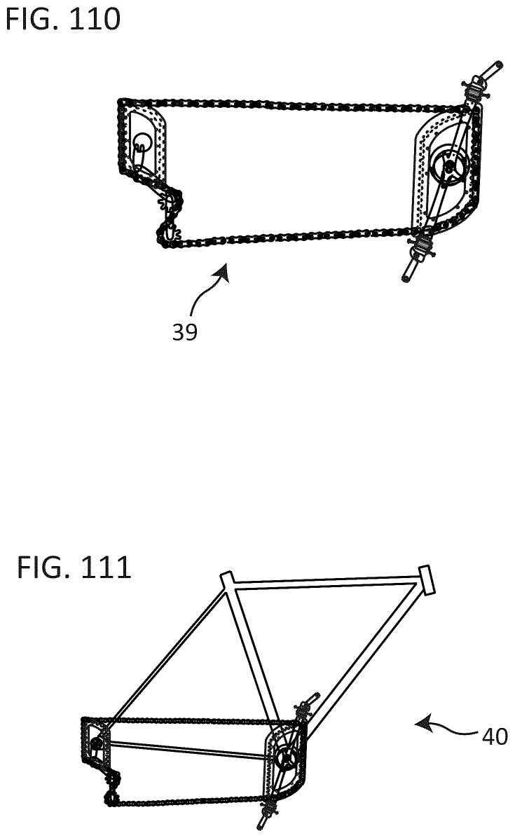

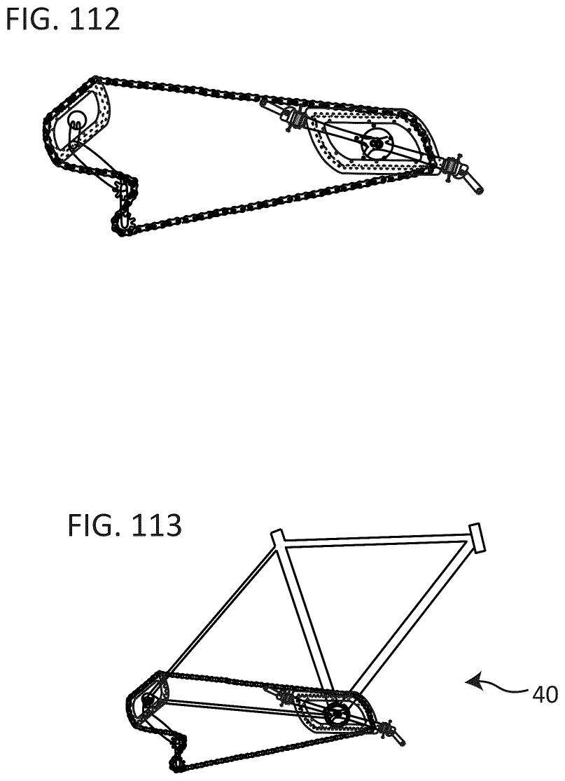

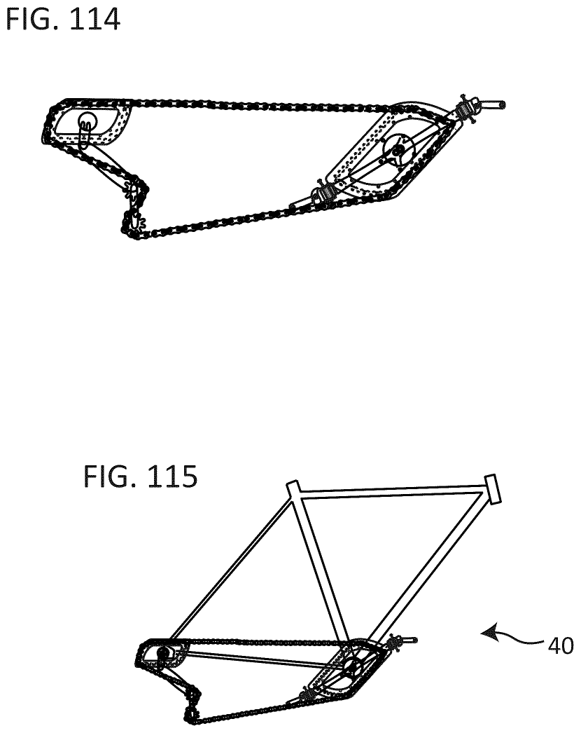

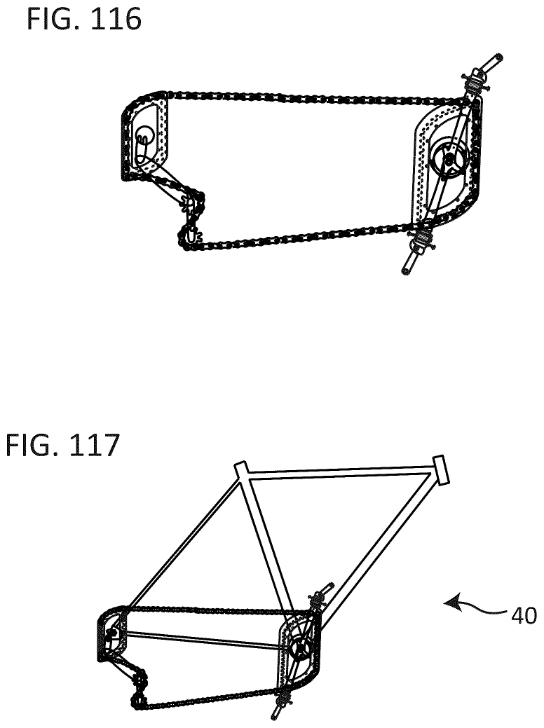

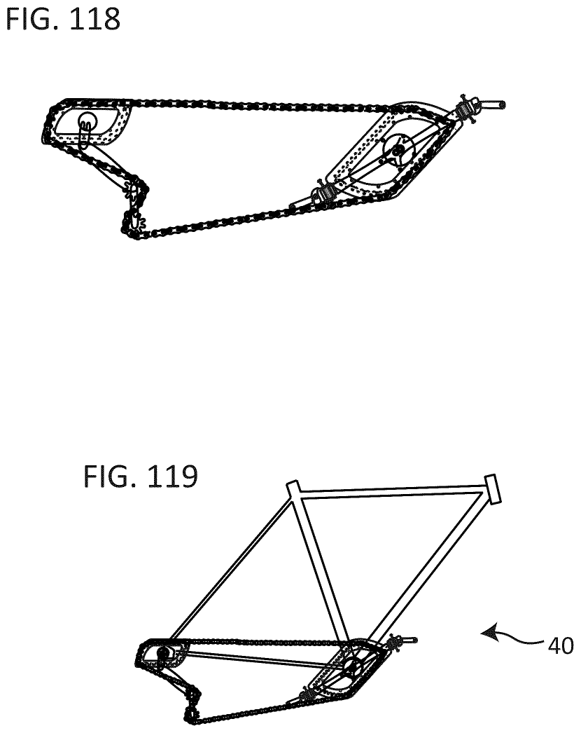

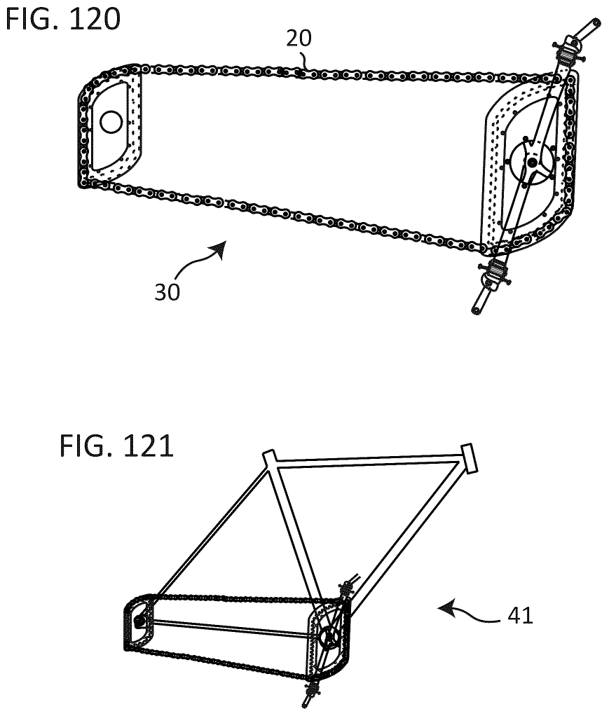

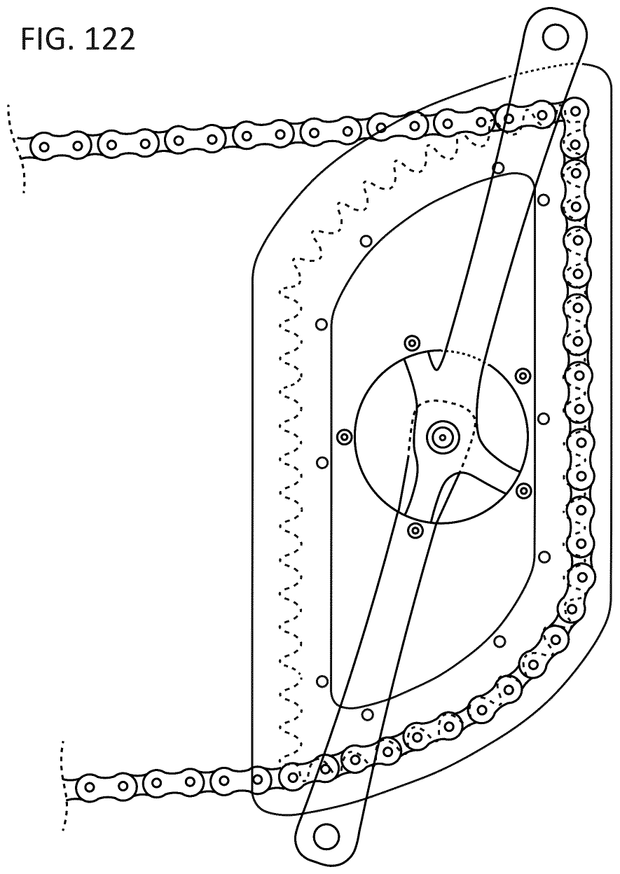

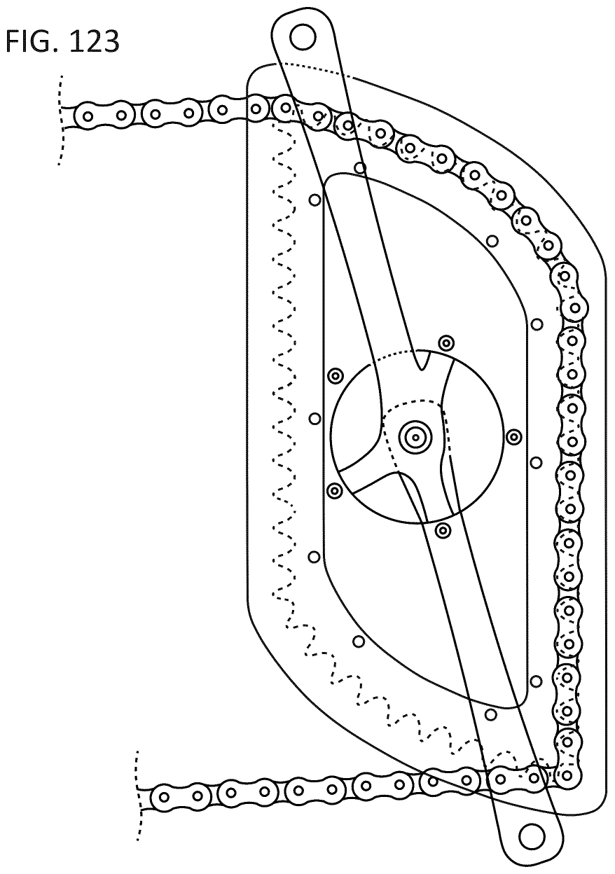

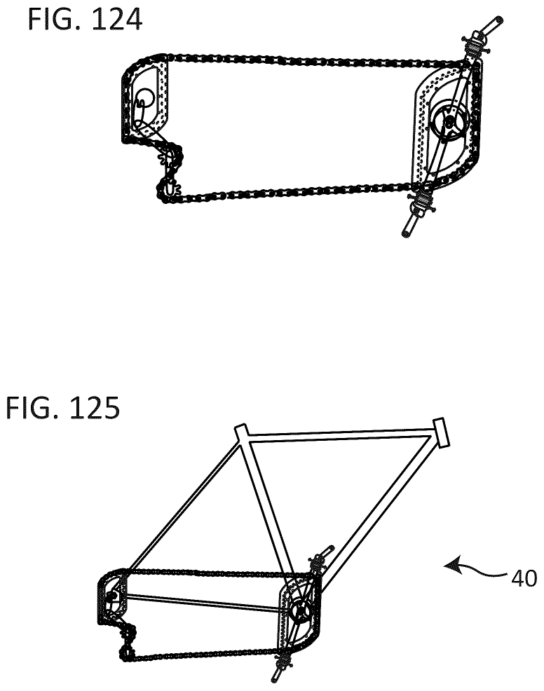

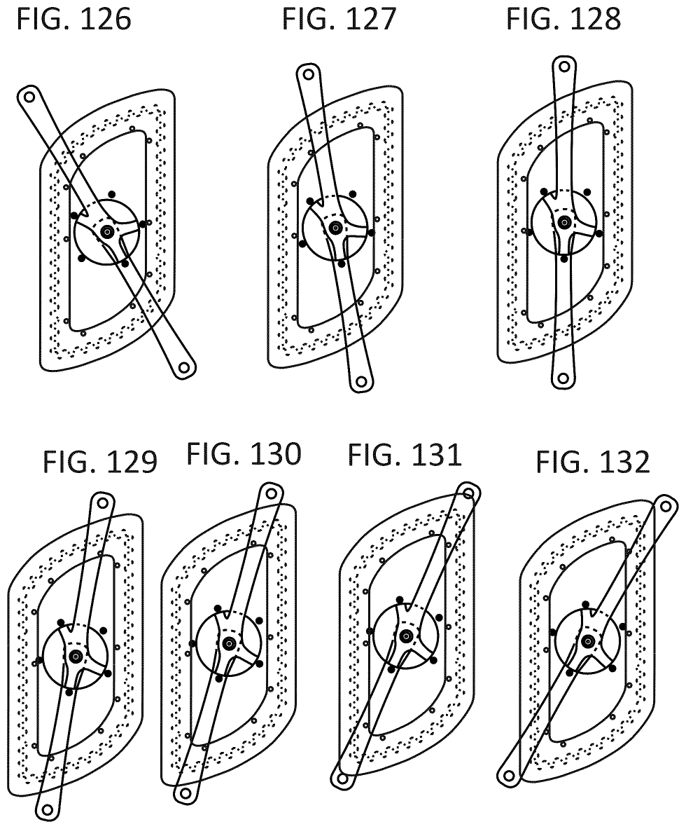

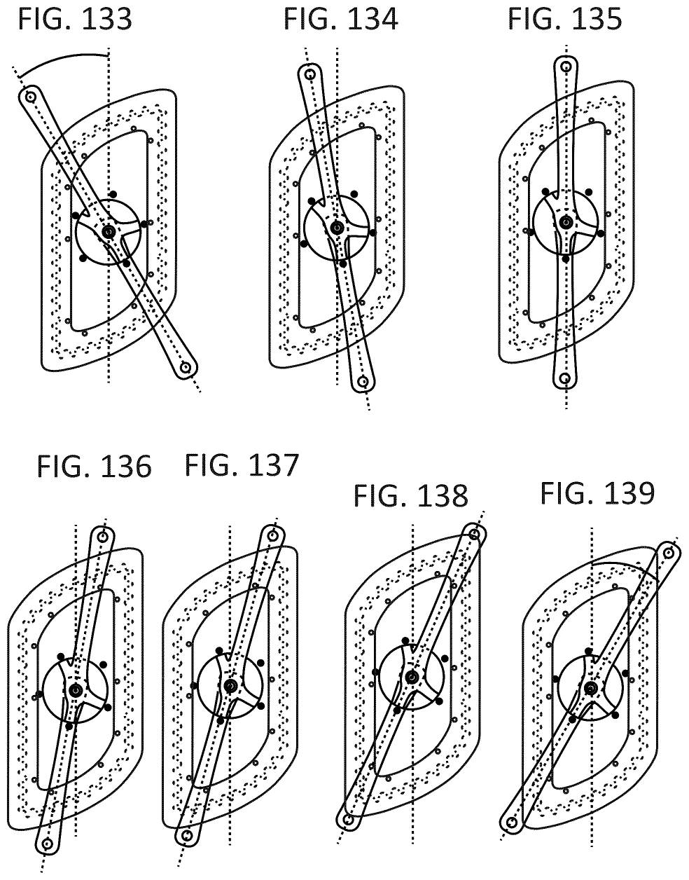

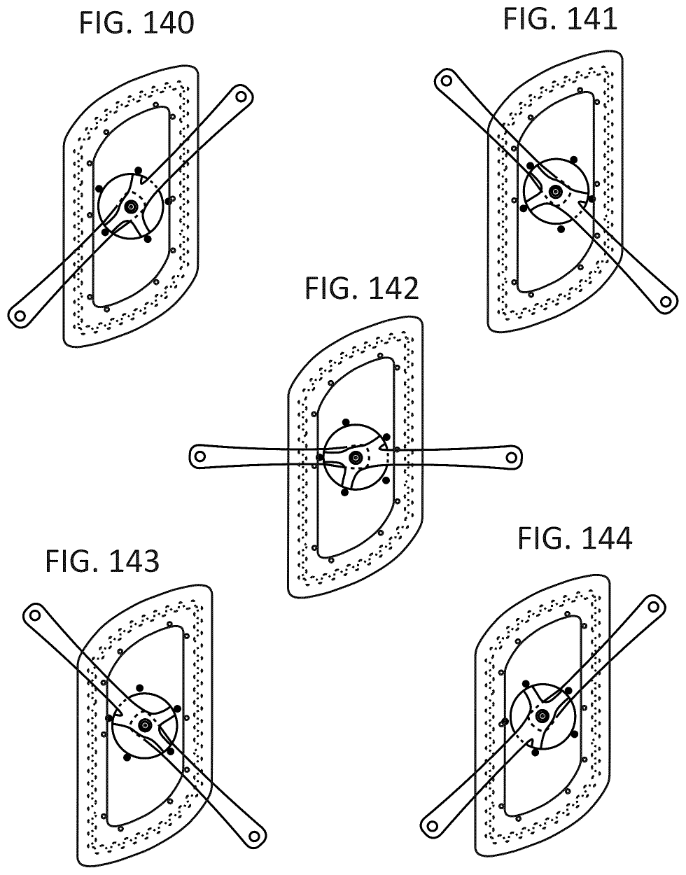

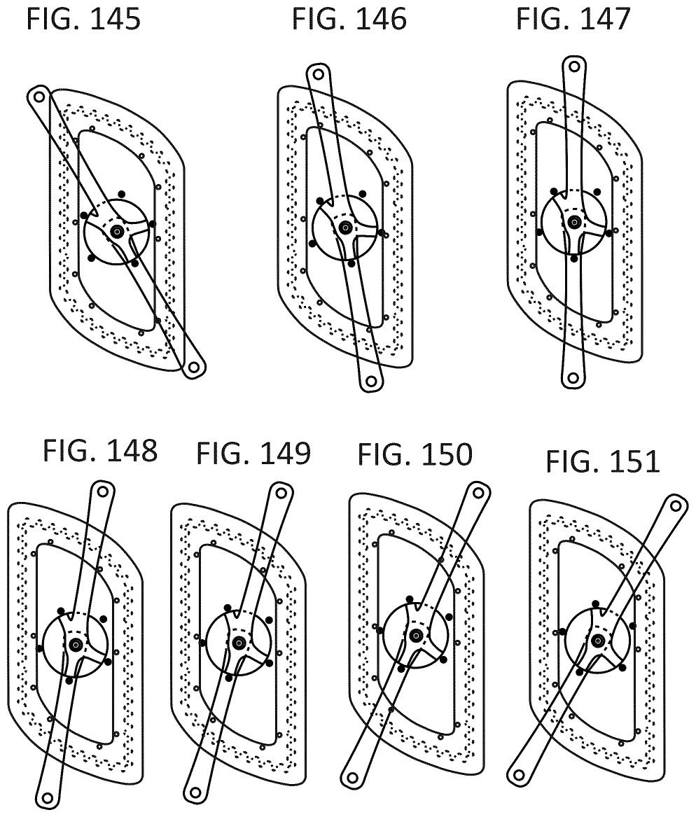

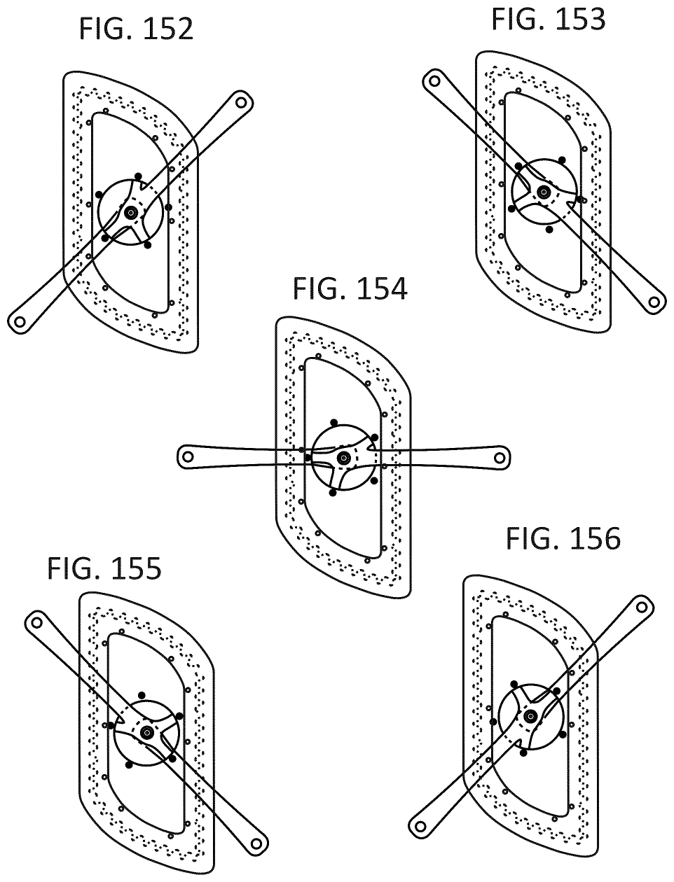

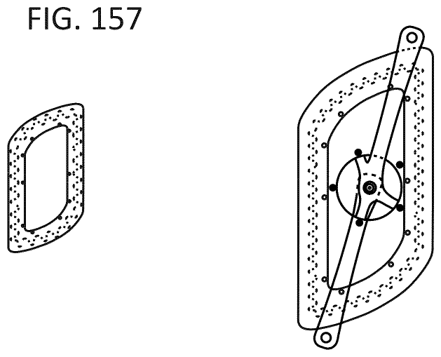

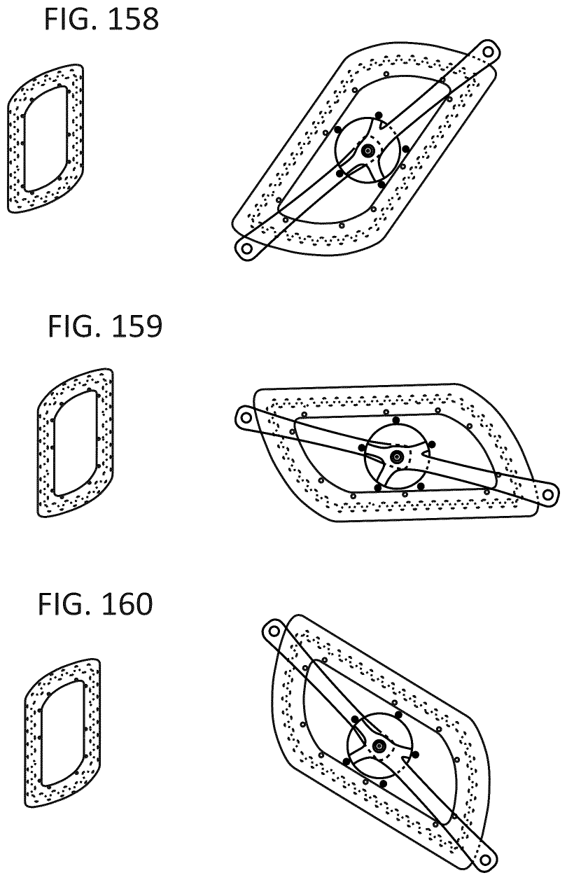

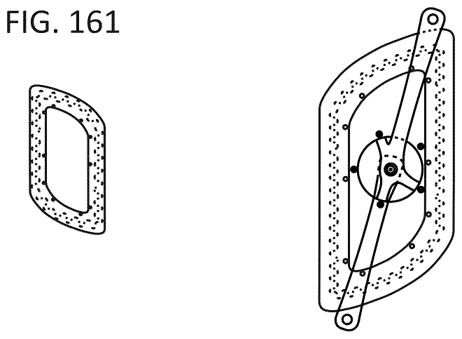

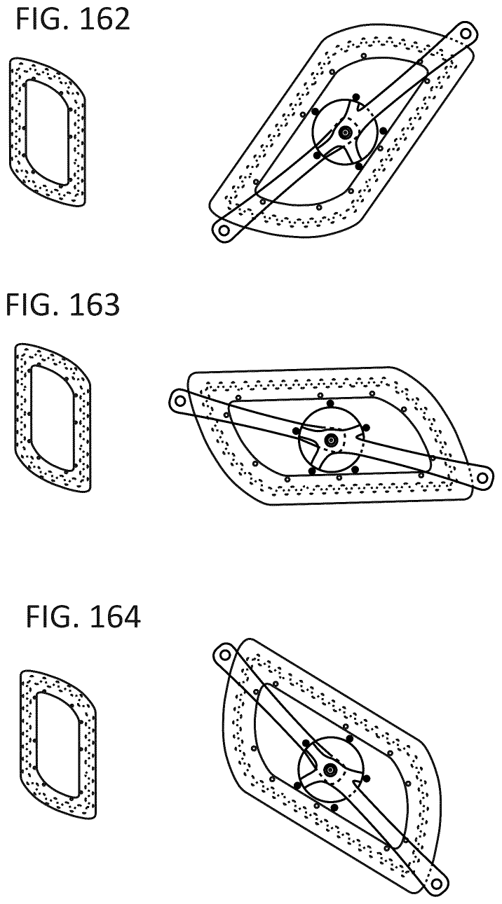

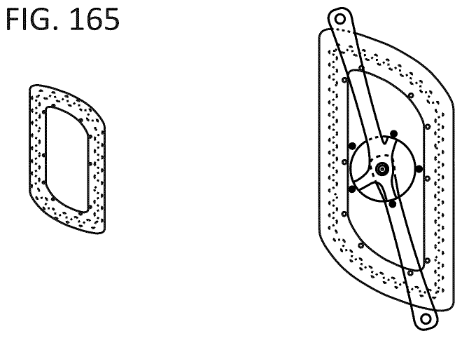

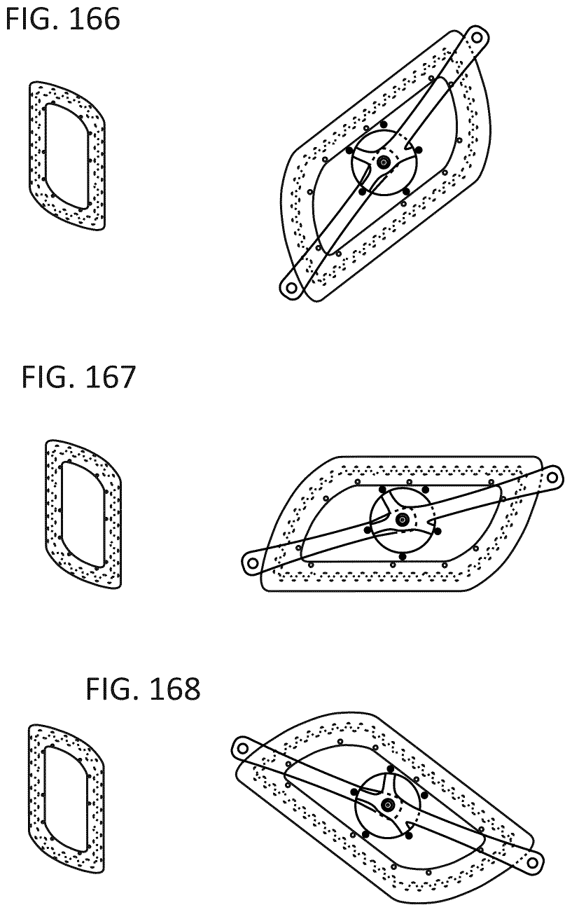

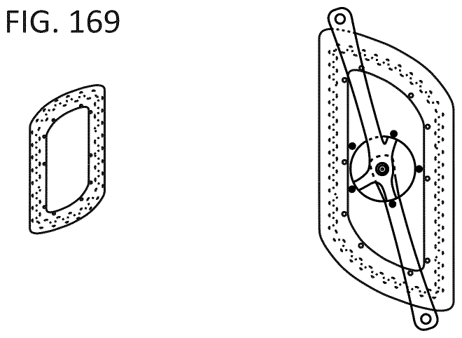

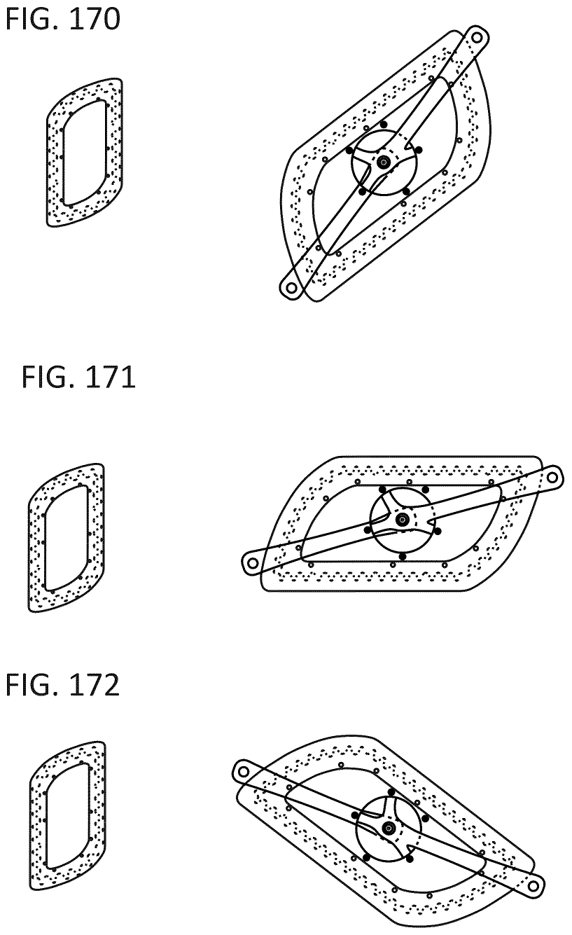

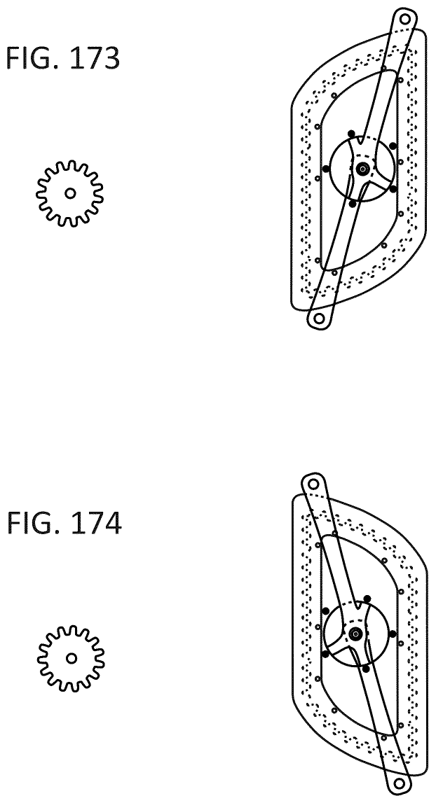

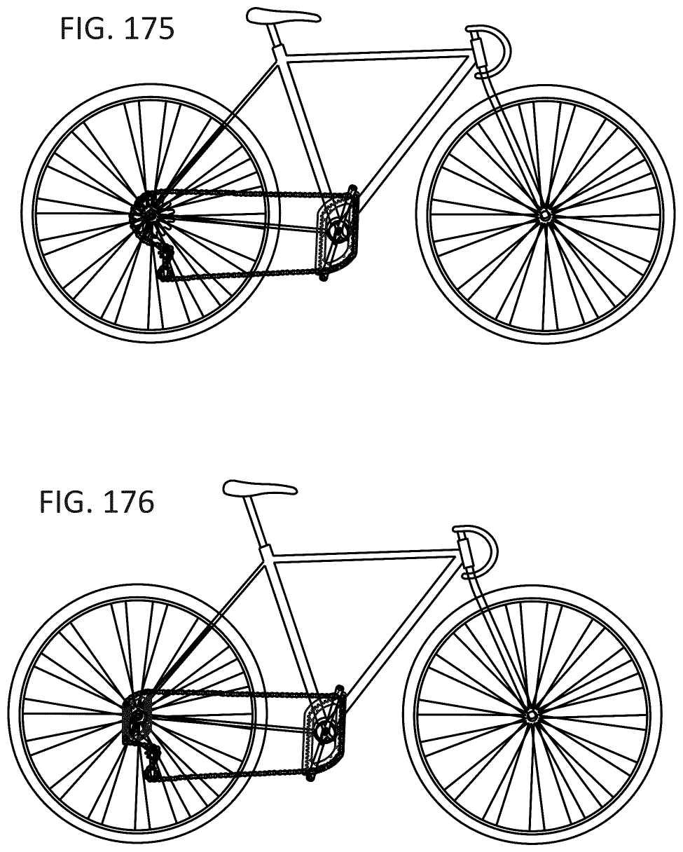

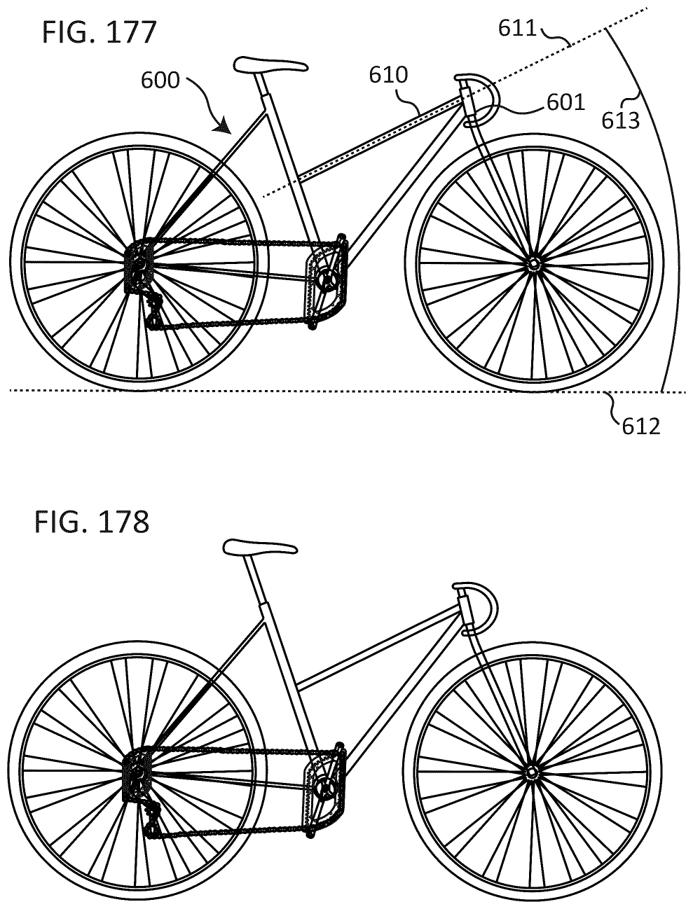

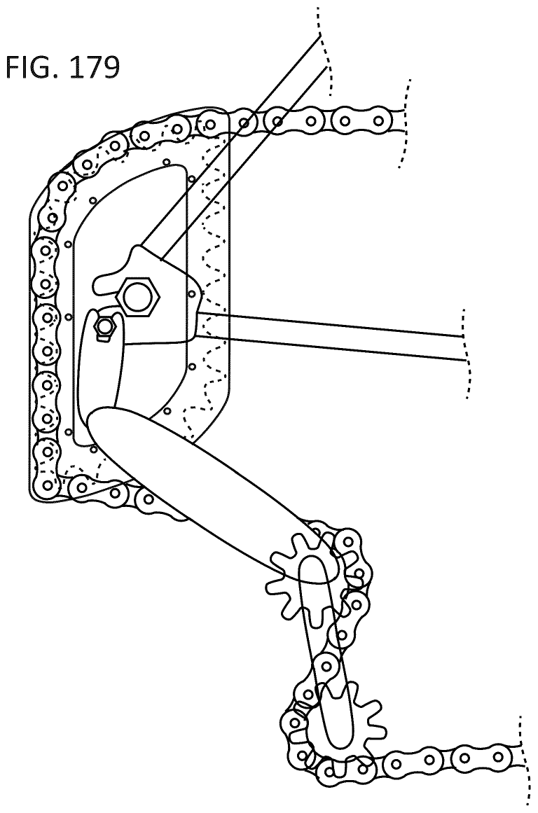

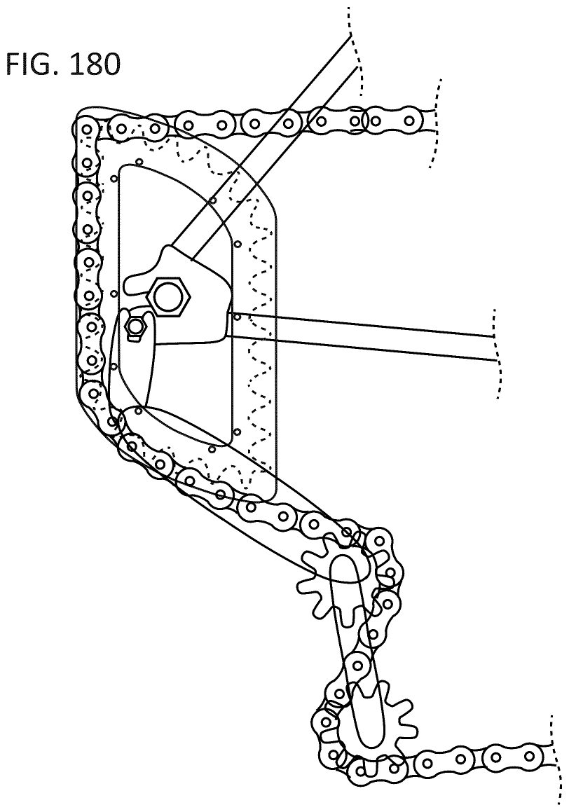

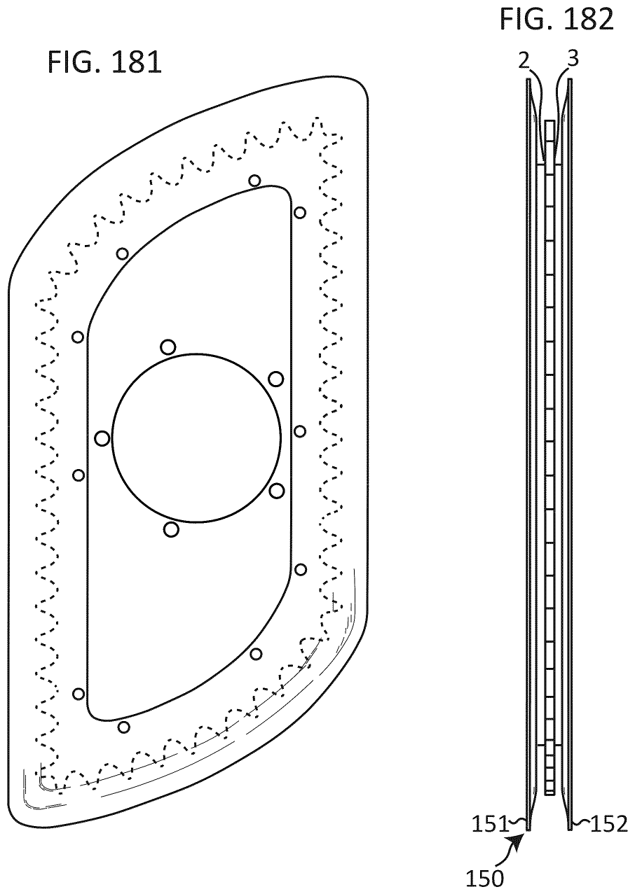

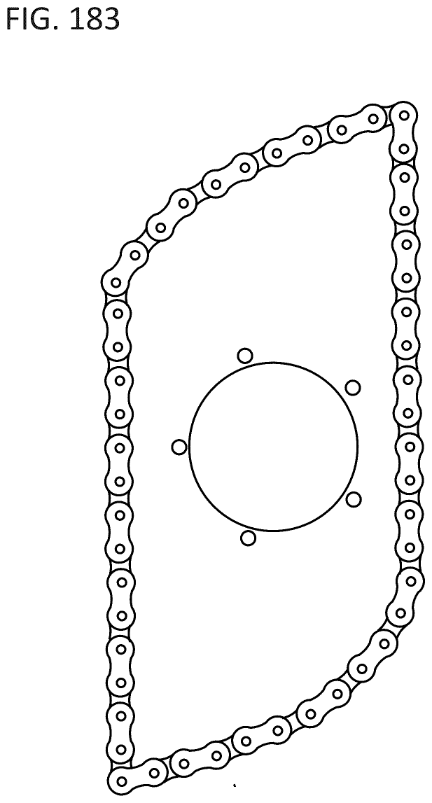

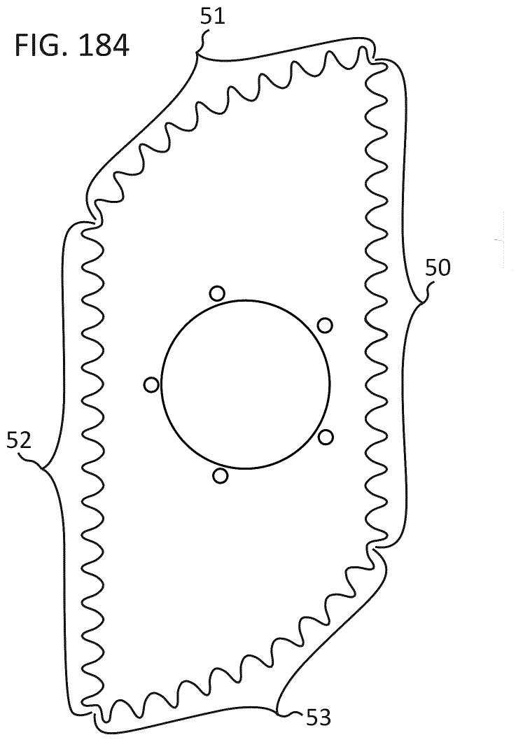

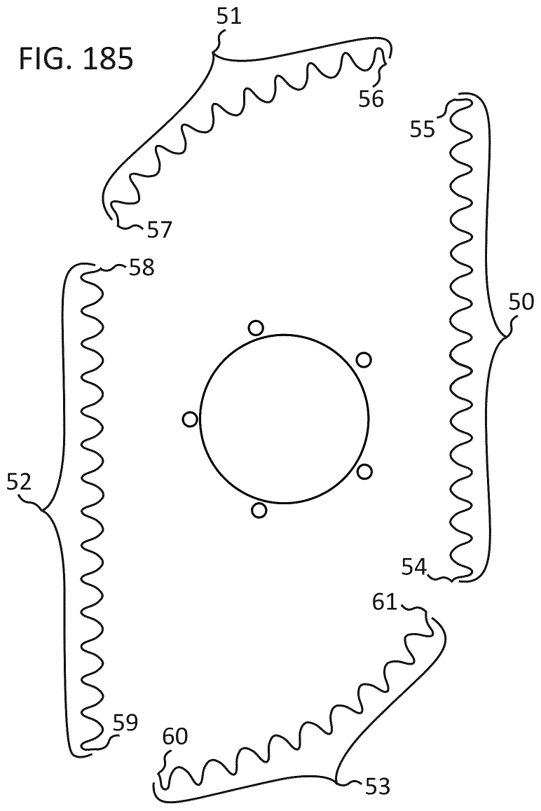

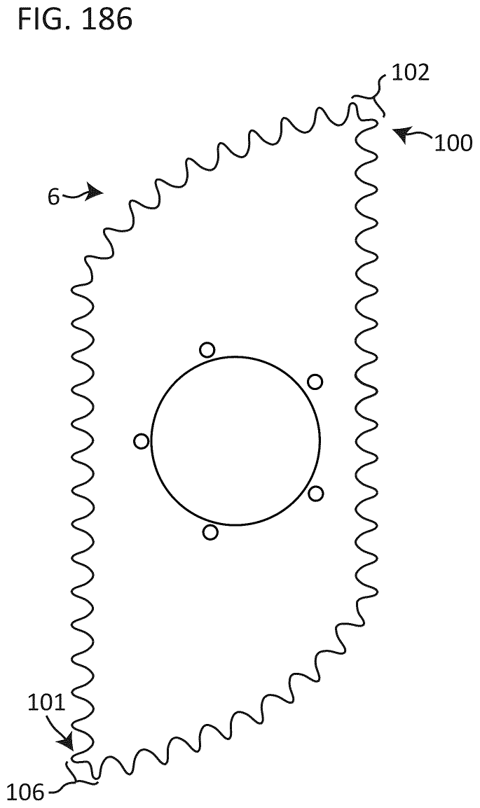

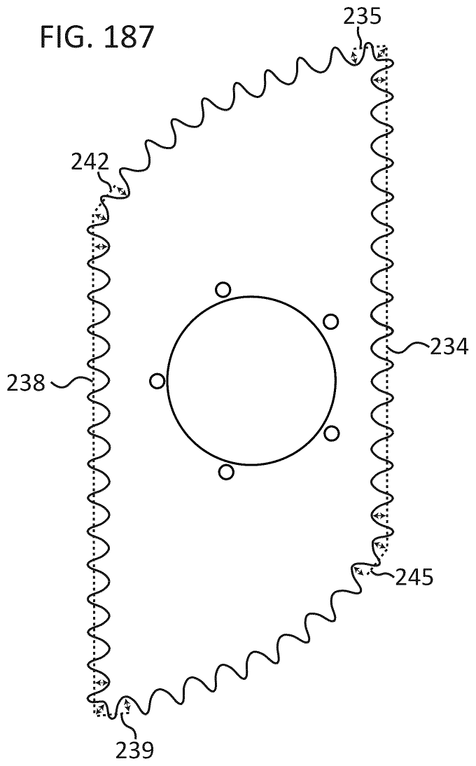

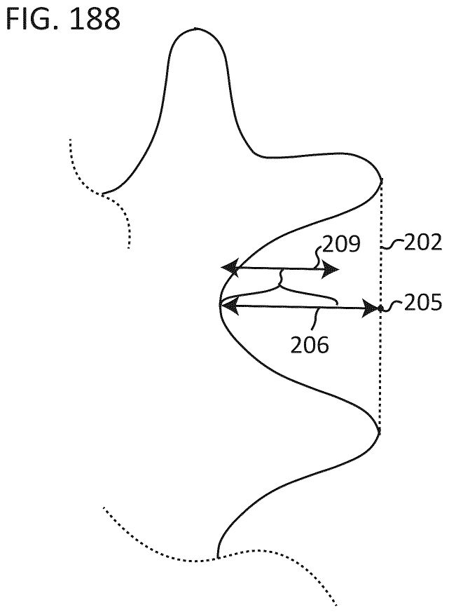

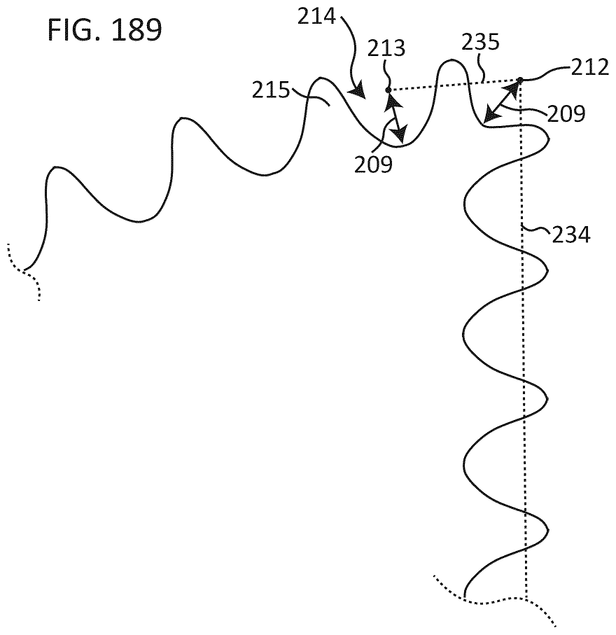

The narrow sprocket in FIG. 101 is the fastest of the three sprocket general shapes as seen in FIGS. 99, 100, and 101.

Standard components can be used to; connect the second sprocket 70 to the bicycle frame; or connect the first sprocket 1 and spindle 700 to the bicycle frame 600.

The rotation of the first sprocket when riding forward is indicated by the arrowed line of 400.

The movement of the slap crank arm lever 310 is represented by the arrowed lines of 401 to slap down for impact and 402 to reset into a position ready for moving forward to impact.

Embodiments of the crank arm can exist of a first short crank arm 280; second short crank arm 281; a first long crank arm 282; and a second long crank arm 283. These crank arms do not have slap clap arm end structures.

The device for the slap impact can be at the base of the crank arm, in the middle of the crank arm, or at the end of the crank arm.

An embodiment of the crank arms can be shorter or longer.

Above is a defined shape of the first sprocket 1 or second sprocket 70. There can be other non-circular shapes of a sprocket such as a square, parallelogram, a triangle, or other shapes. During prototype development, multiple shapes were tried and the best general shape was the above described two inline teeth sections and two curved teeth sections.

The above defined shape of the first sprocket 1 or second sprocket 70 does have two points in the shape. In other embodiments then can be a small radius, instead of the sharp points as described above, but the points were found to be more effective. Other embodiments of the first sprocket 1 or second sprocket 70 can have a point other than a double tooth structure, such as a tooth directly at the point, although the double tooth structure at the point was considered a preferable embodiment. Also in different and less effective embodiments the point in the shape in the sprocket may have rubber elements.

Embodiments of the first sprocket 1 or second sprocket 70 can be reversed in the direction of rotation.

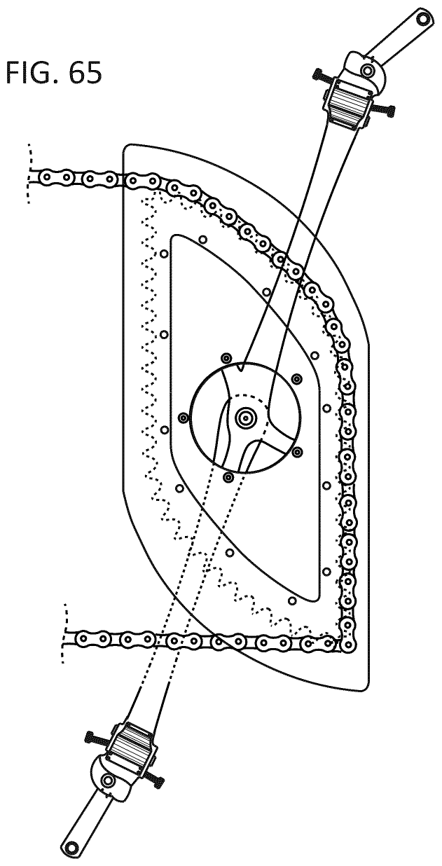

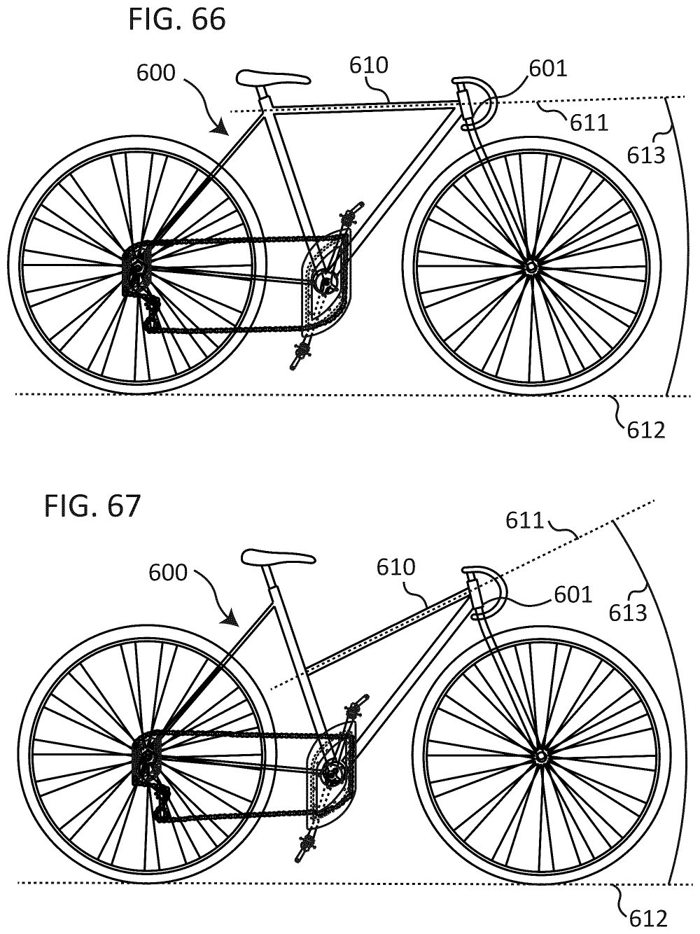

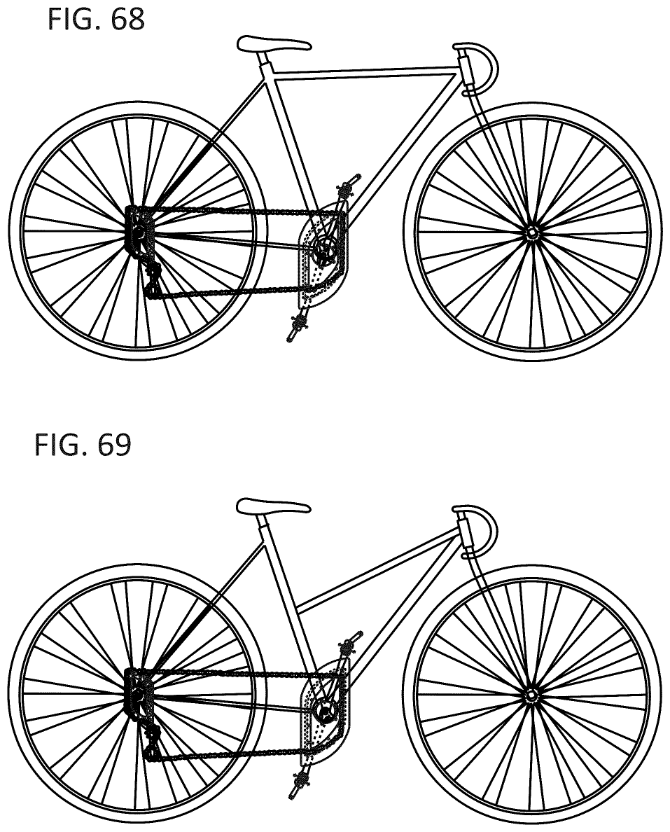

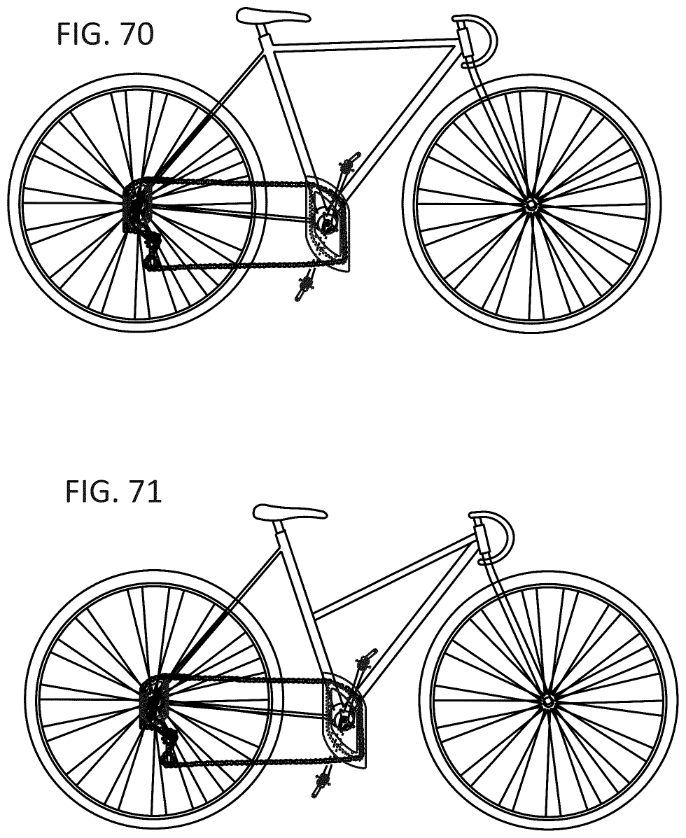

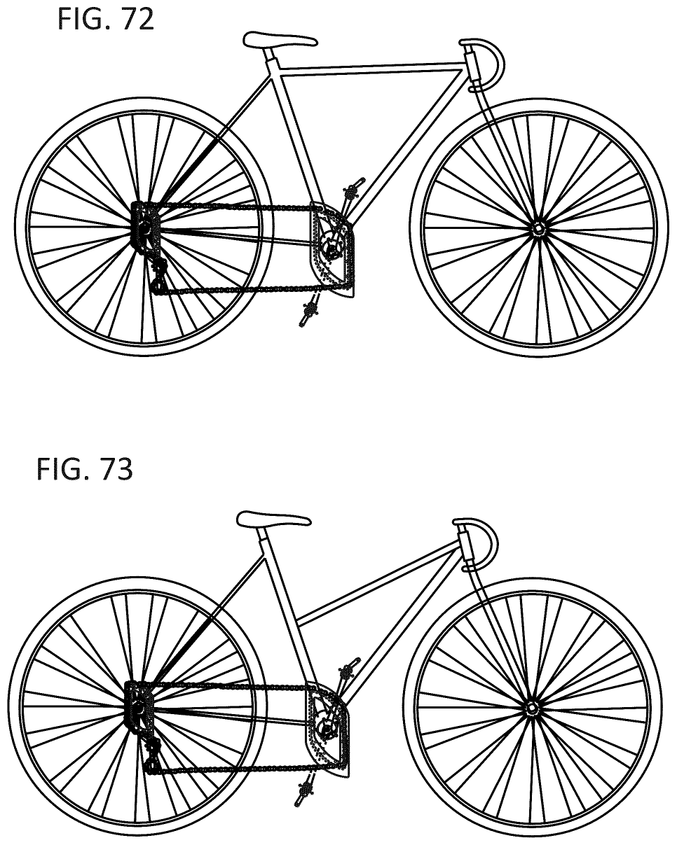

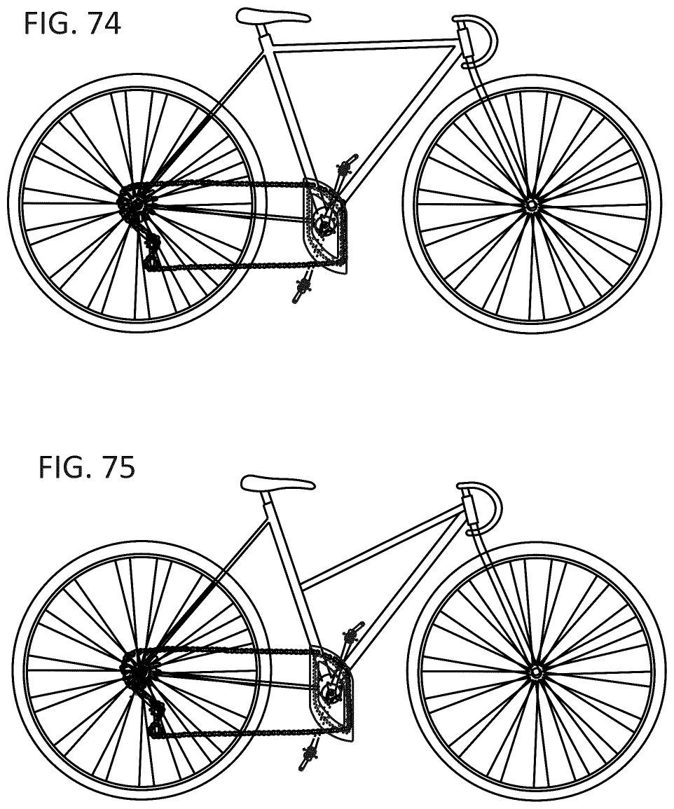

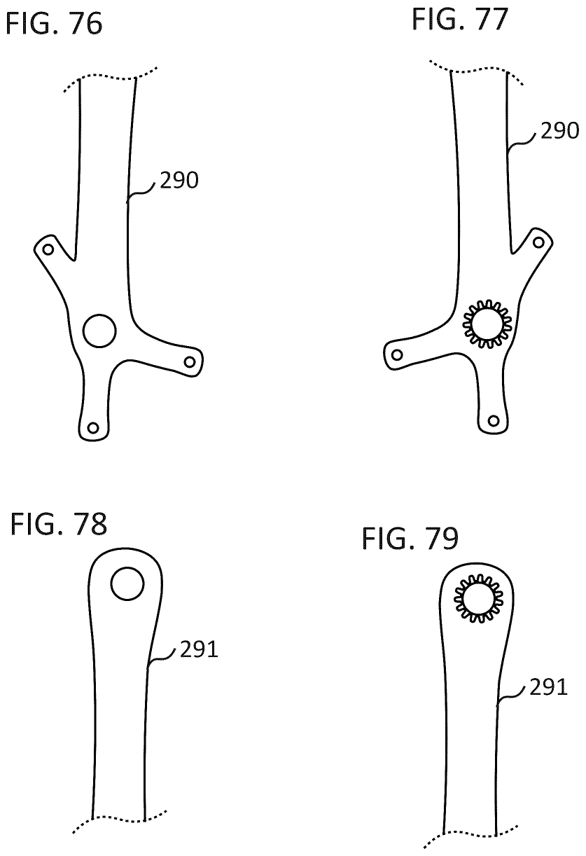

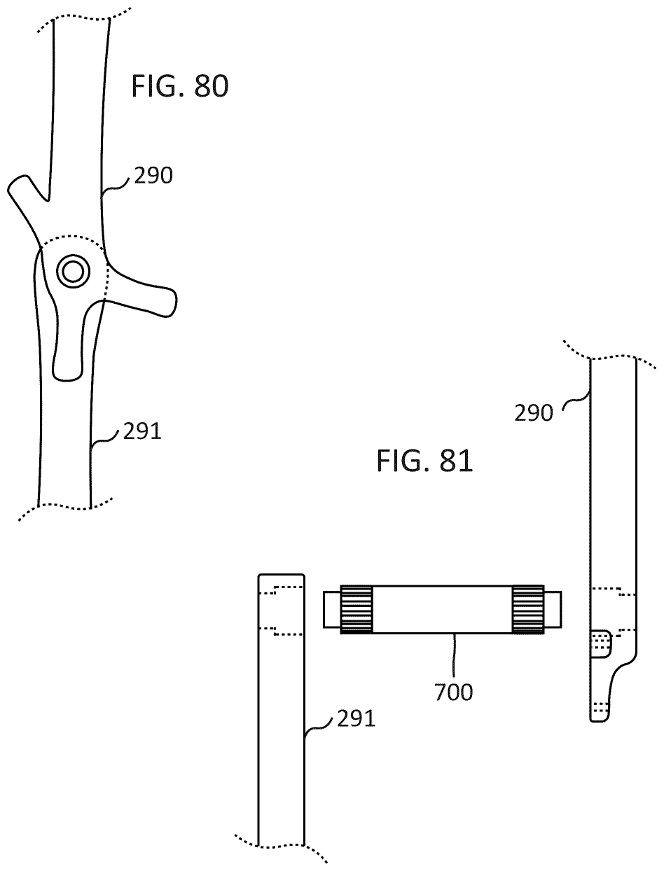

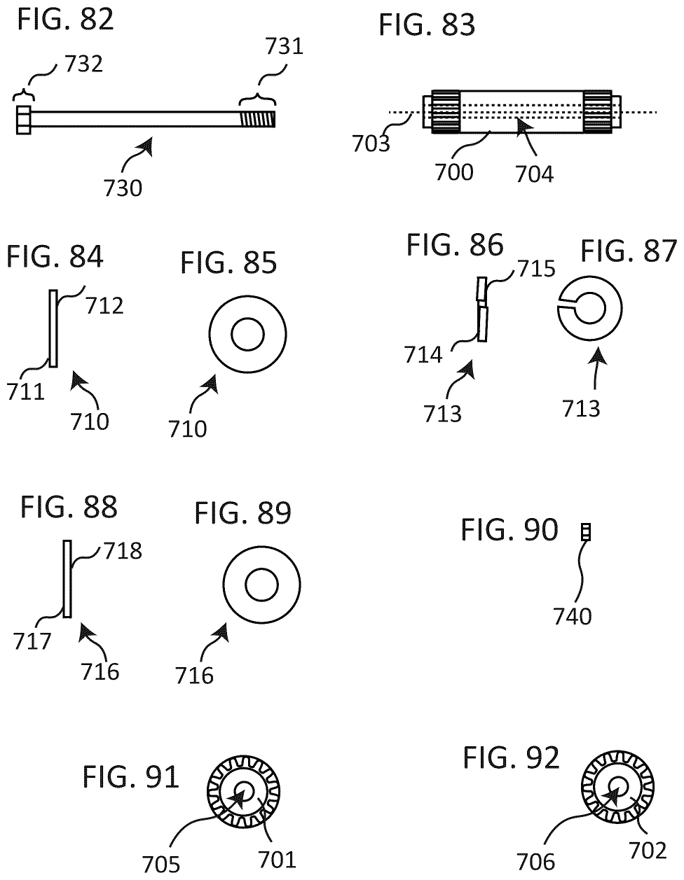

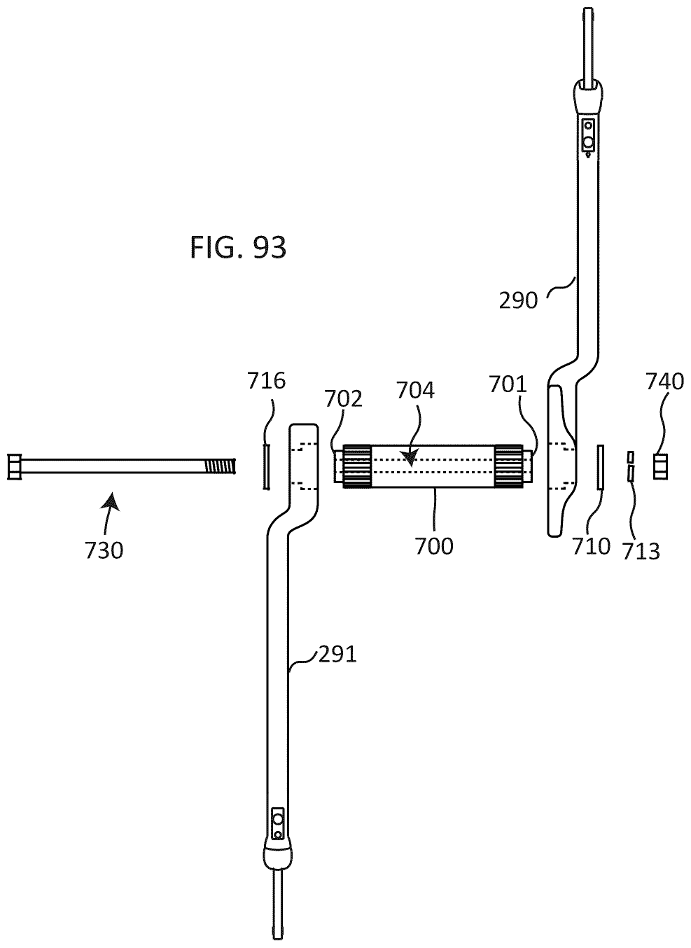

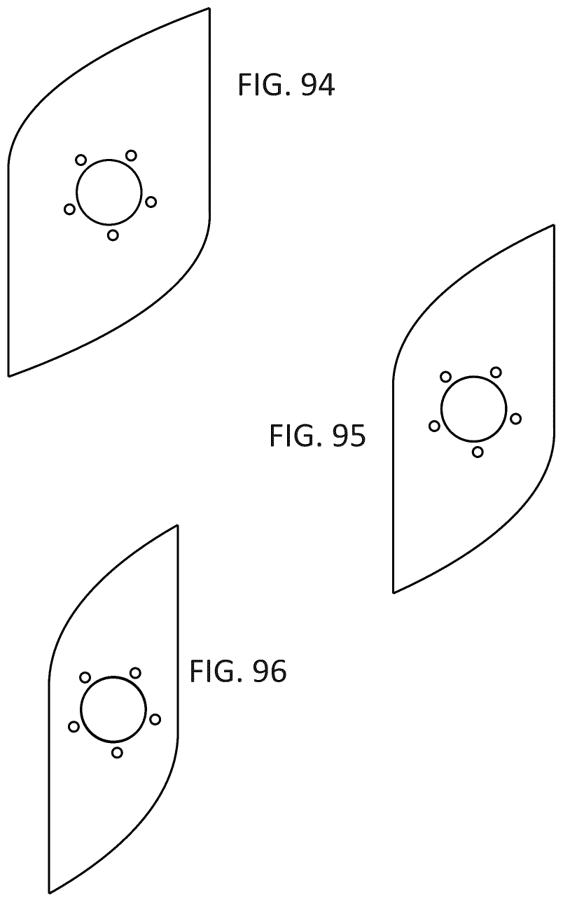

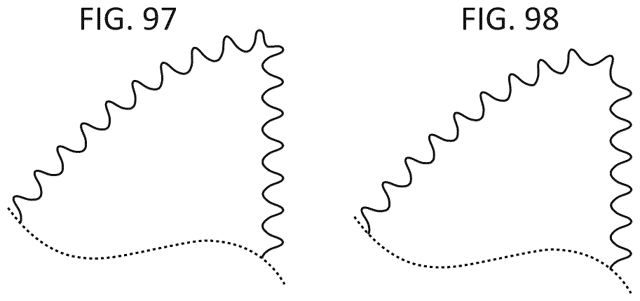

Depending on the user, such as an older rider of a bicycle, the ease of use, or the perceived ease of use, can be different in the reverse direction of rotation of the first sprocket 1, where the reverse is seen in FIG. 65. The direction of rotation can also be varied depending on the steepness of the hills planned to be climbed when bicycle riding. The reverse direction can be used for very steep hills.

Embodiments of the first sprocket 1 shape are there to reduce the wasted energy in the motion of rotation, or the perceived wasted energy in the motion of rotation.

Embodiments of the sprocket can be used for bikes, e-bikes, motorcycles, internal engine gears, treadmills, and other gears.

Less effective embodiments of the apparatus can include a first sprocket 1 attached to a slap crank arms and the rear sprocket is a round sprocket.

Less effective embodiments of the sprocket can include a toothless sprocket which is belt driven.

Less effective embodiments of the sprocket can include a track for the drive chain on the flat sections of the sprocket and teeth in the curved sections of the sprocket.

Less effective embodiments of the sprocket can include adjustments to the overall shape of the sprocket with chains attached to different sections of the sprocket, where the sprocket is made of multiple pieces.

Less effective embodiments of the sprocket can be adjustable with the teeth in the point.

1. An apparatus comprising,
a first sprocket,
a second sprocket,
the first and second sprocket each has a front face and rear face,
a shape of the front face on each of the first and second sprocket,
the first and second sprocket each has an outer edge,
the first and second sprocket each has teeth, the teeth are oriented around the outer edge of each of the first and second sprocket,
the teeth on the first and second sprocket each has a first, second, third, and fourth section of teeth,
on each of the first and second sprocket the first, second, third and fourth section of teeth each has a first end and a second end,
as viewed from the front face of each of the first and second sprocket, on each of the first and second sprocket, the teeth in the first and third section of teeth are in a straight line,
as viewed from the front face of each of the first and second sprocket, on each of the first and second sprocket the teeth in the second and fourth section of teeth are in a curved shape,
on each of the first and second sprocket the second end of the first section of teeth connects to the first end of the second section of teeth,
on each of the first and second sprocket the second end of the second section of teeth connects to the first end of third section of teeth,
on each of the first and second sprocket the second end of the third section of teeth connects to the first end of the fourth section of teeth,
on each of the first and second sprocket the second end of the fourth section of teeth connects to the first end of the first section of teeth,
as viewed from the front face of the first sprocket, a first point in the shape of the front face of the first sprocket, the first point in the shape of the first sprocket is at the second end of the first section of teeth of the first sprocket,
as viewed from the front face of the first sprocket, a second point in the shape of the front face of the first sprocket, the second point in the shape of the front face of the first sprocket is at the second end of the third section of teeth of the first sprocket,
as viewed from the front face of the second sprocket, a first point in the shape of the front face of the second sprocket, the first point in the shape of the front face of the second sprocket is at the second end of the first section of teeth of the second sprocket,
as viewed from the front face of the second sprocket, a second point in the shape of the front face of the second sprocket, the second point in the shape of the front face of the second sprocket is at the second end of the third section of teeth of the second sprocket,
a derailment guard first flange, the derailment guard first flange is around the outer edge of the first sprocket, the derailment guard first flange is attached to the front face of the first sprocket,
a derailment guard second flange, the derailment guard second flange is around the outer edge of the first sprocket, the derailment guard second flange is attached to the rear face of the first sprocket,
a drive chain,
a section of the outer edge of the first sprocket of contact of the drive chain and the first sprocket,
a section of the outer edge of the second sprocket of contact of the drive chain and the second sprocket,
the drive chain is one enclosed loop where the drive chain travels from the outer edge of the first sprocket to the outer edge of the second sprocket then around the section of the outer edge of the second sprocket of contact of the drive chain and the second sprocket, then back to the outer edge of the first sprocket and then around the section of the outer edge of the first sprocket of contact of the drive chain and the first sprocket,
a first and second slap crank arm,
the first slap crank arm attaches to the front face of the first sprocket,
a spindle, the spindle has a first end and a second end,
the first end of the spindle attaches to the first slap crank arm,
the second end of the spindle attaches to the second slap crank arm,
a first and second slap crank arm end structure, the first slap crank arm end structure connects to the first slap crank arm, the second slap crank arm end structure connects to the second slap crank arm,
each slap crank arm end structure, comprising,
a slap crank arm housing structure, comprising,
the slap crank arm housing structure connects to the slap crank arm,
the slap crank arm housing structure has a hollow cavity,
the slap crank arm housing structure has a left and right wall,
a slap crank arm lever,
a slap crank arm pivot bar, the slap crank arm pivot bar has a first end and a second end,
the first end of the slap crank arm pivot bar attaches to the left wall of the slap crank arm housing structure, the second end of the slap crank arm pivot bar attaches to the right wall of the slap crank arm housing structure,
the slap crank arm lever is connected to the slap crank arm pivot bar,
a slap crank arm rear spring, the slap crank arm rear spring has a first end and second end, the first end of the slap crank arm rear spring is attached to the slap crank arm housing structure, the second end of the slap crank arm rear spring is attached to the slap crank arm lever,
a slap crank arm front spring, the slap crank arm front spring has a first end and second end, the first end of the slap crank arm front spring is attached to the slap crank arm lever, the second end of the slap crank arm front spring is attached to the slap crank arm housing structure,
a slap crank arm lever pedal hole, the slap crank arm lever pedal hole has a first and second opening, the slap crank arm lever has a left face and right face, the first opening of the slap crank arm lever pedal hole is on the left face of the slap crank arm lever, the second opening of the slap crank arm lever pedal hole is on the right face of the slap crank arm lever.

2. The apparatus as in claim 1, further comprising,
a bicycle frame,
the first and second sprocket are connected to the bicycle frame,
the first and second sprocket are configured to rotate.

3. The apparatus as in claim 2, further comprising,
a rear derailleur structure, comprising,
an attachment bar, the attachment bar has a first and second end, the first end of the attachment bar is attached to the bicycle frame,
an extender bar, the extender bar has a first and second end, the first end of the
extender bar is attached to the second end of the attachment bar,
a tension sprocket bar, the tension sprocket bar has a first end and a second end, the first end of the tension sprocket bar is attached to the second end of
the extender bar,
an extender bar longitudinal axis,
a tension sprocket bar longitudinal axis,
an angle of attachment between the extender bar and the tension sprocket bar,
the angle of attachment between the extender bar and the tension sprocket bar is the angle of extender bar longitudinal axis to the tension sprocket bar longitudinal axis,
a rotation tension sprocket bar spring, the rotation tension sprocket bar spring has a first and second end, the first end of the rotation tension sprocket bar spring is attached to the second end of the extender bar, the second end of the rotation tension sprocket bar spring is attached to the first end of the tension sprocket bar, the rotation tension sprocket bar spring is under tension configured to widen the angle of attachment between the extender bar and the tension sprocket bar,
a first tension sprocket, the first tension sprocket is attached to the first end of the tension sprocket bar,
a second tension sprocket, the second tension sprocket is attached to the second end of the tension sprocket bar,
the first and second tension sprocket each has an outer edge,
a section of the outer edge of the first tension sprocket of contact of the drive chain and the first tension sprocket,
a section of the outer edge of the second tension sprocket of contact of the drive chain and the second tension sprocket,
the drive chain travels from the outer edge of the first sprocket to the outer edge of the second sprocket then around the section of the outer edge of the second sprocket of contact of the drive chain and the second sprocket to the outer edge of the first tension sprocket then around the section of the outer edge of the first tension sprocket of contact of the drive chain and the first tension sprocket then to the outer edge of the second tension sprocket, the drive chain is oriented in between the first tension sprocket and second tension sprocket, then around the section of the outer edge of the second tension sprocket of contact of the drive chain and the second tension sprocket then back to the outer edge of the first sprocket and then around the section of the outer edge of the first sprocket of contact of the drive chain and the first sprocket.

4. The apparatus as in claim 1, comprising,
the first and second sprocket each has valleys, a valley is oriented between each tooth of the first and second sprocket,
on each of the first and second sprocket there is a bottom of each valley,
on each of the first and second sprocket the first end and the second end of each of the first, second, third, and fourth section of teeth is at the bottom of a valley.

5. The apparatus as in claim 4, further comprising,
each of the first and second sprocket has,
a first double tooth structure, the first double tooth structure forms the first point in the shape of the front face of each sprocket,
a second double tooth structure, the second double tooth structure, forms the second point in the shape of the front face of each sprocket,
a tooth boundary, the tooth boundary is defined from the bottom of the valley on one side of the tooth to the bottom of the valley on the other side of the tooth,
the first double tooth structure has a first section tooth,
the first double tooth structure has a second section tooth,
a tooth in the first section of teeth directly adjacent to the second end of the first section of teeth,
the tooth in the first section of teeth directly adjacent to the second end of the first section of teeth is the first section tooth of the first double tooth structure, a tooth in the second section of teeth directly adjacent to the first end of the second section of teeth,
the tooth in the second section of teeth directly adjacent to the first end of the second section of teeth is the second section tooth of the first double tooth structure,
the first double tooth structure is formed from the first section tooth of the first double tooth structure and the second section tooth of the first double tooth structure,
a first end of the first double tooth structure, a tooth in the first section of teeth adjacent to the first section tooth of the first double tooth structure, a bottom of the valley between the first section tooth of the first double tooth structure and the tooth in the first section of teeth adjacent to the first section tooth of the first double tooth structure, the first end of the first double tooth structure is the bottom of the valley between the first section tooth of the first double tooth structure and the tooth in the first section of teeth adjacent to the first section tooth of the first double tooth structure,
a second end of the first double tooth structure, a tooth in the second section of teeth adjacent to the second section tooth of the first double tooth structure, a bottom of the valley between the second section tooth of the first double tooth structure and the tooth in the second section of teeth adjacent to the second section tooth of the first double tooth structure, the second end of the first double tooth structure is the bottom of the valley between the second section tooth of the first double tooth structure and the tooth in the second section of teeth adjacent to the second section tooth of the first double tooth structure,
the second double tooth structure has a third section tooth,
the second double tooth structure has a fourth section tooth,
a tooth in the third section of teeth directly adjacent to the second end of the third section of teeth,
the tooth in the third section of teeth directly adjacent to the second end of the third section of teeth is the third section tooth of the second double tooth structure,
a tooth in the fourth section of teeth directly adjacent to the first end of the fourth section of teeth,
the tooth in the fourth section of teeth directly adjacent to the first end of the fourth section of teeth is the fourth section tooth of the second double tooth structure,
the second double tooth structure is formed from the third section tooth of the second double tooth structure and the fourth section tooth of the second double tooth structure,
a first end of the second double tooth structure, a tooth in the third section of teeth adjacent to the third section tooth of the second double tooth structure, a bottom of the valley between the third section tooth of the second double tooth structure and the tooth in the third section of teeth adjacent to the third section tooth of the second double tooth structure, the first end of the second double tooth structure is the bottom of the valley between the third section tooth of the second double tooth structure and the tooth in the third section of teeth adjacent to the third section tooth of the second double tooth structure,
a second end of the second double tooth structure, a tooth in the fourth section of teeth adjacent to the fourth section tooth of the second double tooth structure, a bottom of the valley between the fourth section tooth of the second double tooth structure and the tooth in the fourth section of teeth adjacent to the fourth section tooth of the second double tooth structure, the second end of the second double tooth structure is the bottom of the valley between the fourth section tooth of the second double tooth structure and the tooth in the fourth section of teeth adjacent to the fourth section tooth of the second double tooth structure,
on the first sprocket,
the first section tooth of the first double tooth structure has a shape,
the second section tooth of the first double tooth structure has a shape,
the third section tooth of the second double tooth structure has a shape,
the fourth section tooth of the second double tooth structure has a shape,
the shape of the first section and second section tooth of the first double tooth structure and the shape of the third section and fourth section tooth of the second double tooth structure is defined by the profile of the first section and second section tooth of the first double tooth structure and the third section and fourth section tooth of the second double tooth structure when viewing the front face of the first sprocket,
the shape of the first section tooth of the first double tooth structure and the shape of the third section tooth of the second double tooth structure is the same,
the shape of the second section tooth of the first double tooth structure and the shape of the fourth section tooth of the second double tooth structure is the same,
the shape of the first section tooth of the first double tooth structure is a mirror image of the shape of the second section tooth of the first double tooth structure,
the shape of the third section tooth of the second double tooth structure is a mirror image of the shape of the fourth section tooth of the second double tooth structure,
on the second sprocket,
the first section tooth of the first double tooth structure has a shape,
the second section tooth of the first double tooth structure has a shape,
the third section tooth of the second double tooth structure has a shape,
the fourth section tooth of the second double tooth structure has a shape,
the shape of the first section and second section tooth of the first double tooth structure and the shape of the third section and fourth section tooth of the second double tooth structure is defined by the profile of the first section and second section tooth of the first double tooth structure and the third section and fourth section tooth of the second double tooth structure when viewing the front face of the second sprocket,
the shape of the first section tooth of the first double tooth structure and the shape of the third section tooth of the second double tooth structure is the same,
the shape of the second section tooth of the first double tooth structure and the shape of the fourth section tooth of the second double tooth structure is the same,
the shape of the first section tooth of the first double tooth structure is a mirror image of the shape of the second section tooth of the first double tooth structure,
the shape of the third section tooth of the second double tooth structure is a mirror image of the shape of the fourth section tooth of the second double tooth structure.

6. The apparatus as in claim 5, comprising,
the first and second sprocket each has,
a horizontal plane,
each tooth has a tip,
a first section tooth tip to tooth tip line segment, the first section tooth tip to tooth tip line segment has a first end and a second end, the first end and the second end of the first section tooth tip to tooth tip line segment is within the horizontal plane, the first end of the first section tooth tip to tooth tip line segment is at the tip of the first section tooth of the first double tooth, a tooth in the first section of teeth adjacent to the first section tooth of the first double tooth structure, the second end of the first section tooth tip to tooth tip line segment is at the tip of the tooth in the first section of teeth adjacent to the first section tooth of the first double tooth structure,
a middle point of the first section tooth tip to tooth tip line segment,
a bottom of a valley to first section of tooth tip to tooth tip line segment, the bottom of a valley to first section of tooth tip to tooth tip line segment is within the horizontal plane, the bottom of a valley to first section of tooth tip to tooth tip line segment has a first end and a second end, the first end of the bottom of a valley to first section of tooth tip to tooth tip line segment is at the bottom of the valley between the first section tooth of the first double tooth structure and the tooth in the first section of teeth adjacent to the first section tooth of the first double tooth structure, the second end of the bottom of a valley to first section of tooth tip to tooth tip line segment at the middle point of the first section tooth tip to tooth tip line segment,
a perpendicular line segment distance, the perpendicular line segment distance is within the horizontal plane, the perpendicular line segment distance has a first end and a second end, the first end of the perpendicular line segment distance is at the bottom of the valley between the first section tooth of the first double tooth structure and the tooth in the first section of teeth adjacent to the first section tooth of the first double tooth structure, the second end of the perpendicular line segment distance is a point along the bottom of a valley to first section of tooth tip to tooth tip line segment, the perpendicular line segment distance is 0.65 to 0.85 times the length of the bottom of a valley to first section of tooth tip to tooth tip line segment,
a first double tooth perpendicular line segment distance end point, the first double tooth perpendicular line segment distance end point is within the horizontal plane, a bottom of the valley between the first section tooth of the first double tooth structure and the second section tooth of the first double tooth structure, the first double tooth perpendicular line segment distance end point is a perpendicular line segment distance away from the sprocket from the bottom of the valley between the first section tooth of the first double tooth structure and the second section tooth of the first double tooth structure, the first double tooth perpendicular line segment distance end point is equal distant from the first section tooth of the first double tooth structure and the second section tooth of the first double tooth structure,
a first valley of the second section of teeth perpendicular line segment end point, the valley in the second section of teeth adjacent to the valley between the first section tooth and second section tooth of the first double tooth structure is the first valley of the second section of teeth, the first valley of the second section of teeth perpendicular line segment end point is within the horizontal plane, a the bottom of the valley of the first valley of the second section of the teeth, the first valley of the second section of teeth perpendicular line segment end point is a perpendicular line segment distance away from the sprocket from the bottom of the valley of the first valley of the second section of the teeth, a tooth of the second section of teeth adjacent to the second section tooth of the first double tooth structure, the first valley of the second section of teeth perpendicular line segment end point is equal distant from the second section tooth of the first double tooth structure and the tooth of the second section of teeth adjacent to the second section tooth of the first double tooth structure,
a last valley of the second section of teeth perpendicular line segment end point, a valley at the second end of the second section of teeth and the first end of the third section of teeth, a last valley of the second section of teeth, the valley in the second section of teeth adjacent to the valley at the second end of the second section of teeth and the first end of the third section of teeth is the last valley of the second section of teeth, the last valley of the second section of teeth perpendicular line segment end point is within the horizontal plane, a tooth of the second section of teeth adjacent to the valley at the second end of the second section of teeth and the first end of the third section of teeth, a tooth of the second section of teeth adjacent to the tooth of the second section of teeth adjacent to the valley at the second end of the second section of teeth and the first end of the third section of teeth, a bottom of the valley at the last valley of the second section of the teeth, the last valley of the second section of teeth perpendicular line segment end point is a perpendicular line segment distance away from the sprocket from the bottom of the valley of the last valley of the second section of the teeth, the last valley of the second section of teeth perpendicular line segment end point is equal distant from the tooth of the second section of teeth adjacent to the valley at the second end of the second section of teeth and the first end of the third section of teeth and the tooth of the second section of teeth adjacent to the tooth of the second section of teeth adjacent to the valley at the second end of the second section of teeth and the first end of the third section of teeth,
a connection of the second section and third section of teeth perpendicular line segment distance end point, the connection of the second section and third section of teeth perpendicular line segment distance end point is within the horizontal plane, a tooth of the third section of teeth adjacent to the valley at the second end of the second section of teeth and the first end of the third section of teeth, a bottom of the valley at the second end of the second section of teeth and the first end of the third section of teeth, the connection of the second section and third section of teeth perpendicular line segment distance end point is a perpendicular line segment distance away from the sprocket from the bottom of the valley at the second end of the second section of teeth and the first end of the third section of teeth, the connection of the second section and third section of teeth perpendicular line segment distance end point is equal distant from the tooth of the second section of teeth adjacent to the valley at the second end of the second section of teeth and the first end of the third section of teeth and the tooth of the third section of teeth adjacent to the valley at the second end of the second section of teeth and the first end of the third section of teeth,
a second double tooth perpendicular line segment distance end point, the second double tooth perpendicular line segment distance end point is within the horizontal plane, a bottom of the valley between the third section tooth of the second double tooth structure and the fourth section tooth of the second double tooth structure, the second double tooth perpendicular line segment distance end point is a perpendicular line segment distance away from the sprocket from the bottom of the valley between the third section tooth of the second double tooth structure and the fourth section tooth of the second double tooth structure,
a first valley of the fourth section of teeth perpendicular line segment end point,
a first valley of the fourth section of teeth, the valley in the fourth section of teeth adjacent to the valley between the third section tooth and fourth section tooth of the second double tooth structure is the first valley of the fourth section of teeth, the first valley of the fourth section of teeth perpendicular line segment end point is within the horizontal plane, a bottom of the valley of the first valley of the fourth section of the teeth, the first valley of the fourth section of teeth perpendicular line segment end point is a perpendicular line segment distance away from the sprocket from the bottom of the valley of the first valley of the fourth section of the teeth, a tooth of the fourth section of teeth adjacent to the fourth section tooth of the second double tooth structure, the first valley of the fourth section of teeth perpendicular line segment end point is equal distant from the fourth section tooth of the second double tooth structure and the tooth of the fourth section of teeth adjacent to the fourth section tooth of the second double tooth structure,
a last valley of the fourth section of teeth perpendicular line segment end point, a valley at the second end of the fourth section of teeth and the first end of the first section of teeth, a last valley of the fourth section of teeth, the valley in the fourth section of teeth adjacent to the valley at the second end of the fourth section of teeth and the first end of the first section of teeth is the last valley of the fourth section of teeth, the last valley of the fourth section of teeth perpendicular line segment end point is within the horizontal plane, a tooth of the fourth section of teeth adjacent to the valley at the second end of the fourth section of teeth and the first end of the first section of teeth, a tooth of the fourth section of teeth adjacent to the tooth of the fourth section of teeth adjacent to the valley at the second end of the fourth section of teeth and the first end of the first section of teeth, a bottom of the valley at the last valley of the fourth section of the teeth, the last valley of the fourth section of teeth perpendicular line segment end point is a perpendicular line segment distance away from the sprocket from the bottom of the valley of the last valley of the fourth section of the teeth, the last valley of the fourth section of teeth perpendicular line segment end point is equal distant from the tooth of the fourth section of teeth adjacent to the valley at the second end of the fourth section of teeth and the first end of the first section of teeth and the tooth of the fourth section of teeth adjacent to the tooth of the fourth section of teeth adjacent to the valley at the second end of the fourth section of teeth and the first end of the first section of teeth,
a connection of the fourth section and first section of teeth perpendicular line segment distance end point, the connection of the fourth section and first section of teeth perpendicular line segment distance end point is within the horizontal plane, a tooth of the first section of teeth adjacent to the valley at the second end of the fourth section of teeth and the first end of the first section of teeth, a bottom of the valley at the second end of the fourth section of teeth and the first end of the first section of teeth, the connection of the fourth section and first section of teeth perpendicular line segment distance end point is a perpendicular line segment distance away from the sprocket from the bottom of the valley at the second end of the fourth section of teeth and the first end of the first section of teeth, the connection of the fourth section and first section of teeth perpendicular line segment distance end point is equal distant from the tooth of the fourth section of teeth adjacent to the valley at the second end of the fourth section of teeth and the first end of the first section of teeth and the tooth of the first section of teeth adjacent to the valley at the second end of the fourth section of teeth and the first end of the first section of teeth,
a first straight line segment, the first straight line segment has a first end and a second end, the first end of the first straight line segment is the connection of the fourth section and first section of teeth perpendicular line segment distance end point, the second end of the first straight line segment is the first double tooth perpendicular line segment distance end point,
a first line segment defining the second section of teeth, the first line segment defining the second section of teeth has a first end and a second end, the first end of the first line segment defining the second section of teeth is the first double tooth perpendicular line segment distance end point, the second end of the first line segment defining the second section of teeth is the first valley of the second section of teeth perpendicular line segment end point,
a connection of the first straight line segment to the first line segment defining the second section of teeth at the first double tooth perpendicular line segment distance end point,
an angle at the connection of the first straight line segment to the first line segment defining the second section of teeth,
the angle at the connection of the first straight line segment to the first line segment defining the second section of teeth is between 81 and 89 degrees,
a second straight line segment, the second straight line segment has a first end and a second end, the first end of the second straight line segment is the connection of the second section and third section of teeth perpendicular line segment distance end point, the second end of the second straight line segment is the second double tooth perpendicular line segment distance end point,
a first line segment defining the fourth section of teeth, the first line segment defining the fourth section of teeth has a first end and a second end, the first end of the first line segment defining the fourth section of teeth is the second double tooth perpendicular line segment distance end point, the second end of the first line segment defining the fourth section of teeth is the first valley of the fourth section of teeth perpendicular line segment end point,
a connection of the second straight line segment to the first line segment defining the fourth section of teeth at the second double tooth perpendicular line segment distance end point,
an angle at the connection of the second straight line segment to the first line segment defining the fourth section of teeth,
the angle at the connection of the second straight line segment to the first line segment defining the fourth section of teeth is between 81 and 89 degrees,
a last line segment defining the second section of teeth, the last line segment defining the second section of teeth has a first end and a second end, the first end of the last line segment defining the second section of teeth is the last valley of the second section of teeth perpendicular line segment end point, the second end of the last line segment defining the second section of teeth is the connection of the second section and third section of teeth perpendicular line segment distance end point,
a connection of the last line segment defining the second section of teeth to the second straight line segment at the connection of the second section and third section of teeth perpendicular line segment distance end point,
an angle at the connection of the last line segment defining the second section of teeth to the second straight line segment,
the angle at the connection of the last line segment defining the second section of teeth to the second straight line segment is between 163 and 171 degrees,
a last line segment defining the fourth section of teeth, the last line segment defining the fourth section of teeth has a first end and a second end, the first end of the last line segment defining the fourth section of teeth is the last valley of the fourth section of teeth perpendicular line segment end point, the second end of the last line segment defining the fourth section of teeth is the connection of the fourth section and first section of teeth perpendicular line segment distance end point,
a connection of the last line segment defining the fourth section of teeth to the first straight line segment at the connection of the fourth section and first section of teeth perpendicular line segment distance end point,
an angle at the connection of the last line segment defining the fourth section of teeth to the first straight line segment,
the angle at the connection of the last segment defining the fourth section of teeth to the first straight line segment is between 163 and 171 degrees.

7. The apparatus as in claim 3, further comprising,
a front tip of the bicycle frame,
a rear tip of the bicycle frame,
the front tip of the bicycle frame is the leading portion of the bicycle frame, if the bicycle frame is configured to be ridden as part of a bicycle,
the first sprocket is attached to the bicycle frame closer to the front tip of the bicycle frame than the second sprocket,
on the front face of each of the first and second sprocket, a connection of the second section of teeth to the third section of teeth, the connection of the second section of teeth to the third section of teeth is a gradual transition without a sharp point in the shape of the front face, a connection of the fourth section of teeth to the first section of teeth, the connection of the fourth section of teeth to the first section of teeth is a gradual transition without a sharp point in the shape of the front face,
the first sprocket is configured so if the first sprocket is rotated for forward riding where the first section of teeth of the first sprocket is closer to the front tip of the bicycle frame, then the second section of teeth of the first sprocket is closer to the front tip of the bicycle frame, then the third section of teeth of the first sprocket is closer to the front tip of the bicycle frame, and then the fourth section of teeth of the first sprocket is closer to the front tip of the bicycle frame,
the second sprocket is configured so if the second sprocket is rotated for forward riding where the first section of teeth of the second sprocket is closer to the front tip of the bicycle frame, then the second section of teeth of the second sprocket is closer to the front tip of the bicycle frame, then the third section of teeth of the second sprocket is closer to the front tip of the bicycle frame, and then the fourth section of teeth of the second sprocket is closer to the front tip of the bicycle frame.

8. The apparatus as in claim 3, further comprising,
a front tip of the bicycle frame,
a rear tip of the bicycle frame,
the front tip of the bicycle frame is the leading portion of the bicycle frame, if the bicycle frame is configured to be ridden as part of a bicycle,
the first sprocket is attached to the bicycle frame closer to the front tip of the bicycle frame than the second sprocket,
on the front face of each of the first and second sprocket, a connection of the second section of teeth to the third section of teeth, the connection of the second section of teeth to the third section of teeth is a gradual transition without a sharp point in the shape of the front face, a connection of the fourth section of teeth to the first section of teeth, the connection of the fourth section of teeth to the first section of teeth is a gradual transition without a sharp point in the shape of the front face,
the first sprocket is configured so if the first sprocket is rotated for forward riding where the first section of teeth of the first sprocket is closer to the front tip of the bicycle frame, then the second section of teeth of the first sprocket is closer to the front tip of the bicycle frame, then the third section of teeth of the first sprocket is closer to the front tip of the bicycle frame, and then the fourth section of teeth of the first sprocket is closer to the front tip of the bicycle frame,
the second sprocket is configured so if the second sprocket is rotated for forward riding where the third section of teeth of the second sprocket is closer to the front tip of the bicycle frame, then the second section of teeth of the second sprocket is closer to the front tip of the bicycle frame, then the first section of teeth of the second sprocket is closer to the front tip of the bicycle frame, and then the fourth section of teeth of the second sprocket is closer to the front tip of the bicycle frame.

9. The apparatus as in claim 3, further comprising,
a front tip of the bicycle frame,
a rear tip of the bicycle frame,
the front tip of the bicycle frame is the leading portion of the bicycle frame, if the bicycle frame is configured to be ridden as part of a bicycle,
the first sprocket is attached to the bicycle frame closer to the front tip of the bicycle frame than the second sprocket,
on the front face of each of the first and second sprocket, a connection of the second section of teeth to the third section of teeth, the connection of the second section of teeth to the third section of teeth is a gradual transition without a sharp point in the shape of the front face, a connection of the fourth section of teeth to the first section of teeth, the connection of the fourth section of teeth to the first section of teeth is a gradual transition without a sharp point in the shape of the front face,
the first sprocket is configured so if the first sprocket is rotated for forward riding where the third section of teeth of the first sprocket is closer to the front tip of the bicycle frame, then the second section of teeth of the first sprocket is closer to the front tip of the bicycle frame, then the first section of teeth of the first sprocket is closer to the front tip of the bicycle frame, and then the fourth section of teeth of the first sprocket is closer to the front tip of the bicycle frame,
the second sprocket is configured so if the second sprocket is rotated for forward riding where the first section of teeth of the second sprocket is closer to the front tip of the bicycle frame, then the second section of teeth of the second sprocket is closer to the front tip of the bicycle frame, then the third section of teeth of the second sprocket is closer to the front tip of the bicycle frame, and then the fourth section of teeth of the second sprocket is closer to the front tip of the bicycle frame.

10. The apparatus as in claim 3, further comprising,
a front tip of the bicycle frame,
a rear tip of the bicycle frame,
the front tip of the bicycle frame is the leading portion of the bicycle frame, if the bicycle frame is configured to be ridden as part of a bicycle,
the first sprocket is attached to the bicycle frame closer to the front tip of the bicycle frame than the second sprocket,
on the front face of each of the first and second sprocket, a connection of the second section of teeth to the third section of teeth, the connection of the second section of teeth to the third section of teeth is a gradual transition without a sharp point in the shape of the front face, a connection of the fourth section of teeth to the first section of teeth, the connection of the fourth section of teeth to the first section of teeth is a gradual transition without a sharp point in the shape of the front face,
the first sprocket is configured so if the first sprocket is rotated for forward riding where the third section of teeth of the first sprocket is closer to the front tip of the bicycle frame, then the second section of teeth of the first sprocket is closer to the front tip of the bicycle frame, then the first section of teeth of the first sprocket is closer to the front tip of the bicycle frame, and then the fourth section of teeth of the first sprocket is closer to the front tip of the bicycle frame,
the second sprocket is configured so if the second sprocket is rotated for forward riding where the third section of teeth of the second sprocket is closer to the front tip of the bicycle frame, then the second section of teeth of the second sprocket is closer to the front tip of the bicycle frame, then the first section of teeth of the second sprocket is closer to the front tip of the bicycle frame, and then the fourth section of teeth of the second sprocket is closer to the front tip of the bicycle frame.

11. The apparatus as in claim 1, further comprising,
a longitudinal axis of the spindle,
a spindle hole, the spindle hole has a first opening and a second opening,
the first opening of the spindle hole is on the first end of the spindle,
the second opening of the spindle hole is on the second end of the spindle,
a nut,
a first washer,
a second washer,
a lock washer,
each of the first washer, the second washer, and the lock washer has a front face and a rear face,
a bolt, the bolt has a first end section and second end section, the first end section of the bolt is a threaded section of the bolt, the second end section of the bolt is a head of the bolt,
the bolt is oriented through each of the first washer, the second washer, the lock washer, and the spindle hole,
the first end section of the bolt is oriented through the nut,
the front face of the lock washer is oriented in contact with the nut,
the rear face of the lock washer is oriented in contact with the front face of the first washer,
the rear face of the first washer is in contact with the first slap crank arm,
the front face of the second washer is in contact with the second slap crank arm,
the rear face of the second washer is in contact with the head of the bolt.

12. An apparatus as in claim 1, further comprising,
each slap crank arm end structure, further comprising,
the slap crank arm housing structure has a front and rear wall, the slap crank arm housing structure front and rear wall each has a front and rear face,
a slap crank arm rear set screw,
a slap crank arm rear set screw hole, the slap crank arm rear set screw hole has a first and second opening, the first opening of the slap crank arm rear set screw hole is on the rear face of the rear wall of the slap crank arm housing structure,
the second opening of the slap crank arm rear set screw hole is on the front face of the rear wall of the slap crank arm housing structure,
the slap crank arm rear set screw travels through the slap crank arm rear set screw hole, the slap crank arm rear set screw is configured to stop the slap crank arm lever when the slap crank arm lever moves towards the rear wall of the slap crank arm housing structure,
a slap crank arm front set screw,
a slap crank arm front set screw hole, the slap crank arm front set screw hole has a first and second opening, the first opening of the slap crank arm front set screw hole is on the rear face of the front wall of the slap crank arm housing structure, the second opening of the slap crank arm front set screw hole is on the front face of the front wall of the slap crank arm housing structure,
the slap crank arm front set screw travels through the slap crank arm front set screw hole, the slap crank arm front set screw is configured to stop the slap crank arm lever when the slap crank arm lever moves towards the front wall of the slap crank arm housing structure.

13. An apparatus as in claim 12, further comprising,
each slap crank arm end structure, further comprising,
a slap crank arm lever hammer, the slap crank arm lever hammer is connected to the slap crank arm lever, the slap crank arm lever hammer is configured to hit the slap crank arm front set screw when the slap crank arm lever moves towards the front wall of the slap crank arm housing structure.

14. An apparatus as in claim 13, further comprising,
each slap crank arm end structure, further comprising,
the slap crank arm housing structure has a front and rear slap crank arm housing slap crank arm lever position indicator on each of the left and right wall of the slap crank arm housing structure,
the slap crank arm lever has a position indicator on each of the left and right face of the slap crank arm lever.

15. An apparatus as in claim 14, further comprising,
each slap crank arm end structure, further comprising,
a slap crank arm housing weep hole,
a slap crank arm housing weep hole has an internal and external opening,
the internal opening of the slap crank arm housing weep hole opens into the slap crank arm housing structure hollow cavity,
the external opening of the slap crank arm housing weep hole is on the front face of the front wall of the slap crank arm housing structure.

16. An apparatus as in claim 15, further comprising,
each slap crank arm end structure, further comprising,
the slap crank arm rear spring is a conical shape, the conical shape has a wide end and a narrow end, the wide end of the conical shape is closer to the first end of the slap crank arm rear spring and the narrow end of the conical shape is closer to the second end of the slap crank arm rear spring,
the slap crank arm front spring is a cylindrical shape.

17. An apparatus as in claim 16, further comprising,
each slap crank arm end structure, further comprising,
the slap crank arm lever hammer has a front face,
a slap crank arm front impact spear, the slap crank arm front impact spear is connected to the front face of the slap crank arm lever hammer,
the slap crank arm lever has a rear face,
a slap crank arm rear impact cut out in the rear face of the slap crank arm lever,
a slap crank arm rear impact spear,
the slap crank arm rear impact spear is connected to the slap crank arm rear impact cut out,
the slap crank arm rear set screw has a first end and a second end,
a slap crank arm rear set screw bumper, the slap crank arm rear set screw bumper is connected to the second end of the slap crank arm rear set screw,
the slap crank arm front set screw has a first end and a second end,
a slap crank arm front set screw bumper, the slap crank arm front set screw bumper is connected to the second end of the slap crank arm front set screw,
the slap crank arm rear impact spear is configured to hit the slap crank arm rear set screw bumper when the slap crank arm lever moves towards the rear wall of the slap crank arm housing structure,
the slap crank arm front impact spear is configured to hit the slap crank arm front set screw bumper when the slap crank arm lever moves towards the front wall of the slap crank arm housing structure.

18. An apparatus as in claim 17, further comprising,
each slap crank arm end structure, further comprising,
a slap crank arm lever rear spring securing loop, the slap crank arm lever rear spring securing loop is connected to the rear face of the slap crank arm lever,
a slap crank arm lever front spring securing loop, the slap crank arm lever has a front face, the slap crank arm lever front spring securing loop is connected to the front face of the slap crank arm lever,
a rear closure cap,
a rear closure cap hole, the rear closure cap hole has a first opening and a second opening, the first opening of the rear closure cap hole is in the rear face of the rear wall of the slap crank arm housing structure, the second opening of the rear closure cap hole is in the front face of the rear wall of the slap crank arm housing structure,
a rear closure cap securing loop, the rear closure cap securing loop is connected to the rear closure cap,
the rear closure cap is oriented in the rear closure cap hole with the rear closure cap securing loop inside the hollow cavity of the slap crank arm housing structure,
a front closure cap,
a front closure cap hole, the front closure cap hole has a first opening and a second opening, the first opening of the front closure cap hole is in the rear face of the front wall of the slap crank arm housing structure, the second opening of the front closure cap hole is in the front face of the front wall of the slap crank arm housing structure,
a front closure cap securing loop, the front closure cap securing loop is connected to the front closure cap,
the front closure cap is oriented in the front closure cap hole with the front closure cap securing loop inside the hollow cavity of the slap crank arm housing structure,
a slap crank arm rear spring rear securing loop, the slap crank arm rear spring rear securing loop forms the first end of the slap crank arm rear spring,
a slap crank arm rear spring front securing loop, the slap crank arm rear spring front securing loop forms the second end of the slap crank arm rear spring,
a slap crank arm front spring rear securing loop, the slap crank arm front spring rear securing loop forms the first end of the slap crank arm front spring,
a slap crank arm front spring front securing loop, the slap crank arm front spring front securing loop forms the second end of the slap crank arm front spring,
the slap crank arm rear spring rear securing loop is attached to the rear closure cap securing loop, the slap crank arm rear spring front securing loop is attached to the slap crank arm lever rear spring securing loop, the slap crank arm front spring rear securing loop is attached to the slap crank arm lever front spring securing loop, the slap crank arm front spring front securing loop is attached to the front closure cap securing loop.

19. An apparatus as in claim 18, further comprising,
each slap crank arm end structure, further comprising,
a first and second slap crank arm lever pedal hole raised reinforcement ring, the first slap crank arm lever pedal hole raised reinforcement ring is connected to the left face of the slap crank arm lever, the first slap crank arm lever pedal hole raised reinforcement ring surrounds the first opening of the slap crank arm lever pedal hole, the second slap crank arm lever pedal hole raised reinforcement ring is connected to the right face of the slap crank arm lever, the second slap crank arm lever pedal hole raised reinforcement ring surrounds the second opening of the slap crank arm lever pedal hole,
a slap crank arm pivot bar hole, the slap crank arm pivot bar hole has a first and second opening, the first opening of the slap crank arm pivot bar hole is on the left face of the slap crank arm lever, the second opening of the slap crank arm pivot bar hole is on the right face of the slap crank arm lever, the slap crank arm pivot bar is oriented through the slap crank arm pivot bar hole,
a slap crank arm lever pivot bar securing screw hole, the slap crank arm lever pivot bar securing screw hole has a first opening and a second opening, the first opening of the slap crank arm lever pivot bar securing screw hole is inside the slap crank arm pivot bar hole, the second opening of the slap crank arm lever pivot bar securing screw hole is on the front face of the slap crank arm lever,
a slap crank arm pivot bar in bar securing screw hole, the slap crank arm pivot bar in bar securing screw hole has an opening, an outer surface of the slap crank arm pivot bar, the opening of the slap crank arm pivot bar in bar securing screw hole is on the outer surface of the slap crank arm pivot bar,
a slap crank arm pivot bar securing screw, the slap crank arm pivot bar securing screw is oriented in the slap crank arm lever pivot bar securing screw hole and into the slap crank arm pivot bar in bar securing screw hole,
a left and right slap crank arm pivot bar bushing, the slap crank arm pivot bar is oriented through both of the left and right slap crank arm pivot bar bushings,
the left slap crank arm pivot bar bushing is oriented between the left wall of the slap crank arm housing structure and the left face of the slap crank arm lever,
the right slap crank arm pivot bar bushing is oriented between the right wall of the slap crank arm housing structure and the right face of the slap crank arm lever,
a left and right slap crank arm pivot bar bearing, the slap crank arm pivot bar is oriented through both the left and right slap crank arm pivot bar bearings, the left slap crank arm pivot bar bearing is oriented inside the left wall of the slap crank arm housing structure, the right slap crank arm pivot bar bearing is oriented inside the right wall of the slap crank arm housing structure,
a left and right slap crank arm housing cavity hole opening, the left slap crank arm housing cavity hole opening is on the left wall of the slap crank arm housing structure, the right slap crank arm housing cavity hole opening is on the right wall of the slap crank arm housing structure,
a left and right slap crank arm housing cavity hole covering plate, the left slap crank arm housing cavity hole covering plate is removably attached to the left wall of the slap crank arm housing structure and covers the left slap crank arm housing cavity hole opening, the right slap crank arm housing cavity hole covering plate is removably attached to the right wall of the slap crank arm housing structure and covers the right slap crank arm housing cavity hole opening,
a plurality of slap crank arm housing cavity hole covering plate securing screws, the slap crank arm housing cavity hole covering plate securing screws secure the left and right slap crank arm housing cavity hole covering plates to the slap crank arm housing structure.
